(19) United States
(12) Patent Application Publication
(10) Pub. No.: US 2018/0365641 A1
(43) Pub. Date: Dec. 20, 2018

(54) Locker-Based Logistics Management System

(71) Applicant: Zipcodexpress, Inc., Pflugerville, TX (US)

(72) Inventor: Yonghui Richard Zhu, Austin, TX (US)

(21) Appl. No.: 15/918,628

(22) Filed: Mar. 12, 2018

Related U.S. Application Data
(63) Continuation-in-part of application No. 15/724,769, filed on Oct. 4, 2017, now Pat. No. 10,043,151.
(60) Provisional application No. 62/544,099, filed on Aug. 11, 2017.
(60) Provisional application No. 62/520,696, filed on Jun. 16, 2017.

(51) Int. Cl. G06Q 10/08; G06K 19/06; G06K 7/14

(52) U.S. Cl. CPC G06Q 10/0836; G06K 7/1417; G06K 19/06037

(57) ABSTRACT

Technologies are described related to the delivery of items utilizing electronic locker arrangements. Systems described herein coordinate and manage the delivery of items by large numbers of couriers using a network of electronic locker arrangements. Implementations are described corresponding to couriers delivering items between electronic locker arrangements without the use of a distribution hub. In certain implementations, delivery of items is consolidated to electronic locker arrangements that include a number of lockers. This can increase security and privacy by eliminating the need to know a recipient's address in order to deliver an item. The system can notify a recipient that an item is available for pickup at a nearby electronic locker arrangement. Authentication techniques are described to enable the secure access to electronic locker arrangements that are storing items for delivery. Additionally, implementations enable delivery of items to electronic locker arrangements by third-party delivery service providers.

### PRIORITY CLAIM AND CROSS-REFERENCE

This application claims priority to U.S. Provisional Patent Application No. 62/520,696 filed on Jun. 16, 2017, and entitled “Methods and solutions for a smart locker-based shared access and goods logistics;” U.S. Provisional Patent Application No. 62/544,099 filed on Aug. 11, 2017, and entitled “Method and solutions to establish a smart locker-based shared access and good receiving and delivery logistics;” and U.S. patent application Ser. No. 15/724,769 filed on Oct. 4, 2017, and entitled “Locker-Based Logistics Management System” each of which are incorporated by reference herein in their entirety.

### BACKGROUND

Various service providers enable a sender, such as an individual or entity (e.g., business, educational institution, government institution, etc.), to have one or more items delivered to a recipient that includes another individual or entity. Typically, the service providers utilize a fleet of vehicles to deliver an item directly to an individual or entity. The service providers operate distribution hubs that aggregate items for a particular region and vehicles of the service provider obtain items from the distribution hubs and deliver them to a specific location of the recipient (e.g., business address, residential address).

### BRIEF DESCRIPTION OF THE DRAWINGS

FIG. 1 is a diagram of an architecture to facilitate the delivery of an item from a sender to a recipient by a logistics management system using an electronic locker arrangement according to some implementations.

FIG. 2 is a diagram of an architecture to facilitate the delivery of an item from a sender to a recipient by a logistics management system using a single electronic locker arrangement according to some implementations.

FIG. 3 is a diagram of an architecture to facilitate delivery of an item from a sender to a recipient by a logistics management system using multiple electronic locker arrangements according to some implementations.

FIG. 4 is a diagram of an architecture to facilitate delivery of an item to an electronic locker arrangement using a third-party delivery service provider according to some implementations.

FIG. 5 is a diagram of an architecture to provide secure access to an electronic locker arrangement for the delivery of an item from a sender to a recipient according to some implementations.

FIG. 6 is a diagram of a system including an electronic locker arrangement, a logistics management system, and a logistics mobile application to facilitate the delivery of an item from a sender to a recipient according to some implementations.

FIG. 7 is a diagram showing the timing of operations performed by various entities to enable an item to be delivered to a recipient from a sender via a single electronic locker arrangement according to some implementations.

FIG. 8 is a first diagram showing the timing of operations performed by various entities to enable an item to be delivered to a recipient from a sender via a courier utilizing multiple electronic locker arrangements according to some implementations.

FIG. 9 is a second diagram that continues the operations performed in FIG. 7 showing the timing of operations performed by various entities to enable an item to be delivered to a recipient from a sender via a courier utilizing multiple electronic locker arrangements according to some implementations.

FIG. 10 is a diagram showing the timing of operations of a process performed by various entities to enable an item to be delivered to a recipient by a third-party delivery service provider via an electronic locker arrangement according to some implementations.

FIG. 11 shows a first user interface to capture information to deliver an item to a recipient according to some implementations.

FIG. 12 shows a second user interface to obtain information indicating that an item is to be delivered to an electronic locker arrangement according to some implementations.

FIG. 13 shows an implementation of the first user interface with information entered into the user interface elements of the first user interface according to some implementations.

FIG. 14 shows an additional implementation of the first user interface with information entered into the user interface elements of the first user interface according to some implementations.

FIG. 15 shows a third user interface that includes an additional user interface element to capture a code indicating that an item is to be delivered to an electronic locker arrangement according to some implementations.

FIG. 16 is a flow diagram of a process to facilitate the delivery of an item from a sender to a recipient via a single electronic locker arrangement according to some implementations.

FIG. 17 is a flow diagram of a process to facilitate the delivery of an item from a sender to a recipient via multiple electronic locker arrangements according to some implementations.

FIG. 18 is a flow diagram of a process to facilitate the delivery of an item from a recipient to a sender via a courier using an application executed by a computing device of the courier according to some implementations.

FIG. 19 is a flow diagram of a process to facilitate access to an electronic locker arrangement for the delivery of an item from a sender to a recipient.

FIG. 20 is a flow diagram of a first process to deliver an item to an electronic locker arrangement via a delivery service provider according to some implementations.

FIG. 21 is a flow diagram of a second process to deliver an item to an electronic locker arrangement via a delivery service provider according to some implementations.

FIG. 22 is a diagram showing an illustrative computer architecture for implementing aspects of the various technologies presented herein.

### DETAILED DESCRIPTION

The following detailed description is directed to technologies for implementing a logistics management system to provide secure delivery of an item to a recipient from a sender. In some cases, the delivery of the item may take place via a courier. The logistics management system can communicate with the sender, the recipient, and the courier via an application executing on computing devices of the sender, recipient, and the courier. An electronic locker arrangement that includes one or more lockers can be used to store the item during the delivery process. In particular implementations, the courier can deliver the item on behalf of a third-party delivery service provider and is not a courier delivering the item on behalf of the logistics management system.

Conventional item delivery systems and processes are inefficient and can lack a level of security that can be desired by senders and recipients of items. In particular, typical logistics companies maintain a fleet of vehicles that deliver items directly to individuals. The items are often dropped off with individuals whose identity is not verified, except by a general question regarding the last name of the individuals. In some cases when an individual is not present to receive an item, the item is dropped off at a location and left outside of a residence or business or left with a neighboring residence or business. In these scenarios, the items being delivered can easily be obtained by someone who is not the intended recipient without a credible means of identifying the individual that actually received the item. In other situations when an individual is not present to receive an item, delivery of the item can be delayed until another time when the delivery person is scheduled to be in the vicinity of the location of the recipient or until a recipient can drive to a physical location where the item is being held. In these instances, it can be inconvenient for an individual to actually obtain the item being sent to them.

Implementations described herein are different from systems utilized by conventional logistics service providers. In particular, implementing the systems and processes described herein eliminates the need for a service provider to maintain a dedicated fleet of vehicles. For example, utilizing a locker-to-locker delivery arrangement with a number of independent couriers eliminates the intermediate distribution hub that is utilized by conventional logistics service providers to deliver items. Additionally, the use of electronic locker arrangements to store items that are to be picked up and dropped off eliminates the delivery of items to an address dedicated to the recipient. The implementations described herein also provide secure drop off and delivery of items to recipients via electronic locker arrangements. The differences between the systems and processes described herein and conventional logistics and delivery systems results in technical differences with the conventional systems. In particular, the implementations described in this application are able to obtain requests to deliver items and process them relatively quickly with respect to conventional systems that deliver items via a set of routes on a daily basis because the items do not need to traverse the physical infrastructure of conventional systems, such as a distribution hub and a fleet of delivery vehicles, in order to be delivered to a recipient. Thus, the implementations described herein utilize a mobile app and/or website to obtain requests to deliver items and also to notify couriers of items that have been requested for delivery in real-time or near real-time.

Further, eliminating a distribution hub and implementing locker-to-locker deliveries causes the systems and methods described herein to differ from conventional systems in the processes and algorithms utilized due to the differences in the architectures. In particular, implementations described herein utilize authentication and identity verification processes that are different from other logistics service providers and are different from other locker-based delivery systems. These different authentication and identity verification processes provide improved security over conventional systems. Additionally, the processes described in implementations differ from conventional logistics systems and locker-based delivery systems by controlling the assignment and access to lockers by couriers, senders, and recipients that conventional systems do not need to implement and/or are unable to implement. These processes represent improvements over the conventional industry practice by enabling the assignment of lockers and couriers to deliver items within minutes or seconds and enables faster delivery times from the time that a request was received that are not possible with conventional hub-based logistics systems that utilize a fleet of vehicles that have assigned routes and traditional locker-based systems, which are simpler and less complex that the implementations described herein.

The implementations of the logistics management system described herein are also different from conventional systems because the logistics management systems described herein track the lockers that are available and unavailable for storing items to be delivered. Thus, the logistics management systems are configured to track the use of lockers for the delivery of items and identify lockers that are available to store items related to new requests for delivery in real-time to provide efficient use of the lockers. The logistics management systems described herein also utilize authentication techniques that restrict access to the lockers by individuals, track the individuals accessing the lockers, and monitor the location of the items based on information provided by the electronic locker arrangements to the logistics management system. Thus, in contrast to conventional systems, items can be accurately tracked and securely stored until individuals arrive to pick up their items.

Further, the techniques described herein represent additional improvements with respect to conventional systems. In particular, the systems and methods described herein include the implementation of complex algorithms that manage and coordinate the delivery of hundreds, up to thousands of items at a given time by hundreds, up to thousands of couriers. The systems and methods described herein also control access to electronic locker arrangements that enables the secure delivery of items to large numbers of couriers, recipients, and senders of items. The techniques described herein can manage and coordinate the many different facets of the logistic management system and control the dynamic manner in which a large number of items are being delivered at a given time in an efficient and secure manner that is not able to be obtained by conventional systems because conventional systems are more simplified in nature and are not associated with managing, controlling, and coordinating the delivery of such a large number of items via such a large number of couriers for a given geographic location.

In particular implementations, a first individual, the sender, can request to send an item to an additional individual, the recipient, utilizing a website, a mobile app, or both. The individual sending the item can provide information about the item being sent via the web site and/or mobile app. In some cases, the information about the item can include a text description of the item, one or more images of the item, video of the item, dimensions of the item, weight of the item, combinations thereof, and the like. Additionally, the individual sending the item can provide payment for the delivery of the item to the recipient via the website and/or the mobile app.

A logistics management system can receive the information about the item to be delivered to the recipient and determine one or more electronic locker arrangements that can be utilized to deliver the item to the recipient. In some cases, a single electronic locker management arrangement can be used to deliver the item to the recipient. In other situations, multiple electronic locker arrangements can be utilized to deliver the item to the recipient. In cases where a single electronic locker arrangement is used to deliver the item to the recipient, the logistics management system can identify the electronic locker arrangement for both the sender to drop off the item and for the recipient to pick up the item. Additionally, in instances where multiple electronic locker arrangements are used to deliver the item, the logistics management system can identify a first locker for the sender to drop off the item and a second locker for the recipient to pick up the item.

In various implementations, the electronic locker arrangement(s) utilized to provide the item to the recipient can be identified by the logistics management system based at least partly on a location of the sender of the item and a location of the recipient of the item. For example, the logistics management system can identify one or more electronic locker arrangements for the delivery of the item to the recipient that are proximate to the sender and the recipient. In some cases, the logistics management system can identify one or more locker arrangements for the delivery of the item to the recipient that are within a threshold distance of the sender and/or the recipient. In particular implementations, zip codes or other geographic designations can be utilized to identify one or more electronic locker arrangements for delivery of the item to the recipient. In an illustrative example, the logistics management system can identify a first electronic locker arrangement located in a zip code of the sender for the item to be dropped off and a second electronic locker arrangement in a zip code of the recipient for the item to be picked up. In scenarios where the sender and the receiver are in the same zip code, in certain implementations, the same electronic locker arrangement can be utilized for dropping off the item by the sender and picking up the item by the recipient.

In implementations that utilize multiple electronic locker arrangements to deliver the item to the recipient, one or more couriers can transport the item between the electronic locker arrangements. The logistics management system can determine that an item is to be delivered to a recipient and identify a number of candidate couriers to deliver the item to the recipient. In some cases, the logistics management system can identify candidate couriers based on locations of couriers relative to the location of the sender, the location of the recipient, or both. Additionally, the logistics management system can identify candidate couriers based on a number of items that that the couriers are already committed to delivering to other recipients. In additional situations, the logistics management system can identify candidates to deliver the item based on metrics of the couriers, such as on-time delivery percentage, number of items previously delivered, damage to items delivered, combinations thereof, and so forth. Further, the logistics management system can identify candidate couriers to deliver the item based on couriers that have provided status information to the logistics management system indicating that the couriers are available to pick up and drop off items in the location of the sender and the location of the recipient. After identifying a number of candidate couriers to deliver the item, the logistics management system can broadcast a message to the candidate couriers that the item is available for delivery. The message can include locations for pickup and delivery of the item. The logistics management system can then obtain notifications of acceptance from one or more of the candidate couriers and determine a particular candidate courier to deliver the item to the recipient.

Access to electronic locker arrangements can be implemented according to authentication processes to verify the identities of individuals requesting access to the electronic locker arrangements. In some implementations, an identifier that uniquely identifies the individual can be generated and provided to the individual. The identifier can then be utilized by the individual to gain access to an item stored by an electronic locker arrangement. In various implementations, the identifier can be encoded by a Quick Response (QR) code. In particular implementations, the QR codes can be utilized by couriers to pick up items for delivery and by recipients to pick up items that have been sent to them. In additional implementations, bar codes identifying items to be delivered can be used to obtain access to the electronic locker arrangements. For example, bar codes can be utilized by senders to access the electronic locker arrangements to store an item in a locker for delivery to a recipient. In other examples, bar codes can be utilized by couriers to drop off items in a locker that are to be picked up later by the recipients.

In still other implementations described herein, items can be delivered to an electronic locker arrangement by a courier of a third-party delivery service provider without integrating the logistics management system with systems of the third-party delivery service provider. Thus, a sender can arrange for an item to be delivered to an electronic locker arrangement by a courier of a third-party delivery service provider without any modifications being made to the processes or systems of the third-party delivery service provider. For example, in some cases, an electronic locker arrangement can be co-located with another building or structure. In these situations, a street address or other geographic location indicator can be associated with the building or structure in the systems of the third-party delivery service provider, but the electronic locker arrangement may not be associated with the address or geographic location indicator in the systems of the third-party delivery service provider. Accordingly, a sender can indicate the address or geographic location indicator of the location that the electronic locker arrangement shares with the additional building or structure, but a courier would not be able to determine whether the item is to be delivered to the electronic locker arrangement or to the building or structure. As a result, the item may be delivered to the wrong individual, the item may be returned to the sender, or the item may be undeliverable. The implementations described herein enable an item to be accurately, efficiently, timely, and safely delivered to an electronic locker arrangement that is co-located with another building or structure without integrating the systems of the third-party delivery service provider and the systems of the logistics management system to indicate a difference between delivering the item to the electronic locker arrangement or to the building or structure.

In particular implementations, the logistics management system can generate a locker identifier that a sender of an item can add to information that is provided to a courier of the third-party delivery service. The locker identifier can be an additional alphanumeric string or a security code (e.g., a bar code, a QR code) that indicates the item is to be delivered to an electronic locker arrangement instead of to a building or structure that is co-located with the electronic locker arrangement. In some illustrative implementations, the locker identifier can be entered into a field of a user interface provided by the third-party delivery service provider that captures information related to the delivery of the item, such as a field that captures a name of the recipient or a field that captures an address of the recipient. By adding an additional locker identifier to the information that is typically provided to a courier of the third-party delivery service provider to deliver the item, the courier can recognize that the item is to be delivered to the electronic locker arrangement and not a building or other structure that is co-located with the electronic locker arrangement. In this way, the locker identifier ensures to the courier that the item is to be delivered to a recipient that is associated with the locker management system and that the courier can access a locker of the electronic locker arrangement to deliver the item. Accordingly, confusion for the courier can be minimized by using the locker identifier to verify that items are to be delivered to electronic locker arrangements and not to buildings that may be co-located with the electronic locker arrangements. Minimizing confusion on the part of the courier can lead to fewer items being returned as undeliverable and/or items being incorrectly delivered to buildings instead of the electronic locker arrangements co-located with the buildings.

It should be appreciated that the subject matter presented herein can be implemented as a computer process, a computer-controlled apparatus, a computing system, or an article of manufacture, such as a computer-readable storage medium. While the subject matter described herein is presented in the general context of program modules that execute on one or more computing devices, those skilled in the art will recognize that other implementations can be performed in combination with other types of program modules. Generally, program modules include routines, programs, components, data structures, and other types of structures that perform particular tasks or implement particular abstract data types.

Those skilled in the art will also appreciate that aspects of the subject matter described herein can be practiced on or in conjunction with other computer system configurations beyond those described herein, including multiprocessor systems, microprocessor-based or programmable consumer electronics, minicomputers, mainframe computers, handheld computers, personal digital assistants, e-readers, mobile telephone devices, tablet computing devices, special-purposed hardware devices, network appliances, and the like. In particular, the configurations described herein can be practiced in distributed computing environments where tasks can be performed by remote computing devices that are linked through a communications network. In a distributed computing environment, program modules can be located in both local and remote memory storage devices.

In the following detailed description, references are made to the accompanying drawings that form a part hereof, and that show, by way of illustration, specific configurations or examples. The drawings herein are not drawn to scale. Like numerals represent like elements throughout the several figures (which might be referred to herein as a “FIG.” or “FIGS.”).

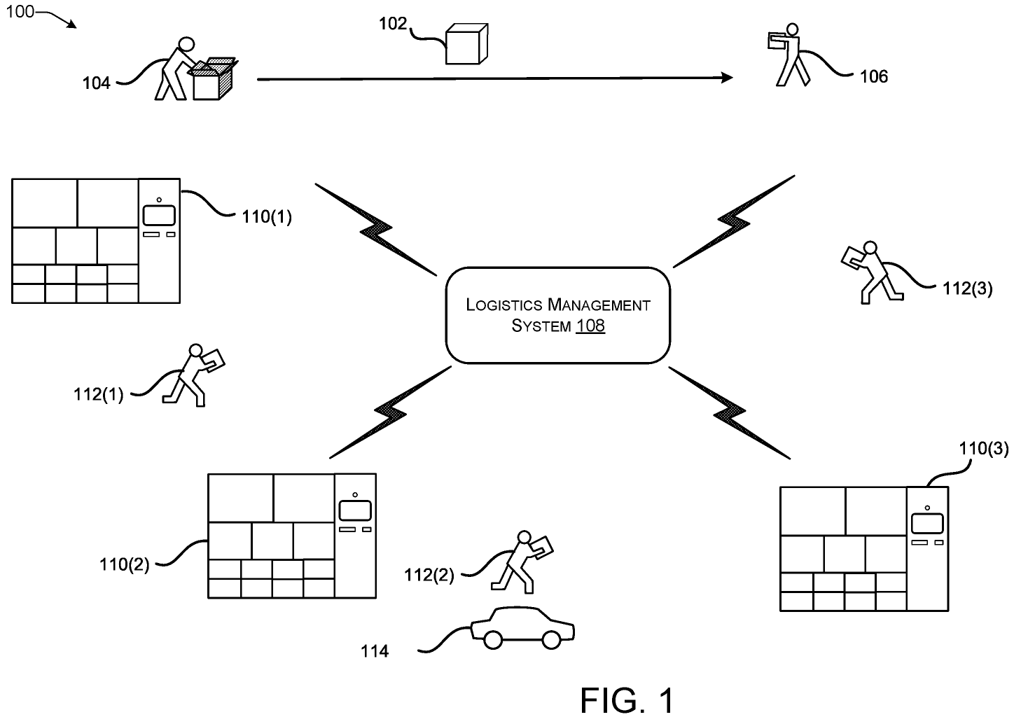

FIG. 1 is a diagram of an architecture 100 to facilitate the delivery of an item 102 from a sender 104 to a recipient 106 by a logistics management system 108 using an electronic locker arrangement 110 according to some implementations. In some cases, the item 102 can be included in a container or other type of packaging. The item 102 can include goods obtained from a retailer or manufacturer. The item 102 can also include food or other perishable articles. Further, the item 102 can include non-perishable articles. Additionally, the item 102 can have a number of different weights and sizes.

The sender 104 can include an individual that wants to have the item 102 sent to the recipient 106. In some cases, the sender 104 can be a representative of an entity, such as an employee of a company, that sends the item 102 to the recipient 106 on behalf of the entity. In other cases, the sender 104 can be acting in an individual capacity to send the item 102 to the recipient 106. The recipient 106 can also be a representative of an entity that receives the item 102 on behalf of the entity. In addition, the recipient 106 can receive the item 102 in their individual capacity.

The logistics management system 108 can control the flow of information within the architecture 100 to enable the delivery of the item 102 from the sender 104 to the recipient 106. That is, the logistics management system 108 can obtain a request from the sender 104 to deliver the item 102 to the recipient 106 and identify electronic locker arrangements 110 that can be utilized to store the item 102 during the delivery process. The logistics management system 108 can also identify one or more couriers, such as couriers 112(1), 112(2), 112(3), that can transport the item 102 between the sender 104 and the recipient 106. The logistics management system 108 can communicate with the sender 104, the recipient 106, and the courier 112 to coordinate the pickup and drop off of the item 102 by the sender 104, the recipient 106, and optionally by one or more couriers 112, to one or more of the electronic locker arrangements 110 such that the item 102 can be delivered to the recipient. 106.

The electronic locker arrangements 110 can include a number of lockers that can store items to be delivered from senders to recipients. The lockers can have varying dimensions such that some lockers can hold items that are larger than other items stored by smaller lockers. In some cases, the lockers can be refrigerated to store food or other items (e.g., electronics) that can be damaged by heat. The electronic locker arrangements 110 can also include a number of input/output devices to provide information and/or communications to users of the electronic locker arrangements 110. For example, the electronic locker arrangements 110 can include one or more display devices, one or more microphones, one or more speakers, or combinations thereof. The electronic locker arrangements 110 can also include computing resources, such as one or more processors, one or more memory devices, communication interfaces, and so forth to send, receive, and process electronic information. In particular, the electronic locker arrangements 110 can provide a number of user interfaces to enable individuals to access the lockers of the electronic locker arrangements 110 to drop off or pickup items stored in the lockers of the electronic locker arrangements 110. The electronic locker arrangements 110 can also include additional systems to open and/or close the lockers, sensors to determine that items have been stored in or removed from the lockers, cameras to obtain images and/or video, biometric devices to identify individuals accessing the lockers, and the like.

In various implementations, the electronic locker arrangements 110 can be stationary and located in a fixed location. In these situations, the electronic locker arrangements 110 can be anchored to the ground or to a structure and/or the weight of the electronic locker arrangements 110 can cause the electronic locker arrangements 110 to remain in a particular location. In additional implementations, the electronic locker arrangements 110 can be mobile. In these scenarios, the electronic locker arrangements 110 can be mounted to a vehicle and be transported by the vehicle to different locations. In implementations where the electronic locker arrangements 110 are mobile, items can be delivered to and/or picked up from electronic locker arrangements 110. For example, a vehicle transporting an electronic locker arrangement 110 can stop at a particular location, and items can be delivered to and/or picked up from the electronic locker arrangement 110 at the particular location. In particular implementations, dimensions of a mobile electronic locker arrangement 110, such as length, width, and height, can be smaller than dimensions of an electronic locker arrangement in a fixed position.

In particular implementations, the electronic locker arrangements 110 can be in electronic communication with the logistics management system 108. In some implementations, the electronic locker arrangements 110 can be in communication with each other. In still other implementations, the electronic locker arrangements 110 can be in communication with applications executing on mobile devices of senders, recipients, and couriers that are involved in the delivery of items. Although the architecture 100 of FIG. 1 shows three representative electronic locker arrangements 110(1), 110(2), and 110(3), the architecture 100 can include fewer than three electronic locker arrangements or more than three electronic locker arrangements.

In some cases, the electronic locker arrangements 110 can be associated with a particular region and can store items to be delivered within that particular region. In an illustrative example, individual locker arrangements 110 can be associated with a corresponding zip code. In this way, items being delivered to recipients located in a particular zip code can obtain the items from a particular locker arrangement 110. Additionally, senders associated with a particular zip code can drop off items for delivery at an electronic locker arrangement associated with the zip code of the senders. In situations where senders and recipients of items are in different zip codes, couriers 112 can transport the item from an electronic locker arrangement 110 located in the zip codes of the senders to different electronic locker arrangements 110 located in the zip codes of the recipients.

In an illustrative implementation, the logistics management system 108 can receive a request from the sender 104 to deliver the item 102 to the recipient 106. The logistics management system 108 can receive the request via a mobile app executed by an electronic device of the sender 104. The logistics management system 108 can also receive the request via a website administered by or on behalf of the logistics management system 108. Additionally, the logistics management system 108 can receive the request to deliver the item 102 from an electronic locker arrangement 110. The request can indicate information related to the recipient 106. In some cases, the request can indicate a location of the recipient 106. In particular implementations, the request can indicate a region in which the recipient 106 is located, such as a zip code, without specifying an address of the recipient 106. Further, the request can indicate an identifier of the individual, such as a phone number, an email address, a name, an identification number, combinations thereof, and the like.

A request to deliver the item 102 to the recipient 106 can also indicate information related to the item 102. To illustrate, the request can indicate dimensions of the item 102, such as a length of the item 102, a width of the item 102, a height of the item 102, a diameter of the item 102, a volume of the item 102, or combinations thereof. The request can also indicate a weight of the item 102. Further, the request can indicate a description of the item 102. That is, the request can indicate a category associated with the item 102, such as electronic device, food, consumer good, toys, furniture, etc. In addition, the request can indicate whether an item is fragile, perishable, and so forth.

After receiving the request from the sender 104 to deliver the item 102 to the recipient 106, the logistics management system 108 can identify one or more electronic locker arrangements 110 that can be utilized to provide the item 102 to the recipient 106. In some implementations, a single electronic locker arrangement 110 can be utilized to provide the item 102 to the recipient 106. In these situations, the sender 104 can drop off the item 102 in a locker of an electronic locker arrangement 110, such as the electronic locker arrangement 110(1), and the recipient 106 can pick up the item 102 from the same locker. In other cases, multiple locker arrangements 110 can be utilized to provide the item 102 to the recipient 106. For example, the item 102 can be dropped off by the sender 104 at the electronic locker arrangement 110(1) and the item 102 can be picked up by the recipient 106 at the electronic locker arrangement 110(2).

In situations where an item is to be transported between electronic locker arrangements 110, the logistics management system 108 can determine one or more couriers 112 to transport the item from one electronic locker arrangement 110 to an additional electronic locker arrangement 110. In particular, the logistics management system 108 can determine a number of candidate couriers from among a larger pool of couriers based on one or more criteria. In some cases, the logistics management system 108 can identify candidate couriers to transport items between electronic locker arrangements 110 based at least partly on proximity of the couriers to a pickup location or a drop off location. The logistics management system 108 can also determine candidate couriers to transport items between electronic locker arrangements 110 based at least partly on an experience level of the couriers, such as a number of deliveries previously completed, and/or on performance metrics of the couriers (e.g., on time percentage, number of packages lost or damaged, current delivery load, etc.). Couriers 112 can indicate an availability to deliver items in certain regions and the logistics management system 108 can identify candidate couriers to deliver the item 102 based at least partly on couriers 112 that have indicated an availability to deliver items in locations corresponding to the location of the sender 104 and the location of the recipient 106. In various implementations, the couriers 112 can utilize a number of modes of transportation to deliver the item 102 from the sender 104 to the recipient 106. In the illustrative example of FIG. 1, the courier 112(2) can transport an item utilizing a vehicle 114.

After the logistics management system 108 has identified one or more candidate couriers to transport an item between electronic locker arrangements, the logistics management system 108 can send communications to the candidate couriers indicating the item to be delivered and the electronic locker arrangements to be utilized to drop off and pick up the item. In the illustrative example of FIG. 1, the logistics management system 108 can identify the couriers 112(1) and 112(2) as candidates to transport the item 102 from the first electronic locker arrangement 110(1) to the second electronic locker arrangement 110(2). Candidate couriers can send an indication to the logistics management system 108 to accept the job of transporting an item between electronic locker arrangements and the logistics management system 108 can assign a particular courier to transport the item.

Access to the electronic locker arrangements 110 can be controlled to provide secure delivery of the item 102 to the recipient 106. In some implementations, one or more authentication techniques can be utilized to control access to lockers of the electronic locker arrangements 110 by the recipient 106 and/or courier 112. For example, a QR code can be provided to the recipient 106 before picking up the item 102 at an electronic locker arrangement 110. The QR code can uniquely identify the recipient 106 with respect to the item 102. In particular implementations, the logistics management system 108 can generate the QR code in response to a request from the recipient 106 to access the item stored by the electronic locker arrangement 110. The electronic locker arrangement 110 can provide the QR code to a computing device of the recipient 106 and the computing device of the recipient 106 can extract certain information from the QR code. The extracted information can be sent back to the logistics management system 108 along with an identifier of the recipient 106. The logistics management system 108 can then utilize the identifier of the recipient 106 and the information extracted from the QR code to authorize access to the electronic locker arrangement 110 by the recipient 106. In response to verification of the identity of the recipient 106, in various implementations, the logistics management system 108 can cause the electronic locker arrangement 110 to open the particular locker storing the item 102 by sending a signal to the electronic locker arrangement 110 to open the particular locker. Consequently, the recipient 106 can pick up the item 102 from the electronic locker arrangement 110.

In additional implementations, an additional QR code can be provided to a courier 112 that is assigned to deliver the item 102 to the recipient from the sender 104 via an electronic locker arrangement 110. The additional QR code can uniquely identify the courier 112 with respect to the item 102. That is, the additional QR code provided to the courier 112 with respect to the item can be different from the QR code provided to the recipient 106 with respect to the item. Also, the QR codes provided to the recipient 106 and the courier 112 with respect to the item 102 can be different from QR codes provided to an additional recipient and an additional courier with respect to a different item that is to be delivered via the logistics management system 108. Thus, the QR codes generated by the logistics management system 108 are dynamic and not static and the same QR code is not re-used to gain access to the electronic locker arrangements 110. The dynamic generation of QR codes by the logistics management system 108 provides an authentication technique to access the electronic locker arrangements 110 that is more secure than the techniques utilized to authenticate identities in conventional item delivery arrangements.

In particular implementations, the logistics management system 108 can generate the additional QR code in response to a request from the courier 112 to access the item stored by the electronic locker arrangement 110. The electronic locker arrangement 110 can provide the additional QR code to a computing device of the courier 112 and the computing device of the courier 112 can extract certain information from the additional QR code. The extracted information can be sent back to the logistics management system 108 along with an identifier of the courier 112. The logistics management system 108 can then utilize the identifier of the courier 112 and the information extracted from the additional QR code to authorize access to the electronic locker arrangement 110 by the courier 112. In response to verification of the identity of the courier 112 by the logistics management system 108, the courier 112 can be granted access to a particular locker of the electronic locker arrangement 110 that is storing the item 102. For example, the logistics management system 108 can send a signal to the electronic locker arrangement 108 to open the locker storing the item 102. The courier 112 can then obtain the item 102 from the locker and transport the item 102 to another locker in a different electronic locker arrangement 110 that is proximate to a location of the recipient 106.

Other techniques can also be utilized to control access to the electronic locker arrangements 110. In some implementations, access to the electronic locker arrangements 110 can be controlled by providing an identifier of the item 102. For example, the logistics management system 108 can generate a bar code for the item 102 in response to a request from the sender 104 to deliver the item 102 to the recipient 106. The sender 104 can activate a scanner on an electronic locker arrangement 110 to scan the bar code of the item 102 and the electronic locker arrangement 110 can communicate with the logistics management system 108 to obtain access to a locker of the electronic locker arrangement 110 to store the item 102. In this way, the sender 104 can store the item 102 in an electronic locker arrangement 110 until the item 102 is picked up by a courier 112 for delivery to the recipient 106 or until the item 102 is picked up by the recipient 106. In particular implementations, a courier 112 can also utilize a bar code of the item 102 to obtain access to an additional electronic locker arrangement 110 to drop off the item 102 until the recipient 106 picks up the item 102.

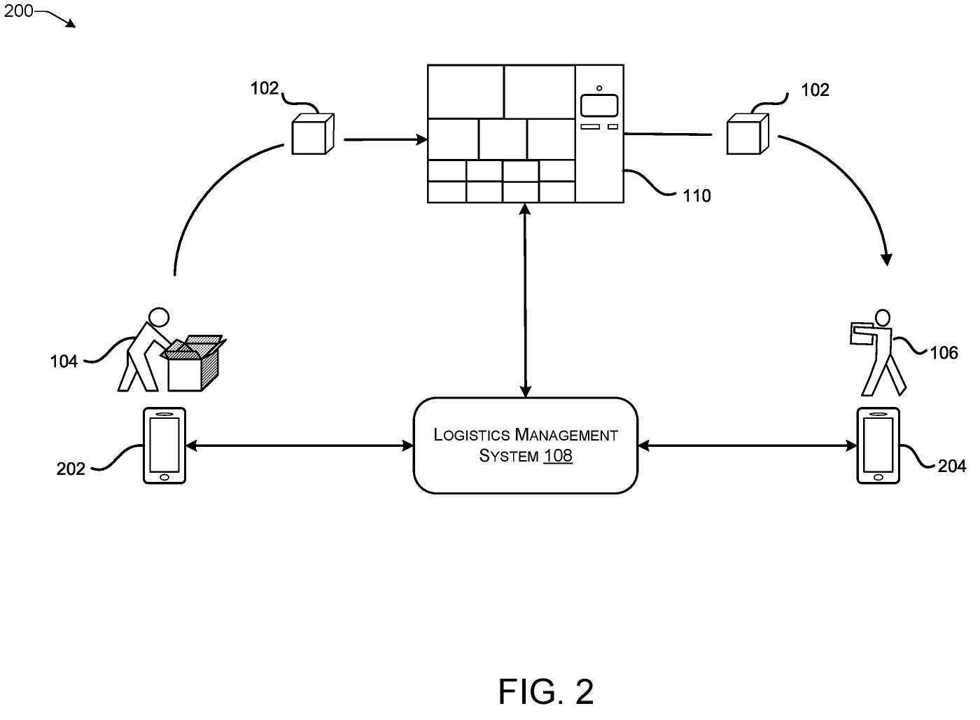

FIG. 2 is a diagram of an architecture 200 to facilitate the delivery of an item 102 from a sender 104 to a recipient 106 by a logistics management system 108 using a single electronic locker 110 arrangement according to some implementations. The architecture 200 also includes a first computing device 202 that is operated by the sender 104 and a second computing device 204 that is operated by the recipient 106. The computing devices 202, 204 can include one or more of a smart phone, laptop computing device, tablet computing device, electronic reader device, portable gaming device, desktop computing device, or gaming console.

In some implementations, the sender 104 can utilize the first computing device 202 to send a request to the logistics management system 108 to deliver the item 102 to the recipient 106. In particular implementations, the first computing device 202 can execute a logistics application to send the request to deliver the item 102 to the recipient 106. In various examples, the logistics application can be a mobile app executing on a portable computing device and the logistics application can be provided by a service provider associated with the logistics management system 108. The logistics application executed by the first computing device 202 can provide one or more user interfaces that include user interface elements to enter information related to a request to deliver the item 102 to the recipient 106. For example, the logistics application can capture information entered by the sender 104 corresponding to the item 102 (e.g., dimensions of the item 102, weight of the item 102, images of the item 102, description of the item 102, etc.), information related to the recipient 106 (e.g., location of the recipient 106, identifier(s) of the recipient 106, etc.), and/or information related to the sender 104 (e.g. location of the sender 104, payment information of the sender, identifier(s) of the sender 104, etc.).

In response to receiving the request from the sender 104 to deliver the item 102 to the recipient 106, the logistics management system 108 can determine that the item 102 is to be delivered to the recipient 106 via the electronic locker arrangement 110. In particular implementations, the logistics management system 108 can determine that the electronic locker arrangement 110 corresponds to the location of both the sender 104 and the recipient 106. In this way, the logistics management system 108 can determine that the sender 104 can drop off the item 102 at the electronic locker arrangement 110 and the recipient 106 can pick up the item 102 from the electronic locker arrangement 110. In illustrative implementations, the sender 104 and the recipient 106 can be located in a same zip code.

In some implementations, the logistics management system 108 can utilize information obtained from the sender 104 about the item 102 to determine a particular locker within the electronic locker arrangement 110 to store the item 102. For example, the logistics management system 108 can identify a locker of the electronic locker arrangement 110 to store the item 102 based at least partly on dimensions of the item 102 and/or weight of the item 102. That is, the lockers of the electronic locker arrangement 110 can have different dimensions and weight capacities. In these situations, the logistics management system 108 can determine one or more lockers of the electronic locker arrangement 110 that have dimensions and/or weight capacities that correspond to the dimensions and/or weight capacities of the item 102. The logistics management system 108 can also determine a locker to store the item 102 based on a number of lockers that are not already occupied or are not already scheduled to be occupied during the time in which the item 102 is requested to be stored in the electronic locker arrangement 110.

The logistics management system 108 can generate an identifier of the item 102 and provide the identifier to the sender 104 via the application executing on the first computing device 202. In some cases, the identifier of the item 202 can include a bar code. The identifier of the item 102 can be utilized to provide access to the locker of the electronic locker arrangement 110 that is dedicated to store the item 102. In some implementations, the sender 104 can utilize the logistics application executing on the first computing device 202 to provide the identifier of the item 102 to the electronic locker arrangement 110. For example, the logistics application executing on the first computing device 202 can generate a user interface displaying the identifier of the item 102 and the electronic locker arrangement 110 can include an input device to capture the identifier. In an illustrative example, the electronic locker arrangement 110 can include a barcode scanner and the first computing device 202 can display a barcode identifying the item. The barcode scanner of the electronic locker arrangement 110 can scan the barcode being displayed on the first computing device 202. In other implementations, the sender 104 can print the bar code and provide a physical copy of the bar code to be scanned by the electronic locker arrangement 110.

In some implementations, the electronic locker arrangement 110 can send the identifier of the item 102 to the logistics management system 108. The logistics management system 108 can then verify that the electronic locker arrangement 110 corresponds to the particular electronic locker arrangement assigned to the item 102 by the logistics management system 108 based on the identifier of the item 102. In particular implementations, the logistics management system 108 can include and/or be in communication with a database storing information that indicates identifiers of items and the lockers of the electronic locker arrangements that are assigned to store the respective items. In response to receiving the identifier of the item 102 from the electronic locker arrangement 110, the logistics management system 108 can parse the database to determine that the item 102 is assigned to be stored by a locker of the electronic locker arrangement 110. Based on verifying that the item 102 is to be stored by the electronic locker arrangement 110, the logistics management system 108 can send information to the electronic locker arrangement 110 indicating that the sender 104 is authorized to store the item 102. In some situations, the information can include a signal to open a particular locker of the electronic locker arrangement 110 that is assigned to store the item 102.

In additional implementations, the electronic locker arrangement 110 can make the determination that the item 102 is to be stored in the electronic locker arrangement 110 without communicating with the logistics management system 108. In these implementations, the electronic locker arrangement 110 can store information that can be utilized to verify that the item 102 is to be stored by the electronic locker arrangement 110. In response to obtaining an identifier of the item 102, the electronic locker arrangement 110 can access data stored in memory of the electronic locker arrangement 110 to determine that the identifier of the item 102 is included in a list of items that are assigned to be stored by the electronic locker arrangement 110. Based on determining that the item 102 is to be stored by the electronic locker arrangement 110, the electronic locker arrangement 110 can cause a particular locker assigned to store the item 102 to open.

The electronic locker arrangement 110 can determine that the sender 104 has placed the item 102 into a locker for storage. In some implementations, the electronic locker arrangement 110 can determine that the item 102 has been stored in the electronic storage arrangement 110 based on input from one or more sensors of the electronic locker arrangement 110. For example, the electronic locker arrangement 110 can determine that a locker assigned to store the item 102 has been closed. In another example, the electronic locker arrangement 110 can obtain video input to determine that the item 102 has been stored inside a locker of the electronic locker arrangement 110. In additional examples, the electronic locker arrangement 110 can utilize data from weight sensors to determine that the item 102 has been placed in a locker of the electronic locker arrangement 110. The electronic locker arrangement 110 can also obtain input, such as via a user interface displayed by the electronic locker arrangement 110 or via a logistics application executed by the first computing device 202, indicating that the item 102 has been stored in a locker of the electronic locker arrangement 110. In additional implementations, the electronic locker arrangement 110 can send sensor data to the logistics management system 108 and the logistics management system 108 can determine that the item 102 has been stored in the electronic locker arrangement 110.

Based on determining that the item 102 is stored in the electronic locker arrangement 110, the logistics management system 108 can send a notification to the second computing device 202 of the recipient 106 indicating that the item 102 is available to be picked up by the recipient 106. In some cases, the notification can indicate a location of the electronic locker arrangement 110. The notification can also include information indicating the sender 104. In various implementations, the notification can be received and processed by a logistics application executed by the second computing device 204. The logistics application can be provided by a service provider associated with the logistics management system 108, in some cases. In some implementations, the logistics application executed by the second computing device 204 can be another instance of the logistics application being executed by the first computing device 202.

The recipient 106 can request to access the locker of the electronic locker arrangement 110 that is storing the item 102. Based on receiving the request to access the locker storing the item 102, the electronic locker arrangement 110 can send a request to the logistics management system 108 for identity verification information. In some implementations, the identity verification information can include a QR code. In particular implementations, based on receiving the request from the electronic locker arrangement 110 for identity verification information, the logistics management system 108 can generate the identity verification information and provide the identity verification information to the electronic locker arrangement 110. In illustrative examples, the logistics management system 108 can generate a QR code that uniquely identifies the recipient 106 in relation to the item 102 and send the QR code to the electronic locker arrangement 110. The electronic locker arrangement 110 can then provide the QR code to the recipient 106. For example, the electronic locker arrangement 110 can display the QR code and the recipient 106 can utilize the second computing device 202 to scan the QR code. The second computing device 202 can then extract an identifier encoded by the QR code and send the identifier to the logistics management system 108. In some cases, the identifier can be an identifier of the electronic locker arrangement 110. The logistics application executing on the second computing device 204 can also provide additional information to the logistics management system 108, such as an identifier of the recipient 106 that is stored on the second computing device 204 in association with the logistics application. In this way, the logistics management system 108 can verify the identity of the recipient 106 based on the first identifier extracted from the QR code that was obtained by the second computing device 204 from the electronic locker arrangement 110 and the second identifier of the recipient 106.

In response to verifying the identity of the recipient 106, the logistics management system 108 can cause the electronic locker arrangement 110 to provide access to a locker storing the item 102 by the recipient 106. In some implementations, the logistics management system 108 can send a signal to the electronic locker arrangement 110 to open the locker storing the item 102. The electronic locker arrangement 110 can determine that the item 102 has been removed from the locker based at least partly on sensor data obtained by the electronic locker arrangement 110. In some cases, the sensor data can include video, images, weight sensors, magnetic sensors, combinations thereof, and the like. In various implementations, the electronic locker arrangement 110 can send the sensor data to the logistics management system 108 and the logistics management system 108 can determine that the item 102 has been removed from the locker of the electronic locker arrangement 110. In other implementations, the electronic locker arrangement 110 can send information to the logistics management system 108 indicating that the locker of the electronic locker arrangement 110 has been closed.

After determining that the locker previously storing the item 102 has been closed, the logistics management system 108 can determine that the item 102 has been delivered to the recipient 106. In particular implementations, the logistics management system 108 can also determine that the item 102 has been delivered to the recipient 106 based at least partly on information received via the logistics application executed by the second computing device 204. For example, the logistics application can provide one or more user interfaces that can capture input from the recipient 106 indicating that the item 102 has been delivered to the recipient 106. The logistics management system 108 can then update a database associated with the logistics management system 108 to indicate that the item 102 has been delivered to the recipient 106. The electronic locker arrangement 110 can also determine that the item has been obtained by the recipient 106 based on input obtained by the electronic locker arrangement 110 from the recipient 106. In particular, the electronic locker arrangement 110 can display one or more user interfaces that obtain input indicating that the item 102 has been picked up by the recipient 106. In other cases, a logistics application executed by the second computing device 204 can provide one or more user interfaces to obtain input indicating that the item 102 has been picked up by the recipient 106.

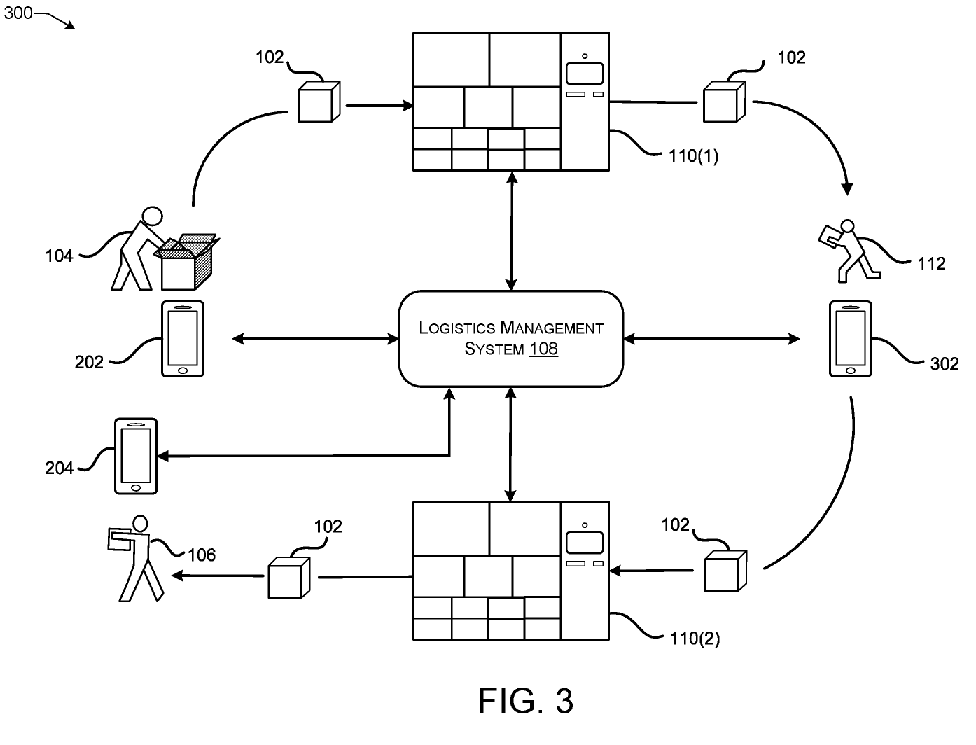

FIG. 3 is a diagram of an architecture 300 to facilitate delivery of an item 102 from a sender 104 to a recipient 106 by a logistics management system 108 using multiple electronic locker arrangements according to some implementations. In the illustrative example of FIG. 3, the architecture 300 includes a first electronic locker arrangement 110(1) and a second electronic locker arrangement 110(2). The item 102 can be transported from the first electronic locker arrangement 110(1) to the second electronic locker arrangement 110(2) by a courier 112. The courier 112 can have a third computing device 302 that is executing an instance of a logistics application. The first computing device 202 of the sender 104 and the second computing device 204 of the recipient 106 can also be executing respective instances of the logistics application.

In an illustrative example, the sender 104 can utilize the first computing device 202 to send a request to the logistics management system 108 to deliver the item 102 to the recipient 106. In particular implementations, the logistics application executed by the first computing device 202 can provide one or more user interfaces that include user interface elements to enter information related to a request to deliver the item 102 to the recipient 106. For example, the logistics application can capture information entered by the sender 104 corresponding to the item 102 (e.g., dimensions of the item 102, weight of the item 102, images of the item 102, description of the item 102, etc.), information related to the recipient 106 (e.g., location of the recipient 106, identifier(s) of the recipient 106, etc.), and/or information related to the sender 104 (e.g. location of the sender 104, payment information of the sender, identifier(s) of the sender 104, etc.).

In response to receiving the request from the sender 104 to deliver the item 102 to the recipient 106, the logistics management system 108 can determine that the item 102 is to be delivered to the recipient 106 via multiple electronic locker arrangements. In some implementations, the logistics management system 108 can identify the electronic locker arrangements 110 to be utilized to deliver the item 102 to the recipient 106 based at least partly on a location of the sender 104 and the recipient 106. In an illustrative example, the logistics management system 108 can determine that the sender 104 is located in a first location and the that recipient is located in a second location. In particular implementations, the first location can be a first zip code and the second location can be a second zip code. In these situations, the logistics management system 108 can identify electronic locker arrangements 110 that are located in the first location and the second location. In an illustrative example, the logistics management system 108 can determine that the first electronic locker arrangement 110(1) is located in the first location of the sender 104 and that the second electronic locker arrangement 110(2) is located in the second location of the recipient 106. In this way, the logistics management system 108 can determine that the sender 104 can drop off the item 102 at the first electronic locker arrangement 110(1) and the recipient 106 can pick up the item 102 from the second electronic locker arrangement 110(2).

The logistics management system 108 can also determine a courier 112 to transport the item 102 from the first electronic locker arrangement 110(1) to the second electronic locker arrangement 110(2). The logistics management system 108 can identify the courier 112 from among a number of candidate couriers. The candidate couriers can be determined by the logistics management system 108 based at least partly on a location of the candidate couriers. In some cases, the logistics management system 108 can determine one or more candidate couriers to transport the item 102 from the first electronic locker arrangement 110(1) to the second electronic locker arrangement 110(2) based on a proximity of the candidate couriers to the location of the first electronic locker arrangement 110(1) and the location of the second electronic locker arrangement 110(2). In particular implementations, the logistics management system 108 can determine couriers within a specified distance of the location of the first electronic locker arrangement 110(1) and/or the location of the second electronic locker arrangement 110(2) and identify those couriers as candidate couriers to transport the item 102 from the first electronic locker arrangement 110(1) and the second electronic locker arrangement 110(2). In illustrative implementations, the logistics management system 108 can identify couriers within a same zip code as the first electronic locker arrangement 110(1) as candidate couriers to transport the item 102 from the first electronic locker arrangement 110(1) and the second electronic locker arrangement 110(2). In additional implementations, the logistics management system 108 can identify candidate couriers based on information provided by couriers indicating that the couriers are available to deliver items to be picked up in the location of the first electronic locker arrangement 110(1) and dropped off in the location of the second electronic locker arrangement 110(2).

The logistics management system 108 can send a notification to the candidate couriers that the item 102 is available to be transported from the first electronic locker arrangement 110(1) to the second electronic locker arrangement 110(2). In some cases, the notification can be provided via a logistics application executed by computing devices of the candidate couriers. The logistics management system 108 can obtain responses to the notification and identify the courier 112 to transport the item 102 from the first electronic locker arrangement 110(1) to the second electronic locker arrangement 110(2).

In some implementations, the logistics management system 108 can utilize information obtained from the sender 104 about the item 102 to determine particular lockers within the first electronic locker arrangement 110(1) and the second electronic locker arrangement 110(2) that can be utilized to store the item 102. For example, the logistics management system 108 can identify lockers of the first electronic locker arrangement 110(1) and the second electronic locker arrangement 110(2) to store the item 102 based at least partly on dimensions of the item 102 and/or weight of the item 102. That is, the lockers of the electronic locker arrangements 110(1), 110(2) can have different dimensions and weight capacities. In these situations, the logistics management system 108 can determine one or more lockers of the electronic locker arrangements 110(1), 110(2) that have dimensions and/or weight capacities that correspond to the dimensions and/or weight capacities of the item 102. The logistics management system 108 can also determine a locker to store the item 102 based on a number of lockers of the electronic locker arrangements 110(1), 110(2) that are not already occupied or are not already scheduled to be occupied during the time in which the item 102 is requested to be stored in the first electronic locker arrangement 110(1) and the second electronic locker arrangement 110(2).

The logistics management system 108 can generate an identifier of the item 102 and provide the identifier to the sender 104 via the application executing on the first computing device 202. In some cases, the identifier of the item 202 can include a bar code. The identifier of the item 102 can be utilized to provide access to the locker of the first electronic locker arrangement 110(1) that is dedicated to store the item 102. In some implementations, the sender 104 can utilize the logistics application executing on the first computing device 202 to provide the identifier of the item 102 to the first electronic locker arrangement 110(1). For example, the logistics application executing on the first computing device 202 can generate a user interface displaying the identifier of the item 102 and the first electronic locker arrangement 110(1) can include an input device to capture the identifier. In an illustrative example, the first electronic locker arrangement 110(1) can include a barcode scanner and the first computing device 202 can display a barcode identifying the item. The barcode scanner of the first electronic locker arrangement 110(1) can scan the barcode being displayed on the first computing device 202.

In some implementations, the first electronic locker arrangement 110(1) can send the identifier of the item 102 to the logistics management system 108. The logistics management system 108 can then verify that the first electronic locker arrangement 110(1) corresponds to the particular electronic locker arrangement assigned to store the item 102 by the logistics management system 108 based on the identifier of the item 102. In particular implementations, the logistics management system 108 can include and/or be in communication with a database storing information that indicates identifiers of items and the electronic locker arrangements that are assigned to store the respective items. In response to receiving the identifier of the item 102 from the first electronic locker arrangement 110(1), the logistics management system 108 can parse the database to determine that the item 102 is assigned to be stored by the first electronic locker arrangement 110(1). Based on verifying that the item 102 is to be stored by the first electronic locker arrangement 110(1), the logistics management system 108 can send information to the first electronic locker arrangement 110(1) indicating that the item 102 can be stored by the first electronic locker arrangement 110(1). In some situations, the information can include a signal to open a particular locker of the first electronic locker arrangement 110(1) that is assigned to store the item 102.

In additional implementations, the first electronic locker arrangement 110(1) can make the determination that the item 102 is to be stored in the first electronic locker arrangement 110(1) without communicating with the logistics management system 108. In these implementations, the first electronic locker arrangement 110(1) can store information that can be utilized to verify that the item 102 is to be stored by the first electronic locker arrangement 110(1). In response to obtaining an identifier of the item 102 (e.g., bar code), the first electronic locker arrangement 110(1) can access data stored in memory of the first electronic locker arrangement 110(1) to determine that the identifier of the item 102 is included in a list of items that are assigned to be stored by the first electronic locker arrangement 110(1). Based on determining that the item 102 is to be stored by the first electronic locker arrangement 110(1), the first electronic locker arrangement 110(1) can cause a particular locker to open.

The first electronic locker arrangement 110(1) can determine that the sender 104 has placed the item 102 into a locker for storage. In some implementations, the first electronic locker arrangement 110(1) can determine that the item 102 has been stored in the first electronic storage arrangement 110(1) based on input from one or more sensors of the first electronic locker arrangement 110(1). For example, the first electronic locker arrangement 110(1) can determine that a locker assigned to store the item 102 has been closed. In another example, the first electronic locker arrangement 110(1) can obtain video input to determine that the item 102 has been stored inside a locker of the first electronic locker arrangement 110(1). In additional examples, the first electronic locker arrangement 110(1) can utilize data from weight sensors to determine that the item 102 has been placed in a locker of the first electronic locker arrangement 110(1). In additional implementations, the first electronic locker arrangement 110(1) can send sensor data to the logistics management system 108 and the logistics management system 108 can determine that the item 102 has been stored in the first electronic locker arrangement 110(1). In various implementations, the first electronic locker arrangement 110(1) or a logistics application executed by the first computing device 202 can display one or more user interfaces to obtain input from the sender 104 indicating that the item 102 has been stored in a locker of the first electronic locker arrangement 110(1).

Based on determining that the item 102 is stored in the first electronic locker arrangement 110(1), the logistics management system 108 can send a notification to the courier 112 indicating that the item 102 is available to be picked up by the courier 112. In some cases, the notification can indicate a location of the first electronic locker arrangement 110(1). The notification can also include information indicating the sender 104 and/or the recipient 106. The notification can be sent to the third computing device 302. In various implementations, the notification can be received and processed by a logistics application executed by the third computing device 302.

The courier 112 can request to access the locker of the first electronic locker arrangement 110(1) that is storing the item 102. Based on receiving the request to access the locker storing the item 102, the first electronic locker arrangement 110(1) can send a request to the logistics management system 108 for identity verification information. In some implementations, the identity verification information can include a QR code. In particular implementations, based on receiving the request from the first electronic locker arrangement 110(1) for identity verification information, the logistics management system 108 can generate the identity verification information and provide the identity verification information to the first electronic locker arrangement 110(1). In illustrative examples, the logistics management system 108 can generate a QR code that uniquely identifies the courier 112 in relation to the item 102 and send the QR code to the first electronic locker arrangement 110(1). The first electronic locker arrangement 110(1) can then provide the QR code to the courier 112. For example, the first electronic locker arrangement 110(1) can display the QR code and the courier 112 can utilize the third computing device 302 to scan the QR code. The third computing device 302 can then extract an identifier encoded by the QR code and send the identifier to the logistics management system 108. In some cases, the identifier extracted from the QR code can include an identifier of the first electronic locker arrangement 110(1). The logistics application executing on the third computing device 302 can also provide additional information to the logistics management system 108, such as an identifier of the courier 112 that is stored on the third computing device 302 in association with the logistics application. In this way, the logistics management system 108 can verify the identity of the courier 112 based on the first identifier extracted from the QR code that was obtained by the third computing device 302 from the first electronic locker arrangement 110(1) and the second identifier of the courier 112.

In response to verifying the identity of the courier 112, the logistics management system 108 can cause the first electronic locker arrangement 110(1) to provide access to a locker storing the item 102 by the courier 112. In some implementations, the logistics management system 108 can send a signal to the first electronic locker arrangement 110(1) to open the locker storing the item 102. The first electronic locker arrangement 110(1) can determine that the item 102 has been removed from the locker based at least partly on sensor data obtained by the first electronic locker arrangement 110(1). In some cases, the sensor data can include video, images, weight sensors, magnetic sensors, combinations thereof, and the like. In various implementations, the first electronic locker arrangement 110(1) can send the sensor data to the logistics management system 108 and the logistics management system 108 can determine that the item 102 has been removed from the locker of the first electronic locker arrangement 110(1). In other implementations, the first electronic locker arrangement 110(1) can send information to the logistics management system 108 indicating that the locker of the first electronic locker arrangement 110(1) has been closed. In various implementations, the first electronic locker arrangement 110(1) or a logistics application executed by the third computing device 302 can display one or more user interfaces to obtain input from the courier 112 indicating that the item 102 has been removed from a locker of the first electronic locker arrangement 110(1).

After determining that the locker previously storing the item 102 has been closed, the logistics management system 108 can determine that the item 102 is in the possession of the courier 112. The logistics management system 108 can update a status of the item 102 to indicate that the item 102 is in transport from the first electronic locker arrangement 110(1) to the second electronic locker arrangement 110(2). The courier 112 can move to the location of the second electronic locker arrangement 110(2) to drop off the item 102 for pick up by the recipient 106. The courier 112 can provide an identifier of the item 102, an identifier of the courier 112, or both to obtain access to a locker of the second electronic locker arrangement 110(2). In particular implementations, the courier 112 can operate the third computing device 302 to display an identifier of the item 102 via the logistics application executed by the third computing device 302. In illustrative implementations, the third computing device 302 can display the bar code of the item 102. A bar code scanner of the second electronic locker arrangement 110(2) can scan the bar code.

The second electronic locker arrangement 110(2) or the logistics management system 108 can determine that the identifier (e.g., bar code) obtained via the third computing device 302 corresponds to the item and also identify the locker of the second electronic locker arrangement 110(2) that is assigned to store the item 102 for pickup by the recipient 106. In various implementations, the second electronic locker arrangement 110(2) can obtain an identifier from the third computing device 302 and send the identifier to the logistics management system 108. The logistics management system 108 can access data stored in a database to verify that the item 102 is to be stored by the second electronic locker arrangement 110(2) and to identify a locker of the second electronic locker arrangement 110(2) that is to store the item 102. In these scenarios, the logistics management system 108 can send information to the second electronic locker arrangement 110(2) to open the locker to store the item 102.

The second electronic locker arrangement 110(2) can obtain sensor data related to the placement of the item 102 in a locker of the second electronic locker arrangement 110(2). The second electronic locker arrangement 110(2) or the logistics management system 108 can determine, based at least partly on the sensor data, that the item 102 has been stored in the second electronic locker arrangement 110(2). The second electronic locker arrangement 110(2) or the logistics management system 108 can also determine that the item 102 has been stored in the second electronic locker arrangement 110(2) based at least partly on input provided by the courier 112 at the second electronic locker arrangement 112(2) or via a logistics application executed by the third computing device 302 indicating that the item has been stores in the second electronic locker arrangement 110(2). After determining that the item 102 has been stored in the second electronic locker arrangement 110(2), the logistics management system 108 can send a notification to the recipient 106 that the item 102 is available for pickup. In some cases, the notification can indicate a location of the electronic locker arrangement 110. The notification can also include information indicating the sender 104. The notification can be sent to the second computing device 204. In various implementations, the notification can be received and processed by a logistics application executed by the second computing device 204. The logistics application can be provided by a service provider associated with the logistics management system 108, in some cases. In some implementations, the logistics application executed by the second computing device 204 can be another instance of the logistics application being executed by the first computing device 202.

The recipient 106 can request to access the locker of the second electronic locker arrangement 110(2) that is storing the item 102. Based on receiving the request to access the locker storing the item 102, the second electronic locker arrangement 110(2) can send a request to the logistics management system 108 for identity verification information. In some implementations, the identity verification information can include a QR code. In particular implementations, based on receiving the request from the second electronic locker arrangement 110(2) for identity verification information, the logistics management system 108 can generate the identity verification information and provide the identity verification information to the second electronic locker arrangement 110(2). In illustrative examples, the logistics management system 108 can generate a QR code that uniquely identifies the recipient 106 in relation to the item 102 and send the QR code to the second electronic locker arrangement 110(2). The QR code provided to the recipient 106 via the second electronic locker arrangement 110(2) is different from the QR code provided to the courier 112 via the first electronic locker arrangement 110(1). The second electronic locker arrangement 110(2) can then provide the QR code to the recipient 106. For example, the second electronic locker arrangement 110(2) can display the QR code and the recipient 106 can utilize the second computing device 202 to scan the QR code. The second computing device 202 can then extract an identifier encoded by the QR code and send the identifier to the logistics management system 108. In some cases, the identifier extracted from the QR code can include an identifier of the second electronic locker arrangement 110(2). The logistics application executing on the second computing device 204 can also provide additional information to the logistics management system 108, such as an identifier of the recipient 106 that is stored on the second computing device 204 in association with the logistics application. In this way, the logistics management system 108 can verify the identity of the recipient 106 based on the first identifier extracted from the QR code that was obtained by the second computing device 204 from the second electronic locker arrangement 110(2) and the second identifier of the recipient 106.

In response to verifying the identity of the recipient 106, the logistics management system 108 can cause the second electronic locker arrangement 110(2) to provide access to a locker storing the item 102 by the recipient 106. In some implementations, the logistics management system 108 can send a signal to the second electronic locker arrangement 110(2) to open the locker storing the item 102. The second electronic locker arrangement 110(2) can determine that the item 102 has been removed from the locker based at least partly on sensor data obtained by the second electronic locker arrangement 110(2). In some cases, the sensor data can include video, images, weight sensors, magnetic sensors, combinations thereof, and the like. In various implementations, the second electronic locker arrangement 110(2) can send the sensor data to the logistics management system 108 and the logistics management system 108 can determine that the item 102 has been removed from the locker of the second electronic locker arrangement 110(2). In other implementations, the second electronic locker arrangement 110(2) can send information to the logistics management system 108 indicating that the locker of the second electronic locker arrangement 110(2) has been closed.

After determining that the locker previously storing the item 102 has been closed, the logistics management system 108 can determine that the item 102 has been delivered to the recipient 106. In particular implementations, the logistics management system 108 can also determine that the item 102 has been delivered to the recipient 106 based at least partly on information received via the logistics application executed by the second computing device 204. For example, the logistics application can provide one or more user interfaces that can capture input from the recipient 106 indicating that the item 102 has been delivered to the recipient 106. In other examples, the second electronic locker arrangement 110(2) or a logistics application executed by the second computing device 204 can display one or more user interfaces to obtain input from the recipient 106 indicating that the item 102 has been removed from a locker of the second electronic locker arrangement 110(2). The logistics management system 108 can then update a database associated with the logistics management system 108 to indicate that the item 102 has been delivered to the recipient 106.

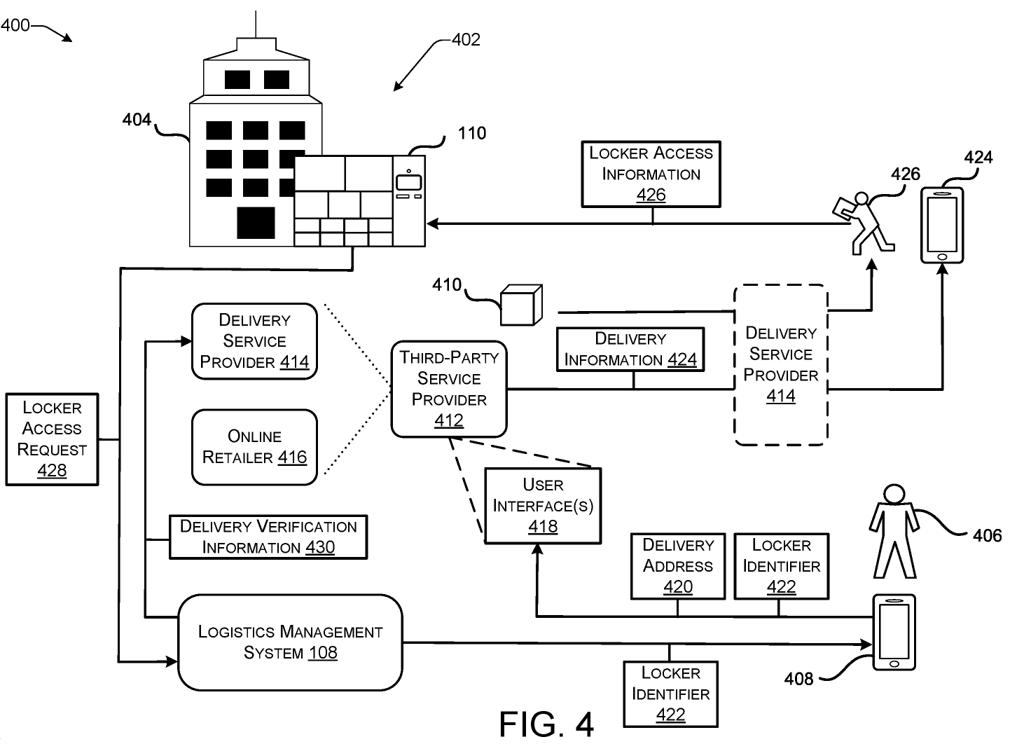

FIG. 4 is a diagram of an architecture 400 to facilitate delivery of an item to an electronic locker arrangement using a third-party delivery service provider according to some implementations. The architecture 400 includes a location 402 that has a building 404 and an electronic locker arrangement 110. Thus, the building 404 and the electronic locker arrangement 110 can be co-located at a same address or geographical location. The architecture 400 also includes a user 406 that can operate a computing device 408 to request delivery of an item 410. The user 406 can request delivery of the item 410 via a third-party delivery service rather than via a courier of the logistics management system 108. In some cases, the third-party service provider 412 can include a delivery service provider 414 that delivers items to individuals. In other situations, the third-party service provider 412 can include an online retailer 416.

In scenarios where the third-party service provider 412 includes the delivery service provider 414, the delivery service provider 414 can aggregate items to a distribution center and then deliver the items from the distribution center to the addresses associated with delivery of the respective items. In various situations, the distribution centers are regional and the delivery service provider 414 can transport or arrange for the transport of the items from the locations of the senders of the items to the various distribution centers. Delivery drivers then transport the items from the distribution centers to their final destinations. In certain implementations, the user 406 can directly communicate with the delivery service provider 414 via one or more user interfaces 418 that are accessible using the computing device 408. In particular implementations, the user 406 can request delivery of the item 410 by the delivery service provider 414 by entering information about the item, information about the recipient of the item, information about a location to deliver the item, or combinations thereof, into user interface elements of the one or more user interfaces 418. For example, the delivery service provider 414 can provide a website or a mobile device app that generates the one or more user interfaces 418 and facilitates communication between the computing device 408 and the delivery service provider 414. The delivery service provider 414 can utilize the information obtained via the one or more user interfaces 418 to deliver the item 410 to a location specified by the user 406, such as the location 402.

In situations where the third-party service provider 412 includes the online retailer 416, the online retailer 416 can provide the one or more user interfaces 418 via a website or a mobile device app of the online retailer 416 to obtain requests to purchase items from the online retailer 416. In an illustrative example, the user 406 can operate the computing device 408 to access the one or more user interfaces 418 and enter information to send a request to the online retailer 416 to purchase the item 410. In certain implementations, the information provided to the online retailer 416 by the user 406 can include delivery information 420. The delivery information 420 can indicate an address to deliver the item 410. To illustrate, the user 406 can operate the computing device 408 to enter an address of the location 402 via the one or more user interfaces 418.

In various implementations, the user 406 can request that the item 410 is delivered to the electronic locker arrangement 110 instead of the building 404. In these cases, the building 404 and the electronic locker arrangement 110 can be located at a same address, that is, the address of the location 402. The user 406 can operate the computing device 408 to obtain a locker identifier 422 to indicate that the item 410 is to be delivered to the electronic locker arrangement 110 at the location 402 instead of the building 404. For example, the user 406 can operate the computing device 408 to send a request to the logistics management system 108 for delivery of the item 410 to an electronic locker arrangement. The request can be sent to the logistics management system 108 via a mobile device app of the logistics management system 108 or a website of the logistics management system 108. In illustrative examples, the request can indicate a recipient of the item 410, a zip code to which the item 410 is to be delivered, an address of the recipient, or combinations thereof. The request can also include information about the item 410, such as a type of the item 410, one or more dimensions of the item 410, a weight of the item 410, additional characteristics of the item 410 (e.g., fragile, perishable, etc.), or combinations thereof.

The logistics management system 108 can utilize the information included in the request, in part, to identify an electronic locker arrangement to receive the item 410. In various implementations, the logistics management system 108 can identify an electronic locker arrangement that is within a threshold distance of the recipient of the item 410. Additionally, the logistics management system 108 can identify an electronic locker arrangement that has the capacity to store the item 410. For example, the logistics management system 108 can identify an electronic locker arrangement that has an available locker to hold the item 410. In certain implementations, the logistics management system 108 can identify an available locker to store the item 410 based at least partly on first sensor data indicating one or more lockers that are storing items, second sensor data indicating one or more lockers that are free of an item, characteristics of one or more lockers (e.g., refrigerated, air conditioned, padded, etc.), information indicating pick up times for one or more items stored by one or more electronic locker arrangements, information indicating delivery times of one or more items at one or more electronic locker arrangements, a type of the item 410, a weight of the item 410, one or more dimensions of the item 410, one or more dimensions of lockers included in a number of electronic locker arrangements, one or more characteristics of the item 410, or combinations thereof.

After identifying an electronic locker arrangement to store the item 410, such as the electronic locker arrangement 110, the logistics management system 108 can determine an identifier of the electronic locker arrangement 110. In some cases, the identifier of the electronic locker arrangement 110 can include a zip code of the electronic locker arrangement 110. In other situations, the identifier of the electronic locker arrangement 110 can include an alphanumeric string that identifies the electronic locker arrangement 110 throughout the logistics management system 108. That is, in these situations, the logistics management system 108 can store an identifier of the electronic locker arrangement 110 that is utilized to specifically indicate the electronic locker arrangement 110 whenever the electronic locker arrangement 110 is referenced within the logistics management system 108. In still additional scenarios, the logistics management system 108 can generate an identifier for the electronic locker arrangement 110 that is associated with the specific transaction to deliver the item to the electronic locker arrangement 110. In certain implementations, the logistics management system 108 can generate an identifier for the electronic locker arrangement 110 that uniquely identifies the electronic locker arrangement 110 with respect to delivery of the item 410.

The logistics management system 108 can send the identifier of the electronic locker arrangement 110 to the computing device 408 as the locker identifier 422. Additionally, the user 406 can operate the computing device 408 to send the locker identifier 422 to the third-party service provider 412 via the one or more user interfaces 418. In particular implementations, the locker identifier 422 can be sent to the third-party service provider 412 in conjunction with the delivery address 420. For example, the one or more user interfaces 418 can include one or more user interface elements to capture the delivery address 420, the locker identifier 422, and other information, such as an identifier of the recipient of the item 410. In an illustrative example, a user interface 118 can include a user interface element to capture an identifier of the recipient of the item 410 and the locker identifier 422 can be entered into the user interface element in addition to the identifier of the recipient of the item 410.

The third-party service provider 412 can generate the delivery information 424 based at least partly on the deliver address 420 and the locker identifier 422. The delivery information 424 can be sent to an additional computing device 424 of a courier 426. The courier 426 can be a representative of the delivery service provider 414. In implementations where the third-party service provider 412 is the online retailer 416, the online retailer 416 can provide the delivery information 424 to the delivery service provider 414 to deliver the item 410 to the electronic locker arrangement 110. The delivery service provider 414 can then send the delivery information to the computing device 424 of the courier 426. In some implementations, the delivery information 424 can be placed onto the item 410. For example, a label can be printed that includes the delivery information 424 and the label can be affixed to the item 410. In particular implementations, the delivery information 424 may not be sent to the additional computing device 424, but printed on a label affixed to the item 410. In this way, the courier 426 can determine where to deliver the item 410 in situations where the courier 426 has access to the delivery information 424 via the additional computing device 424 or via a label (or other instrument) coupled with the item 410. To illustrate, the delivery address 420 can indicate that the item 410 is to be delivered to the address of the location 402 and the locker identifier 422 can indicate that the item is to be delivered to the electronic locker arrangement 110 instead of to the building 404.

To deliver the item 410 to the electronic locker arrangement 110, the courier 426 can provide locker access information 426 to the electronic locker arrangement 110 in relation to the delivery of the item 410. In some implementations, the electronic locker arrangement 110 can generate one or more user interfaces to capture the locker access information 426. In some examples, the locker access information 426 can include an identifier of the recipient of the item 410. In other examples, the locker access information 426 can include an access code that is associated with delivery of the item 410 to the recipient. In certain implementations, the logistics management system 108 can generate the access code and send the access code to the computing device 408, and in turn, the user 406 can operate the computing device 408 to send the access code to the third-party service provider 412. In various implementations, the access code can be entered into a user interface element of the one or more user interfaces 418 and the access code can be provided to the delivery service provider 414 that then provides the access code to the courier 426. In particular implementations, the access code can be included in or comprise the locker identifier 422. Additionally, the locker access information 426 can include an identifier of the item 410. To illustrate, the locker access information 426 can include a bar code of the item 410 that is scanned via the electronic locker arrangement 110. In additional implementations, the courier 426 can access a look-up user interface and enter an identifier of the recipient, such as a name of the recipient. In some implementations, the electronic locker arrangement 110 can then provide a locker number to which the item 410 is to be delivered. In other implementations, the courier can request access to the locker specified by the locker identifier 422. In certain implementations, the electronic locker arrangement 110 can cause the locker to open upon obtaining the name of the recipient, such as by providing a signal to deactivate a magnetic latch that is causing the door of the locker to remain closed.

In implementations, the electronic locker arrangement 110 can send at least a portion of the locker access information 426 to the logistics management system 108. In particular, the electronic locker arrangement 110 can send a locker access request 428 to the logistics management system 108. The logistics management system 108 can authenticate information included in the locker access request 428 to determine whether the courier 426 can access the electronic locker arrangement 110 to deliver the item 410. For example, the electronic locker arrangement 110 can include an access code in the locker access request 428 and the logistics management system 108 can authenticate the access code. In some implementations, the logistics management system 108 can authenticate the access code by parsing a data store of the logistics management system 108 for data indicating that the access code is associated with the item 410. To illustrate, in response to the logistics management system 108 generating the locker identifier 422 at the request of the user 406 for the delivery of the item 410, the logistics management system 108 can produce a data structure that stores information regarding a transaction to deliver the item 410. The data structure can store the locker identifier 422 and other information related to the delivery of the item 410, such as an access code, an identifier of the recipient, an identifier of the user 406, an identifier of the electronic locker arrangement 110, combinations thereof, and the like. In some instances, the data structure is associated with an account of the sender of the item with the logistics management system 108. To authenticate information included in the locker access request 428, the logistics management system 108 can access the data structure generated by the logistics management system 108 in relation to the request to deliver the item 410 and determine that the information included in the locker access request 428 corresponds to the information stored in the data structure. In situations where the information included in the locker access request 428 corresponds to the information stored in the data structure associated with the request to deliver the item 410, the logistics management system 108 can send data to the electronic locker arrangement 110 to grant access to the courier 426 to deliver the item 410 to a locker of the electronic locker arrangement 110. In certain implementations, the access code can include a QR code. In particular implementations, the access code can include a QR code generated by the logistics management system 108 and sent to the additional computing device 424 in response to a request from the additional computing device 424 for the QR code.

In additional implementations, the logistics management system 108 can communicate with the delivery service provider 414 to determine whether or not to provide access by the courier 426 to the electronic locker arrangement 110. In these implementations, the locker access request 428 can include a bar code or other identifier of the item 410. The bar code or other identifier of the item 410 can be generated by the delivery service provider 414 to track movement of the item 410 and delivery of the item 410. In some implementations, updates to the location of the item 410 can be obtained by the delivery service provider 414. To illustrate, the additional computing device 424 can send location information to the delivery service provider 414 that indicates the location of the item 410. In certain situations, the additional computing device 424 can send status information to the delivery service provider 414. The status information can indicate that the item 410 is at a distribution center, in transit to the distribution center, in transit to a delivery location, within a certain distance of the delivery location, combinations thereof, and the like.

In various implementations, the logistics management system 108 can receive the locker access request 428, and in response, the logistics management system 108 can send delivery verification information 430 to the delivery service provider 414 to authenticate the courier 426 to access the electronic locker arrangement 110 and deliver the item. In some implementations, the delivery verification information 430 can include a bar code of the item 410, another identifier of the item 410, an identifier of the courier 426, or combinations thereof, that have been obtained via the electronic locker arrangement 110. The logistics management system 108 can send the delivery verification information 430 to the delivery service provider 414 via one or more application programming interface (API) calls. In particular, the computing architectures and/or computing environments of the logistics management system 108 and the delivery service provider 414 can operate utilizing different platforms, such as different operating systems or different communication protocols. In these situations, the logistics management system 108 can obtain API calls from the delivery service provider 414 that can be utilized to obtain updates to the location and/or status of the item 410. For example, a bar code of the item 410 can be sent from the logistics management system 108 to the delivery service provider 414 in conjunction with one or more API calls that obtain the delivery status and/or location of the item 410.

After obtaining the delivery status and/or location of the item 410 from the delivery service provider 414, the logistics management system 108 can determine that the courier 426 is authorized to access the electronic locker arrangement 110 and deliver the item 410. In various implementations, the logistics management system 108 can determine that a location of the item 410 corresponds to a location of the electronic locker arrangement 110 to determine that the courier 426 can access the electronic locker arrangement. Additionally, the logistics management system 108 can determine that the delivery status of the item 410 obtained from the delivery service provider 414 indicates that the courier 426 is located at the electronic locker arrangement 110 and that the locker access request 428 is a valid request to access the electronic locker arrangement 110. Further, the logistics management system 108 can utilize an identifier of the recipient, an identifier of the item, or both obtained from the electronic locker arrangement 110 to determine that the courier 426 can access the electronic locker arrangement. In response to determining that the courier 426 can access the electronic locker arrangement, the logistics management system 108 can send a signal to the electronic locker arrangement 110 to open a locker of the electronic locker arrangement 110 that has been designated to store the item 410. By verifying the location of the item 410 and/or status of the item 410 with the delivery service provider 414, the logistics management system 108 improves the security of the electronic locker arrangement 110 by preventing unauthorized access to the electronic locker arrangement 110.

In additional implementations, an identifier of the item 410, such as a bar code, can be scanned at the electronic locker arrangement 110 and sent to the logistics management system 108. The logistics management system 108 can utilize one or more API calls to provide the identifier of the item 410 to the delivery service provider 414. The delivery service provider 414 can access a database of the delivery service provider 414 to determine whether or not the identifier of the item 410 is stored in the database of the delivery service provider 414. To illustrate, the delivery service provider 414 can parse a database of the delivery service provider 414 to identify an identifier that corresponds to the identifier of the item 410. The delivery service provider 414 can provide first information to the logistics management system 108 indicating that the identifier of the item 410 does correspond to an item stored by the database of the delivery service provider 414. In these situations, the logistics management system 108 can determine that the delivery of the item 410 to the electronic locker arrangement 110 is an authorized delivery and grant access to the electronic locker arrangement 110 for the delivery of the item 410. In other scenarios, the delivery service provider 414 can provide second information to the logistics management system 108 indicating that the identifier of the item 410 does not correspond to an item stored by the database of the delivery service provider 414. In these instances, the logistics management system 108 can determine that the delivery of the item 410 to the electronic locker arrangement 110 is unauthorized. As a result, the logistics management system 108 can send data to the electronic locker arrangement 108 indicating that entry to the electronic locker arrangement by the courier 426 is to be denied. In certain implementations, the logistics management system 108 can send data to the electronic locker arrangement 110 to display an error message. In this way, secure access to the electronic locker arrangement 110 can be implemented and unauthorized access to the electronic locker arrangement 110 can be prevented.

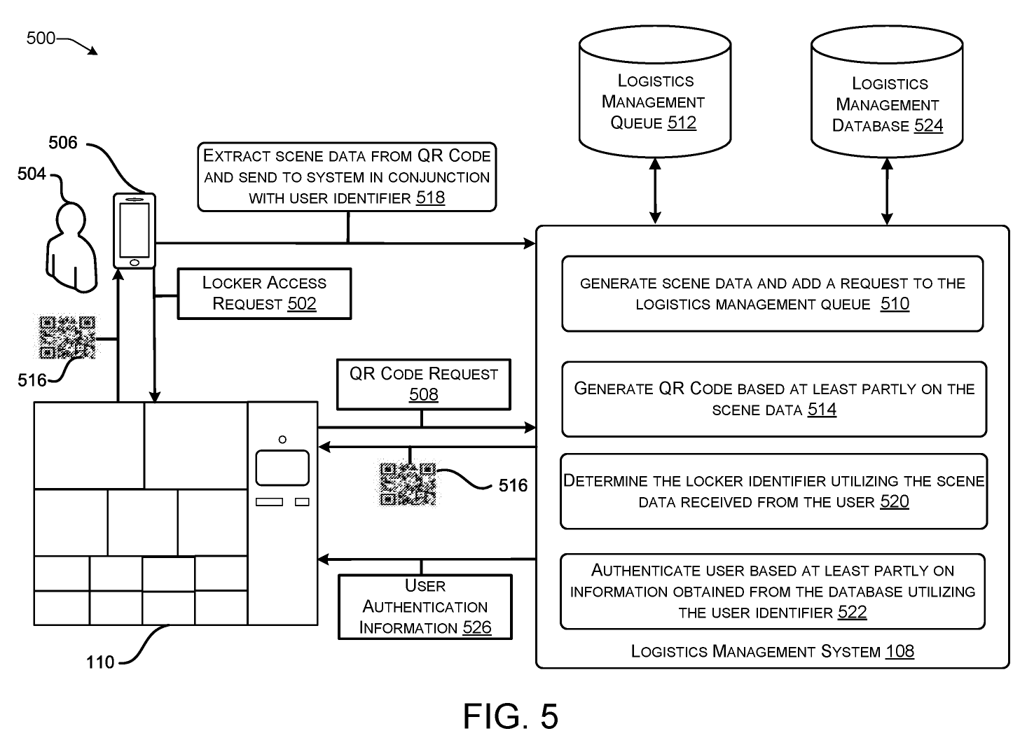

FIG. 5 is a diagram of an architecture 500 to provide secure access to an electronic locker arrangement 110 for the delivery of an item from a sender to a recipient according to some implementations. In particular, the electronic locker arrangement 110 can receive a locker access request 502 from a user 504 via a computing device 506 of the user 504. In other implementations, the locker access request 502 can be obtained via one or more user interfaces displayed by the electronic locker arrangement 110. The user 504 can be any individual attempting to gain access to a locker of the electronic locker arrangement 110 to obtain an item being stored by the electronic locker arrangement 110. In some illustrative examples, the user 504 can include a courier requesting access to obtain an item that is to be delivered from the electronic locker arrangement 110 to an additional electronic locker arrangement. In other illustrative examples, the user 504 can include a recipient that is requesting to pick up an item that is being delivered to the recipient from a sender of the item. In various implementations, the locker access request 502 can include an identifier of the item that the user 504 is attempting to obtain from the electronic locker arrangement 110. In certain implementations, the locker access request 502 can include an identifier of the user 504.

Based at least partly on receiving the locker access request 502, the electronic locker arrangement 110 can send a QR code request 508 to the logistics management system 108. At 510, the logistics management system 108 can generate scene data in response to receiving the QR code request 508 and add a request to the logistics management queue 512. In particular implementations, the logistics management queue 512 can include requests for QR codes that have been provided by one or more electronic locker arrangements that are communicatively coupled to the logistics management system 108. Additionally, the scene data can include at least one of a time stamp corresponding to a time that the locker access request 502 was received or an identifier of the electronic locker arrangement 110. In particular implementations, the scene data can include a location of the electronic locker arrangement 110. The scene data can also include an identifier of a locker storing the item. At 514, the logistics management system 108 can generate a QR code 516 based at least partly on the scene data. By utilizing the scene data to generate the QR code 516, the logistics management system 108 can generate a QR code 516 that uniquely identifies the user 504 with respect to an item that the user 504 is attempting to obtain from the electronic locker arrangement 110. The QR code 516 can, in certain implementations, encode information included in the scene data.

The logistics management system 108 can send the QR code 516 to the electronic locker arrangement 110. The electronic locker arrangement 110 can display the QR code 516 via a display device of the electronic locker arrangement 110. The user 504 can utilize the computing device 506 to scan the QR code 516. In some cases, the QR code 516 can be scanned using a logistics application executed by the computing device 506. The computing device 506 can extract at least a portion of the scene data that is encoded by the QR code 516. In certain examples, the computing device 506 can extract an identifier of the locker storing the item from the QR code 516. Additionally, the computing device 506 can determine a user identifier corresponding to the user 504. In some cases, the logistics application executed by the computing device 506 can determine the user identifier based on information provided by the user 504 during registration of the logistics application. In various implementations, the user identifier can be associated with an account of the user 504 with the logistics management system 108. The computing device 506 can provide the information extracted from the scene data and the user identifier to the logistics management system 108.

At 520, the logistics management system 108 can utilize the portion of the scene data extracted from the QR code 516, such as an identifier of the locker storing the item and provided by the computing device 506 to verify an identity of the user 504. The logistics management system 108 can, at 522, utilize the user identifier and the identifier of the electronic locker arrangement 110 to parse information stored in a logistics management database 524. In particular implementations, the logistics management system 108 can access information stored by the logistics management database 524 to determine that the user 504 is authorized to obtain access to an item stored by the electronic locker arrangement 110. In some examples, the logistics management system 108 can access the logistics management database 524 to determine that the user 504 is a courier that has been selected to deliver the item to a recipient and that the courier has been authorized to pick up the item from the electronic locker arrangement 110. In other examples, the logistics management system 108 can access the logistics management database to determine that the user 504 is a recipient that is authorized to access the electronic locker arrangement 110 to obtain an item that has been sent to the recipient. In response to determining that the user 504 is authorized to access an item stored by the electronic locker arrangement 110, the logistics management system 108 can send user authentication information 526 to the electronic locker arrangement 110. The user authentication information 526 can indicate that the electronic locker arrangement 110 can open a locker storing an item that corresponds to the user 504.

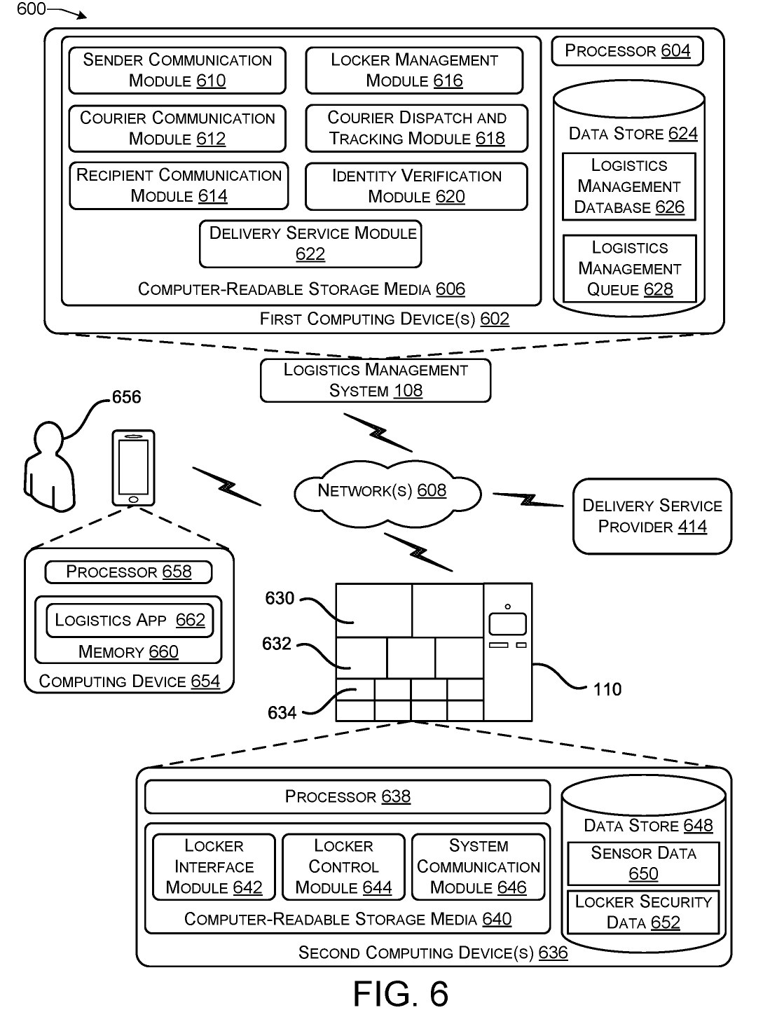

FIG. 6 is a diagram of a system 600 including an electronic locker arrangement 110, a logistics management system 108, and a logistics mobile application to facilitate the delivery of an item from a sender to a recipient according to some implementations. The system 600 may include one or more first computing devices 602. The one or more first computing devices 602 can be associated with the logistics management system 108. In some implementations, the one or more first computing devices 602 can be included in a cloud computing architecture that operates the one or more first computing devices 602 on behalf of a service provider implementing the logistics management system 108. In these scenarios, the cloud computing architecture can implement one or more virtual machine instances on behalf of the service provider associated with the logistics management system 108 on the one or more first computing devices 602. The cloud computing architecture can be located remote from a service provider associated with the logistics management system 108. In additional implementations, the one or more first computing devices 602 can be under the direct control of the service provider associated with the logistics management system 108. For example, the service provider associated with the logistics management system 108 can maintain the one or more first computing devices 602 to perform operations related to coordinating and managing the delivery of items from senders to recipients. In various implementations, the one or more first computing devices 602 can include one or more server computers.

The one or more first computing devices 602 can include one or more processors, such as processor 604. The one or more processors 604 can include at least one hardware processor, such as a microprocessor. In some cases, the one or more processors 604 can include a central processing unit (CPU), a graphics processing unit (GPU), or both a CPU and GPU, or other processing units. Additionally, the one or more processors 604 can include a local memory that may store program modules, program data, and/or one or more operating systems.

In addition, the one or more first computing devices 602 can include one or more computer-readable storage media, such as computer-readable storage media 606. The computer-readable storage media 606 can include volatile and nonvolatile memory and/or removable and non-removable media implemented in any type of technology for storage of information, such as computer-readable instructions, data structures, program modules, or other data. Such computer-readable storage media 606 can include, but is not limited to, RAM, ROM, EEPROM, flash memory or other memory technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, removable storage media, or any other medium that can be used to store the desired information and that can be accessed by a computing device. Depending on the configuration of the one or more first computing devices 602, the computer-readable storage media 606 can be a type of tangible computer-readable storage media and can be a non-transitory storage media.

The one or more first computing devices 602 can include one or network interfaces (not shown) to communicate with other computing devices via one or more networks 608. The one or more networks 608 can include one or more of the Internet, a cable network, a satellite network, a wide area wireless communication network, a wired local area network, a wireless local area network, or a public switched telephone network (PSTN).

The computer-readable storage media 606 can be used to store any number of functional components that are executable by the one or more processors 604. In many implementations, these functional components comprise instructions or programs that are executable by the one or more processors 604 and that, when executed, implement operational logic for performing the operations attributed to the one or more first computing devices 602. Functional components of the one or more first computing devices 602 that can be executed on the one or more processors 604 for implementing the various functions and features related to coordinating and managing the delivery of items utilizing electronic locker arrangements, as described herein, include a sender communication module 610, a courier communication module 612, a recipient communication module 614, a locker management module 616, a courier dispatch and tracking module 618, an identity verification module 620, and a delivery service module 622.

Additionally, the one or more first computing devices 602 can include one or more input/output devices (not shown). The one or more input/output devices can include a display device, keyboard, a remote controller, a mouse, a printer, audio input/output devices, a speaker, a microphone, a camera, and so forth

The one or more first computing devices 602 can also include, or be coupled to, a data store 624 that can include, but is not limited to, RAM, ROM, EEPROM, flash memory, one or more hard disks, solid state drives, optical memory (e.g. CD, DVD), or other non-transient memory technologies. The data store 624 can maintain information that is utilized by the one or more first computing devices 602 to perform operations related to coordinating and managing the delivery of items utilizing electronic locker arrangements. For example, the data store 624 can store a logistics management database 626 and a logistics management queue 628.

The logistics management database 626 can include information indicating transactions related to the delivery of items from senders to recipients. For each request by a sender to have an item delivered to a recipient using the logistics management system 108, the logistics management database 626 can generate a set of data stored in a data structure, such as a database table, one or more rows of a database table, and/or a record, dedicated to storing information associated with coordinating and managing the delivery of the item from the sender to the recipient. For example, the logistics management database 626 can store information about the sender and the recipient. To illustrate, the logistics management database 626 can store names of the sender and recipient, locations of the sender and recipient, payment information for the sender and/or the recipient, delivery preferences of the sender and/or recipient, combinations thereof, and the like. The locations of the sender and recipient can include an address, a zip code, an Internet Protocol (IP) address, a real-time location, or combinations thereof. A real-time location of the sender and the recipient can include Geographic Positioning System (GPS) information, location information obtained from a mobile communications service provider (e.g., triangulation data), or both. In situations where the sender and/or the recipient have an account with the logistics management system 108, the logistics management database 626 can include respective login identifiers, passwords, and the like to enable the sender and/or recipient to access their account with the logistics management system 108.

The logistics management database 626 can also store information about items being delivered from recipients to senders. For example, the logistics management database 626 can store information indicating the weight of an item to be delivered, dimensions of an item to be delivered, a category or type of the item to be delivered (e.g., electronic device, baby products, household goods, etc.), images of the item to be delivered, a description of the item to be delivered, notes regarding the item to be delivered (e.g., fragile, irregular shape, perishable, etc.), combinations thereof, and so forth. Additionally, the logistics management database 626 can store information indicating timing related to the delivery of the item, such as a time that the item was dropped off by a sender at an electronic locker arrangement, a time that the item was picked up by a courier at an electronic locker arrangement, a time that the item was dropped off by a courier at an electronic locker arrangement, a time that a recipient picked up the item from an electronic locker arrangement, or combinations thereof. The logistics management database 626 can also store information indicating a time that the item is to be made available for pickup by a recipient and/or a time that the item is to be made available for pickup by a courier. In some cases, the logistics management database 626 can indicate a window of time that the item is to be available for pickup by a recipient or a courier. In other instances, the logistics management database 626 can indicate a threshold time (e.g., deadline) that the item is to be delivered to an electronic locker arrangement and available for pickup by a recipient or courier. In various implementations, the logistics management database 626 can store a status of items being delivered. The status of the items can indicate that the items have been dropped off by a sender or a courier, that the items are available for pick up by a courier or a recipient, that the items are in transport from one electronic locker arrangement to another electronic locker arrangement, or combinations thereof.

Further, the logistics management database 626 can include information related to individual couriers that are assigned to transport items between one or more electronic locker arrangements. To illustrate, the logistics management database 626 can include information indicating identifiers of couriers, delivery history of couriers, ratings of couriers, locations associated with couriers, combinations thereof, and the like. The delivery history of couriers can indicate a number of items delivered by individual couriers, types of items delivered by individual couriers, electronic locker arrangements accessed by individual couriers, times that items were delivered by individual couriers, or combinations thereof. The ratings of the couriers can be obtained from senders and/or recipients of items that were delivered by the individual couriers. In some cases, the ratings of the couriers can be obtained by the logistics management system 108 analyzing data related to metrics associated with delivery of items by couriers, such as on-time delivery by the couriers, time to transport items between electronic locker arrangements, errors made in the delivery of items, number of lost or damaged items, combinations thereof, and so forth. Additionally, the location information stored by the logistics management database 626 in conjunction with the delivery of items can indicate a real-time location of the couriers, locations indicated in profiles of the couriers, locations of electronic locker arrangements where the couriers have picked up and dropped off items, or combinations thereof. In certain implementations, the logistics management database 626 can indicate a status of couriers. The status of the couriers can indicate that the couriers are accepting items for delivery. In other situations, the status of the couriers can indicate that the couriers are not accepting items for delivery. In particular implementations, the status of the couriers can also indicate locations where the couriers are accepting items for delivery. The logistics management database 626 can also include a queue of items that are to be delivered by individual couriers.

The logistics management database 626 can also store information about electronic locker arrangements associated with the logistics management system 108. In some situations, the logistics management database 626 can store information indicating lockers of the electronic locker arrangements that are occupied with an item. The logistics management database 626 can also store information indicating lockers of the electronic locker arrangements that are scheduled to store items for drop off or pick up. Additionally, the logistics management database 626 can store information indicating dimensions of the lockers included in the electronic locker arrangements and/or weight capacities of the lockers of the electronic locker arrangements. In the illustrative example of FIG. 6, the representative electronic locker arrangement 110 can include a first locker 630 having first dimensions and/or a first weight capacity, a second locker 632 having second dimensions and/or a second weight capacity, and a third locker 634 having third dimensions and/or a third weight capacity. The first locker 630 can have larger dimensions and/or a higher weight capacity than both the second locker 632 and the third locker 634. The second locker 632 can have larger dimensions and/or a higher weight capacity than the third locker 634. In certain situations, at least one of the lockers 630, 632, 634 can be refrigerated or heated. The logistics management database 626 can also store information indicating that doors of the lockers of the individual electronic locker arrangements are open or closed.

In an illustrative implementation, the logistics management database 626 can include at least one data structure for individual requests to deliver an item from a sender to a recipient. The at least one data structure for an individual request to deliver an item can at least in part include an identifier of a sender, an identifier of a recipient, a location of a sender, a location of a recipient, dimensions of the item, category of the item, description of the item, images of the item, characteristics of the item (e.g., perishable, irregular shape), combinations thereof, and the like. Additionally, the at least one data structure for an individual request to deliver an item can at least in part include an identifier of a courier assigned to deliver the item, an identifier of at least one electronic locker arrangement assigned to store the item, an identifier of at least one particular locker assigned to store the item, or combinations thereof. Further, the at least one data structure for an individual request to deliver an item can include a location of a courier delivering the item, a location of the item, a status of at least one locker assigned to store the item (e.g., occupied, empty, door open, door closed), or combinations thereof. The at least one data structure for an individual request to deliver an item can also include one or more identifiers related to the item, such as one or more bar codes assigned to the item. In other implementations, the at least one data structure for an individual request to deliver an item can include authentication information to obtain access to at least one locker storing the item, such as a QR code provided in association with granting access to the at least one locker storing the item. In certain implementations, the at least one data structure for an individual request to deliver an item can include timing information related to the delivery of an item, such as drop off times, pick up times, delivery deadlines, time that the request to deliver the item was made or received, time that requests for authentication information were made or received, combinations thereof, and so forth.

The logistics management queue 628 can include requests that are awaiting processing by the one or more first computing devices 602. In particular implementations, the logistics management queue 628 can include requests to obtain QR codes that are received from electronic locker arrangements. The logistics management queue 628 can store the requests sequentially as they are received and provide the requests to the corresponding modules 610, 612, 614, 616, 618, 620, 622 based at least partly on the order in which the requests were received. In certain implementations, the logistics management queue 628 can provide the requests for processing by the modules 610, 612, 614, 616, 618, 620, 622 based on a priority associated with the requests.

The sender communications module 610 can include computer-readable instructions that when executed by the processor 604 send, receive, process, and store information corresponding to communications associated with a sender of an item to a recipient. In some implementations, the sender communication module 610 can obtain a request from a sender for an item to be delivered to a recipient. The request can indicate information about the sender, information about the item to be delivered, and information about the recipient. In particular implementations, the sender communication module 610 can provide a website to obtain requests from senders to deliver items to recipients. In additional implementations, the sender communications module 610 can be in communication with a mobile application executed by a computing device of a sender to obtain a request to deliver an item to a recipient. The sender communication module 610 can also provide information related to the delivery of the item to a computing device of the sender. For example, the sender communication module 610 can provide a notification that the item has been picked up by a courier or delivered to an electronic locker arrangement by a courier. The sender communication module 610 can also provide a notification that the recipient has picked up the item. Further, the sender communication module 610 can obtain payment information from the sender of the item.

The courier communication module 612 can include computer-readable instructions that when executed by the processor 604 send, receive, process, and store information corresponding to communications associated with a courier transporting an item between electronic locker arrangements. The courier communication module 612 can provide communications indicating that an item is available for delivery to a recipient. In some cases, the communications can include information about the item, a location of a first electronic locker arrangement storing the item, and a location of a second electronic locker arrangement where the item is to be delivered. The communications can also include an amount of payment for delivery of the item and/or a time by which the item is to be delivered. The courier communication module 612 can also obtain communications from couriers indicating a request to deliver an item and notifications that the couriers have been selected to deliver one or more items that are available to be delivered. In various implementations, the courier communication module 612 can obtain information indicating a status of couriers and/or information indicating locations where the couriers are available to deliver items. In particular implementations, the courier communications module 612 can obtain and provide communications related to couriers via a web site. In additional implementations, the courier communication module 612 can be in communication with a mobile app executed by computing devices of couriers to obtain information from couriers and to provide information to couriers.

The recipient communication module 614 can include computer-readable instructions that when executed by the processor 604 send, receive, process, and store information corresponding to communications associated with a recipient of an item delivered via the logistics management system 108. The recipient communication module 614 can provide notifications to recipients that items are available to be picked up by the recipients. The notifications can include locations of locker arrangements that are storing items to be picked up the recipients. The notifications can also include information about the sender of the item. In some cases, the recipient communication module 614 can provide updates indicating a location of an item as it is being transported to an electronic locker arrangement for delivery to a recipient. Additionally, the recipient communication module 614 can obtain information from recipients that the recipients have obtained the items that are intended to be delivered to the recipients. In some implementations, the recipient communication module 614 can obtain and provide communications related to the delivery of items to recipients via a web site. In additional implementations, the recipient communication module 614 can be in communication with a mobile app executed by computing devices of recipients to obtain information from recipients and to provide information to recipients.

In particular implementations, the sender communication module 610, the courier communication module 612, and the recipient communication module 614 can utilize a Short Messaging Service (SMS) gateway to communicate with senders, couriers, and recipients regarding items to be delivered to recipient from senders. The sender communication module 610, the courier communication module 612, and the recipient communication module 614 can also utilize an application programming interface (API) to facilitate communications between the one or more first computing devices 602 and computing devices of the senders, recipients, and couriers. In illustrative implementations, the API can include a representational state transfer (RESTful) API to facilitate communications between the one or more first computing devices 602 and computing devices of the senders, recipients, and the couriers. In particular, the API includes a number of calls that enable information to be exchanged between a platform of the one or more first computing devices 602 and various platforms of the computing devices of the senders, recipients, and the couriers that can be different from the platform of the one or more first computing devices 602. In some cases, the different platforms utilized by the one or more first computing devices 602 and the computing devices of the senders, recipients, and the couriers can correspond to different operating systems, different communication protocols, and/or different resource types (e.g., extensible markup language (XML) resources, hypertext markup language (HTML) resources, java script object notation (JSON) resources).

The locker management module 616 can include computer-readable instructions that when executed by the processor 604 coordinate the assignment of lockers at electronic locker arrangements to facilitate the delivery of items via the electronic locker arrangements. The locker management module 616 can be in communication with the sender communication module 610 or the logistics management database 626 to determine that a request has been received to deliver an item from a sender to a recipient. The locker management module 616 can utilize information included in the request to identify one or more electronic locker arrangements to store the item being delivered. The locker management module 616 can also determine specific lockers within an electronic locker arrangement to store the item.

In particular implementations, the locker management module 616 can determine a location of a sender of an item and determine a location of a recipient of the item. The locker management module 616 can also determine one or more electronic locker arrangements that correspond to the location of the sender and the location of the recipient. In an illustrative example, the locker management module 616 can determine a zip code of the sender and a zip code of the recipient. Continuing with this example, the locker management module 616 can determine one or more electronic locker arrangements that correspond to the zip code of the sender and the zip code of the recipient. In situations where the sender and the recipient are located in the same zip code, the locker management module 616 can identify a single electronic locker arrangement to utilize to deliver the item where the single electronic locker arrangement is located in the zip code of the sender and recipient. In scenarios where the sender and the recipient are located in different zip codes, the locker management module 616 can determine a first electronic locker arrangement located in the zip code of the sender to drop off the item and a second electronic locker arrangement in the zip code of the recipient for the recipient to pick up the item. In some implementations, the locker management module 616 can determine one or more intermediate electronic locker arrangements located between a first electronic locker arrangement located in a location of the sender and a second electronic locker arrangement located in a location of the recipient.

In additional implementations, the locker management module 616 can determine one or more electronic locker arrangements that are within a threshold distance of the location of the sender and the location of the recipient. In these situations, there can be multiple electronic locker arrangements disposed in a single zip code or there can be a single electronic locker arrangement that services multiple zip codes. In illustrative implementations, the locker management module 616 can identify one or more electronic locker arrangements that are within a threshold distance of a location of the sender to determine an electronic locker arrangement for the sender to drop off the item. The locker management module 616 can also identify one or more electronic locker arrangements that are within a threshold distance of a location of the recipient to determine an electronic locker arrangement for the recipient to pick up the item. In certain implementations, the threshold distance can include a radius or one or more other dimensions that define an area serviced by each electronic locker arrangement. The locker management module 616 can identify a first electronic locker arrangement to drop off the item based at least partly on determining that the sender of the item is located within an area serviced by the first electronic locker arrangement. The locker management module 616 can also identify a second locker arrangement for the recipient to pick up the item based at least partly on determining that the recipient of the item is located within an area serviced by the second electronic locker arrangement. In situations where a sender and/or recipient are located within service areas of multiple electronic locker arrangements, the locker management module 616 can determine the electronic locker arrangement that is within a shortest distance from the location of the sender and/or recipient to utilize for drop off and/or pick up of the item.

In various implementations, the locker management module 616 can determine one or more locker arrangements to store the item based at least partly on input obtained from the sender. In some cases, the locker management module 616 can obtain first input from the sender indicating a first electronic locker arrangement to store the item and second input from the sender indicating a second electronic locker arrangement to store the item. In particular implementations, the locker management module 616 can obtain the input indicating one or more electronic locker arrangements to store the item via a mobile app executed by a computing device of the sender or via a website of a service provider associated with the logistics management system 108. In certain implementations, the locker management module 616 can obtain information from an electronic locker arrangement indicating one or more electronic locker arrangements to store the item. For example, an electronic locker arrangement can provide one or more user interfaces to capture input indicating one or more electronic locker arrangements to store the item and provide the input to the locker management module 616. In an illustrative example, the locker management module 616 can obtain input from an individual specifying one or more electronic locker arrangements to store an item based at least partly on the sender and/or the recipient being located in a location that does not include an electronic locker arrangement. To illustrate, in situations where a sender and/or recipient is located in a zip code that does not include an electronic locker arrangement, input can be provided by an individual indicating an electronic locker arrangement where an item is to be dropped off or picked up. In some scenarios, the locker management module 616 can provide a suggestion indicating an electronic locker arrangement that is nearest the sender and/or recipient to store an item.

Further, the locker management module 616 can identify specific lockers within the one or more electronic locker arrangements that are to be utilized to deliver an item to a recipient. For example, the locker management module 616 can identify one or more lockers included in the one or more electronic locker arrangements that are available to store the item. The locker management module 616 can determine criteria, such as dimensions and/or a weight, of an item to be stored by an electronic locker arrangement and identify one or more lockers that satisfy the criteria of the item. To illustrate, the locker management module 616 can determine one or more lockers that the item can fit within by comparing dimensions of the item with dimensions of lockers of electronic locker arrangements. Based at least partly on the dimension and/or weight criteria and the availability of lockers, the locker management module 616 can assign at least one locker to store an item. In some cases, the locker management module 616 can assign a first locker to store the item until the item is picked up by a courier and a second locker to store the item until the item is picked up by the recipient. In other situations, the locker management module 616 can assign a single locker to store the item until the item is picked up by the recipient. The locker management module 616 can cause information to be stored in the logistics management database 626 indicating the one or more lockers assigned to store an item.

In particular situations, the locker management module 616 can process requests for delivery of multiple items to the same recipient. In these scenarios, the locker management module 616 can determine that the items can be stored in a single locker at one or more electronic locker arrangements or at multiple lockers of one or more electronic locker arrangements. The number of lockers assigned to store multiple items for a single recipient can be based at least partly on dimensions of the items with respect to dimensions of lockers and/or availability of lockers to store the items. In certain implementations, the items to be delivered to a recipient can be stored in a first number of lockers at a first electronic locker arrangement and a second number of lockers, different from the first number, at a second electronic locker arrangement.

In various implementations, the locker management module 616 can provide information to electronic locker arrangements that can be utilized to control access to the lockers of the electronic locker arrangements. In particular implementations, the locker management module 616 can provide signals to open and/or close particular lockers of an electronic locker arrangement. In some situations, the locker management module 616 can cause the electronic locker arrangements to display user interfaces and to obtain input from the electronic locker arrangements via the user interfaces. For example, the locker management module 616 can cause an electronic locker arrangement to display user interfaces related to obtaining a request by a sender to have an item delivered to a recipient. In other examples, the locker management module 616 can cause an electronic locker arrangement to display user interfaces related to providing and/or obtaining bar codes associated with an item. In additional examples, the locker management module 616 can cause an electronic locker arrangement to display user interfaces related to providing and/or obtaining user identity authentication information, such as QR codes or biometric information, in association with users obtaining access to lockers of the electronic locker arrangement to pick up an item stored by the electronic locker arrangement.

The locker management module 616 can dynamically and in real-time manage and coordinate assignments of items to lockers of electronic locker arrangements. In particular implementations, the locker management module 616 can process hundreds, up to thousands of requests at a time for items to be stored in lockers of electronic locker arrangements that are in communication with the logistics management system. In some implementations, the electronic locker arrangements in communication with the logistics management system 108 can be owned and/or managed by different entities. For example, some electronic locker arrangements in communication with the logistics management system 108 can be owned or operated by a service provider different from the service provider associated with the logistics management system 108, but these electronic locker arrangements can still be utilized by the logistics management system to deliver items.

In order to process large numbers of requests to store items in lockers, the locker management module 616 analyzes data obtained from the electronic locker arrangements (e.g., locker door open/close status, weight sensors, video/image data, dimensions and/or weight capacities of lockers) and information included in requests to deliver items via the electronic locker arrangements (e.g., dimensions of items, weight of items, time constraints on delivery, type of item) to determine lockers that are available to store items. In various implementations, the locker management module 616 can also analyze location information for items while the items are in transit and estimate delivery times to determine the availability of lockers in electronic locker arrangements to store items. In this way, the locker management module 616 can perform a complicated analysis of data, some of which can be changing dynamically (e.g., real-time location data), to determine the availability of lockers to store items and to assign lockers to store items for delivery via electronic locker arrangements.

The courier dispatch and tracking module 618 can include computer-readable instructions that when executed by the processor 604 to identify couriers and assign the couriers to deliver items via electronic locker arrangements. The courier dispatch and tracking module 618 can obtain information from the sender communication module 610 or the logistics management database 626 indicating a request to store an item for delivery to a recipient and determine, based on the information associated with the request, the location of the sender and the recipient. In some implementations, the courier dispatch and tracking module 618 can obtain information from the locker management module 616 indicating a location of one or more electronic locker arrangements that have been assigned to store the item. The courier dispatch and tracking module 618 can also obtain courier location information indicating locations corresponding to couriers. In some situations, the courier location information can be obtained from the logistics management database. In particular implementations, the courier location information can include GPS data indicating a location of the couriers. The GPS data can, in some cases, indicate a real-time or near real-time location of the couriers. In various implementations, the courier location information can be included in profiles of couriers stored in the logistics management database 626. The profiles of the couriers can indicate geographic locations for which the respective couriers can be available to deliver items. In additional implementations, the courier location information can be obtained from mobile computing devices of the couriers. In certain implementations, the courier profiles can be modified by the couriers to indicate availability to deliver items associated with different locations at different time. For example, a courier profile can indicate that the courier is available to deliver items associated with a first location and a second location at a first time and that the courier is available to deliver items associated with a third location and a fourth location at a second time, where at least one of the third location and the fourth location are different from at least one of the first location and the second location.

The courier dispatch and tracking module 618 can compare one or more locations where the item is to be stored with locations associated with a number of couriers. The courier dispatch and tracking module 618 can identify one or more couriers associated with locations that overlap with the one or more locations where the item is to be stored. For example, the courier dispatch and tracking module 618 can determine that an item is to be stored in a particular zip code and the courier dispatch and tracking module 618 can identify one or more couriers that are associated with the same zip code. To illustrate, the courier dispatch and tracking module 618 can determine that the one or more couriers are currently located in the particular zip code based at least partly on GPS data corresponding to the one or more couriers and/or that the one or more couriers have expressed availability to deliver items in their respective profiles to deliver items in the particular zip code. In some implementations, the current location of couriers can be weighed more heavily in identifying couriers to deliver an item than locations included in profiles of the couriers.

In addition to location, the courier dispatch and tracking module 618 can also utilize one or more additional criteria to identify couriers to deliver items. In some examples, the courier dispatch and tracking module 618 can determine a number of items that couriers are already assigned to deliver in order to determine the availability of couriers to deliver items. For example, the more items that a courier is currently assigned to deliver, the less likely the courier dispatch and tracking module 618 is to select the courier for delivery of an additional item. Additionally, courier dispatch and tracking module 618 can determine ratings of couriers to identify one or more couriers to deliver an item. The ratings of the couriers can be based at least partly on performance of the couriers with respect to previous deliveries. Further, the courier dispatch and tracking module 618 can analyze previous experience with delivering certain types of items to identify one or more couriers to deliver an item. To illustrate, for certain items that may be associated with particular restrictions, such as fragile items, irregularly shaped items, perishable items, and the like, the courier dispatch and tracking module 618 can give preference to couriers that have previously delivered similar items in determining one or more couriers to deliver an item of a similar type.

By analyzing a number of criteria with respect to a group of couriers, the courier dispatch and tracking module 618 can identify a subset of the group of couriers that are candidates to deliver the item. In various implementations, the courier dispatch and tracking module 618 can determine a score for couriers included in a group of couriers based on one or more criteria and select a subset of the group of couriers having at least a threshold score. In additional implementations, the courier dispatch and tracking module 618 can identify couriers satisfying one or more criteria to identify couriers that are candidates to deliver an item. In an illustrative example, the courier dispatch and tracking module 618 can identify couriers associated with and/or located in a particular location, such as a particular zip code, to determine candidate couriers to deliver an item. Thus, the courier dispatch and tracking module 618 can filter a group of couriers based on one or more criteria to identify one or more candidate couriers to deliver an item.

After identifying one or more candidate couriers to deliver an item, the courier dispatch and tracking module 618 can invoke the courier communication module 612 to send notifications to the candidate couriers indicating that the item is available for delivery. The courier dispatch and tracking module 618 can receive responses from the candidate couriers where the responses indicate an availability to deliver the item. In some implementations, the responses can be obtained by the courier communication module 612. The courier dispatch and tracking module 618 can then select a courier from among the couriers providing responses to assign to deliver the item. In some implementations, the courier dispatch and tracking module 618 can additionally filter couriers after receiving responses to a notification to deliver an item. In some illustrative examples, the courier dispatch and tracking module 618 can filter the couriers providing responses to the notification based at least partly on times in which the responses were received. In a particular illustrative example, the courier dispatch and tracking module 618 can assign the first courier to provide a response to the notification to deliver the item. In other illustrative examples, the courier dispatch and tracking module 618 can filter the couriers providing responses to the notification based on other criteria, such as location of the couriers with respect to locations of electronic locker arrangements used to store the item, ratings of the couriers responding to the notification, number of items assigned to the respective couriers for delivery, delivery history of the couriers, combinations thereof, and the like. In certain implementations, the courier dispatch and tracking module 618 can identify a number of items to be picked up from or dropped off at a particular electronic locker arrangement. In these situations, the courier dispatch and tracking module 618 can assign a courier to deliver multiple items that are associated with different senders and/or recipients, but are being picked up from and/or dropped off at a particular electronic locker arrangement. In various implementations, the courier dispatch and tracking module 618 can perform a first filtering operation to identify candidate couriers to notify about delivery of an item and a second filtering operation to determine a particular courier to assign to deliver the item.

In response to determining a courier to deliver an item, the courier dispatch and tracking module 618 can invoke the courier communication module 612 to send a notification to the courier indicating that the courier has been assigned to deliver the item. In some implementations, the courier dispatch and tracking module 618 can cause a record or other data structure stored in the logistics management data base 626 to indicate that the courier has been assigned to deliver the item. In particular implementations, the courier dispatch and tracking module 618 can track the location of the courier assigned to deliver the item to determine the progress in the delivery of the item. The courier dispatch and tracking module 618 can determine an estimate of the delivery time of the item based at least partly on the location of the courier assigned to deliver the item. Additionally, the courier dispatch and tracking module 618 can operate in conjunction with the sender communication module 610 and/or the recipient communication module 614 to provide updates on the delivery of the item based at least partly on the location of the courier assigned to deliver the item.

The identity verification module 620 can include computer-readable instructions that when executed by the processor 604 to verify the identity of individuals attempting to access an item stored by an electronic locker arrangement. In some cases, the identity verification module 620 can verify the identity of a sender of an item. In other situations, the identity verification module 620 can verify the identity of a courier delivering the item. In additional implementations, the identity verification module 620 can verify the identity of a recipient of the item. The identity verification module 620 can verify the identity of individuals based at least partly on identifiers of the individuals. The identity verification module 620 can also verify the identity of individuals based at least partly on video data, image data, or biometric data of the individuals. Additionally, the identity verification module 620 can verify the identity of individuals based at least partly on identifiers generated by the logistics management system 108, such as bar codes and/or QR codes. In some implementations, the identity verification module 620 can utilize different types of data to verify the identity of different individuals. For example, the identity verification module 620 can verify the identity of a first individual based at least partly on a first type of data and the identity verification module 620 can verify the identity of a second individual based at least partly on a second type of data that is different from the first type of data.

In particular implementations, the identity verification module 620 can verify the identity of a sender of an item attempting to access a locker of an electronic locker arrangement to drop off the item for delivery. In these situations, the identity verification module 620 can verify the identity of the sender based at least partly on an identifier of the sender associated with the logistics management system 108. For example, the sender can provide one or more identifiers, such as a user name and password, via an electronic locker arrangement. The identity verification module 620 can then access information stored in the logistics management data base 626 to verify that the identification information provided by the sender corresponds to information stored in the logistics management database 626. The identity verification module 620 can also generate a bar code that is associated with the sender and the item being delivered. The identity verification module 620 can obtain bar code information provided by a sender from an electronic locker arrangement and analyze the bar code with respect to bar codes stored in the logistics management database 626. The identity verification module 620 can determine that the bar code information provided by the sender corresponds to a bar code associated with an item that is to be stored in the electronic locker arrangement and delivered on behalf of the sender.

The identity verification module 620 can also verify the identity of a courier delivering an item on behalf of a sender. In some implementations, the identity verification module 620 can verify the identity of the courier at a first electronic locker arrangement where the courier picks up the item and also verify the identity of the courier at a second electronic locker arrangement where the courier drops off the item for the recipient. In certain implementations, the identity verification module 620 can utilize different techniques to verify the identity of the courier at different electronic locker arrangements. For example, the identity verification module 620 can utilize a first identity verification technique to verify the identity of the courier at an electronic locker arrangement where the courier is picking up the item and a second identity verification technique to verify the identity of the courier at an additional electronic locker arrangement where the courier is dropping off the item.

In particular implementations, the identity verification module 620 can generate a QR code that can be utilized by the courier to access a locker storing an item that has been dropped off by a sender of the item. In some cases, the identity verification module 620 can obtain a request indicating that the sender is attempting to access the locker storing the item. In various implementations, the request can be provided by the electronic locker arrangement storing the item. In other scenarios, the request can be provided via an application executed by a computing device of the courier. The identity verification module 620 can generate a QR code that uniquely identifies the courier with respect to the item. For example, the identity verification module 620 can obtain a time related to the item and generate the QR code based at least partly on the time. The time related to the item can include a time that the item was stored in the electronic locker arrangement or a time that the courier requested access to the electronic locker arrangement. In another example, the identity verification module 620 can generate the QR code based on other information, such as at least one of an identifier of the courier, an identifier of the sender, an identifier of the item, an identifier of the locker storing the item, an identifier of the electronic locker arrangement storing the item, a location of the electronic locker arrangement, or a location of the courier.

In various implementations, the identity verification module 620 can provide the QR code to the electronic locker arrangement that the courier is requesting to access. In additional implementations, the identity verification module 620 can operate in conjunction with the courier communication module 612 to provide the QR code to a computing device of the courier. The identity verification module 620 can then obtain the QR code from a different device than the device that the QR code was initially sent to. That is, in cases where the QR code was sent to the computing device of the courier, the identity verification module 620 can obtain information indicating the QR code from the electronic locker arrangement that the courier is requesting to access. In these situations, the courier can display the QR code on a computing device of the courier and scan the displayed QR code at the electronic locker arrangement. The electronic locker arrangement can then send the QR code or information derived from the QR code to the identity verification module 620 to verify the identity of the courier. In instances where the QR code was first sent to the electronic locker arrangement that the courier is requesting to access, the identity verification module 620 can obtain information associated with the QR code from a computing device of the courier. In these scenarios, the electronic locker arrangement can display the QR code obtained from the identity verification module 620 and the courier can scan the displayed QR code using a computing device. The computing device can then send the QR code or information derived from the QR code back to the identity verification module 620 to verify the identity of the courier.

In response to receiving QR code information, the identity verification module 620 can analyze the information with respect to information stored by the logistics management database 626. In particular, the identity verification module 620 can compare QR code information received from the computing device of the courier or from the electronic locker arrangement and verify whether the QR code information is stored in the logistics management database 626 in association with at least the courier, the item, and the electronic locker arrangement. In cases where the identity verification module 620 determines that the QR code information received from the computing device of the courier or from the electronic locker arrangement corresponds to information stored by the logistics management database 626, the identity verification module 620 can determine that the identity of the courier has been verified.

In illustrative implementations, the identity verification module 620 can receive a request to generate a QR code from an electronic locker arrangement. In some cases, the request can be added to the logistics management queue 628. In response to receiving the request, the identity verification module 620 can generate a QR code and send the QR code to the electronic locker arrangement. Additionally, the identity verification module 620 can store the QR code and/or information encoded by the QR code in the logistics management database 626. In various implementations, the information stored by the logistics management database 626 that is related to the QR code can be stored in association with the item that the courier is attempting to pick up and/or stored in association with at least one data structure that has been created for the delivery of the item in the logistics management database 626. Subsequently, the identity verification module 620 can obtain the QR code or information derived from the QR code from a computing device of the courier. In these cases, the computing device of the courier can scan the QR code displayed by the electronic locker arrangement. In certain implementations, the identity verification module 620 can obtain an identifier that has been derived from the QR code from the computing device of the courier. The identifier can include an identifier of the electronic locker arrangement storing the item or an identifier of the particular locker storing the item. The identity verification module 620 can also receive additional information from the computing device of the courier, such as an identifier of the courier. The identity verification module 620 can access data stored by the logistics management database 626 and determine whether the identifier of the electronic locker arrangement or the identifier of the locker, in addition to other identity verification information obtained from the computing device of the courier, corresponds to the item and the courier assigned to deliver the item. The identity verification module 620 can determine that the identity of the courier has been verified based at least partly on determining that the information received from the computing device of the courier corresponds to information stored by the logistics management database 626 in relation to the item.

In some implementations, the identity verification module 620 can verify the identity of the courier utilizing a bar code. For example, in situations where the courier is dropping off an item for storage at an electronic locker arrangement, a bar code of the item can be utilized to provide access to a locker assigned to the item at the electronic locker arrangement. In some cases, the bar code used to verify the identity of the courier and provide access to the electronic locker arrangement can be the same bar code utilized by the sender to gain access to the electronic locker arrangement where the item was initially dropped off by the sender. In other situations, the bar code utilized to gain access to the electronic locker arrangement by the courier to drop off the item can be different from the initial bar code. In these instances, the identity verification module 620 can generate an additional bar code that the courier can utilize to verify the identity of the courier and access the electronic locker arrangement to drop off the item.

The identity verification module 620 can also verify the identity of a recipient that is picking up an item that is stored by an electronic locker arrangement. In particular implementations, the identity verification module 620 can generate a QR code that can be utilized by the recipient to access a locker storing an item that has been dropped off by a courier. The QR code generated by the identity verification module 620 for the recipient to access the electronic locker arrangement is different from the QR code generated by the identity verification module 620 for the courier to access an additional electronic locker arrangement that previously stored the item. In some cases, the identity verification module 620 can obtain a request indicating that the recipient is attempting to access the locker storing the item. In various implementations, the request can be provided by the electronic locker arrangement storing the item. In other scenarios, the request can be provided via an application executed by a computing device of the recipient. The identity verification module 620 can generate a QR code that uniquely identifies the recipient with respect to the item. For example, the identity verification module 620 can obtain a time related to the item and generate the QR code based at least partly on the time. The time related to the item can include a time that the item was stored in the electronic locker arrangement or a time that the recipient requested access to the electronic locker arrangement. In another example, the identity verification module 620 can generate the QR code based on other information, such as at least one of an identifier of the recipient, an identifier of the sender, an identifier of the item, an identifier of the locker storing the item, an identifier of the electronic locker arrangement storing the item, a location of the electronic locker arrangement, or a location of the recipient.

In various implementations, the identity verification module 620 can provide the QR code to the electronic locker arrangement that the recipient is requesting to access. In additional implementations, the identity verification module 620 can operate in conjunction with the recipient communication module 614 to provide the QR code to a computing device of the recipient. The identity verification module 620 can then obtain the QR code from a different device than the device that the QR code was initially sent to. That is, in cases where the QR code was sent to the computing device of the recipient, the identity verification module 620 can obtain information indicating the QR code from the electronic locker arrangement that the recipient is requesting to access. In these situations, the recipient can display the QR code on a computing device of the recipient and scan the displayed QR code at the electronic locker arrangement. The electronic locker arrangement can then send the QR code or information derived from the QR code to the identity verification module 620 to verify the identity of the recipient. In instances where the QR code was first sent to the electronic locker arrangement that the recipient is requesting to access, the identity verification module 620 can obtain information associated with the QR code from a computing device of the recipient. In these scenarios, the electronic locker arrangement can display the QR code obtained from the identity verification module 620 and the recipient can scan the displayed QR code using a computing device. The computing device can then send the QR code or information derived from the QR code back to the identity verification module 620 to verify the identity of the recipient.

In response to receiving QR code information, the identity verification module 620 can analyze the information with respect to information stored by the logistics management database 626. In particular, the identity verification module 620 can compare QR code information received from the computing device of the recipient or from the electronic locker arrangement and verify whether the QR code information is stored in the logistics management database 626 in association with the recipient, the item, and the electronic locker arrangement. In cases where the identity verification module 620 determines that the QR code information received from the computing device of the recipient or from the electronic locker arrangement corresponds to information stored by the logistics management database 626, the identity verification module 620 can determine that the identity of the recipient has been verified.

In illustrative implementations, the identity verification module 620 can receive a request to generate a QR code from an electronic locker arrangement. In some cases, the request can be added to the logistics management queue 628. In response to receiving the request, the identity verification module 620 can generate a QR code and send the QR code to the electronic locker arrangement. Additionally, the identity verification module 620 can store the QR code and/or information encoded by the QR code in the logistics management database 626. In various implementations, the information stored by the logistics management database 626 that is related to the QR code can be stored in association with the item that the recipient is attempting to pick up and/or stored in association with at least one data structure that has been created for the delivery of the item in the logistics management database 626. Subsequently, the identity verification module 620 can obtain the QR code or information derived from the QR code from a computing device of the recipient. In these cases, the computing device of the recipient can scan the QR code displayed by the electronic locker arrangement. In certain implementations, the identity verification module 620 can obtain an identifier that has been derived from the QR code from the computing device of the recipient. The identifier can include an identifier of the electronic locker arrangement storing the item or an identifier of the particular locker storing the item. The identity verification module 620 can also receive additional information from the computing device of the recipient, such as an identifier of the recipient. The identity verification module 620 can access data stored by the logistics management database 626 and determine whether the identifier of the electronic locker arrangement or the identifier of the locker, in addition to other identity verification information obtained from the computing device of the recipient, corresponds to the item and the recipient assigned to deliver the item. The identity verification module 620 can determine that the identity of the recipient has been verified based at least partly on determining that the information received from the computing device of the recipient corresponds to information stored by the logistics management database 626 in relation to the item.

In situations, where the identity verification module 620 verifies the identity of an individual requesting to access a locker of an electronic locker arrangement, the identity verification module 620 can cause the electronic locker arrangement to provide access to the individual. In some cases, the identity verification module 620 can send a signal to the electronic locker arrangement to open a locker storing the item. In scenarios where the identity verification module 620 is unable to verify the identity of an individual requesting to access a locker of an electronic locker arrangement, the identity verification module 620 can deny access to the electronic locker arrangement by the individual. To illustrate, the identity verification module 620 can send information to the electronic locker arrangement indicating that the identity of the individual requesting access to the electronic locker arrangement has been denied and to keep the door to the locker storing the item closed/locked.

The delivery service module 622 includes instructions executable by the one or more processors 604 to enable a third-party delivery service provider, such as the delivery service provider 414, to deliver an item to a recipient using an electronic locker arrangement, such as the electronic locker arrangement 110. In particular implementations, the delivery service module 622 can receive a request from a computing device of a sender of an item for a locker identifier. The locker identifier can indicate that the item is to be delivered to an electronic locker arrangement. The delivery service module 622 can generate the locker identifier. In some cases, the delivery service module 622 can generate a locker identifier that includes a zip code of an electronic locker arrangement. Additionally, the delivery service module 622 can generate a locker identifier that is associated with a particular electronic locker arrangement to which the item is to be delivered. The delivery service module 622 can also generate a locker identifier that includes a security code to grant access to the electronic locker arrangement. The locker identifier can include an alphanumeric string in some instances. In various situations, the locker identifier can include a bar code or a QR code. In particular scenarios, the delivery service module 622 can generate the locker identifier after determining an electronic locker arrangement that is to store the item. Also, the delivery service module 622 can operate in conjunction with the locker management module 616 to determine an electronic locker arrangement and a locker within the electronic locker arrangement to which the item is to be delivered.

After generating the locker identifier, the delivery service module 622 can operate in conjunction with the sender communication module 610 to send the locker identifier to the sender of the item. The sender can then provide the locker identifier to an online retailer that forwards the locker identifier to the delivery service provider 414 or the sender can directly provide the locker identifier to the delivery service provider 414. In response to obtaining the locker identifier, the third-party service provider 410 and/or the delivery service provider 414 can provide the locker identifier to a courier that is assigned by the third-party service provider 410 and/or the delivery service provider 414 to deliver the item to the recipient.

The delivery service module 622 can also obtain information from the electronic locker arrangement in relation to granting access to the electronic locker arrangement by the courier that is delivering the item. For example, the delivery service module 622 can receive a request to obtain access to the electronic locker arrangement from the courier. In some cases, the request can be obtained via the electronic locker arrangement. In these cases, the courier can operate one or more input devices of the electronic locker arrangement to request access to a locker of the electronic locker arrangement. In other situations, the request can be obtained from a computing device of the courier.

The delivery service module 622 can operate in conjunction with the identity verification module 620 to determine whether or not to grant access to the electronic locker arrangement by the courier. The delivery service module 622 can also communicate with the delivery service provider 414 to determine whether or not to grant access to the electronic locker arrangement by the courier. In some implementations, the delivery service module 622 can determine that a courier is authenticated to access the electronic locker arrangement based at least partly on a location of the item with respect to the location of the electronic locker arrangement. The delivery service module 622 can also determine that a courier is authenticated to access the electronic locker arrangement based at least partly on a location of the courier with respect to the location of the electronic locker arrangement. Additionally, the delivery service module 622 can determine that a courier is authenticated to access the electronic locker arrangement based at least partly on a status of the item.

In particular implementations, the delivery service module 622 can provide a code or other security information to the delivery service provider 414 to obtain access to the systems of the delivery service provider 414 to determine whether the courier is authorized to access the electronic locker arrangement. For example, the delivery service module 622 can query systems of the delivery service provider 414 to obtain information indicating a location of the courier, a location of the item, and/or a status of the item. In some situations, the delivery service module 622 can obtain calls of an API of the delivery service provider 414 to access information regarding the item and the courier. In various situations, the delivery service module 622 can obtain the calls of the API based on differences between platforms of the logistics management system 108 and the delivery service provider 414. After obtaining information about the location of the item, the location of the courier, the status of the item, or combinations thereof, the delivery service module 622 can determine that the location of the item and/or the location of the courier correspond with the location of the electronic locker arrangement that is designated to store the item. The delivery service module 622 can also, in some cases, determine that the status of the item indicates that the item is proximate to the electronic locker arrangement that is designated to store the item. In illustrative implementations, based on the information included in the request to access the electronic locker arrangement and the information obtained from the delivery service provider 414, the delivery service module 622 can determine that the courier is authenticated to access the electronic locker arrangement. The delivery service module 622 can operate in conjunction with the recipient communication module 614 to send a notification to the recipient that the item has been delivered to the electronic locker arrangement. The delivery service module 622 can also operate in conjunction with the locker management module 616 and/or the identity verification module 620 to send a signal to the electronic locker arrangement to open the locker.

The electronic locker arrangement 110 can include one or more second computing devices 636. The one or more second computing devices 636 can include one or more processors, such as processor 638. The one or more processors 638 can include at least one hardware processor, such as a microprocessor. In some cases, the one or more processors 638 may include a central processing unit (CPU), a graphics processing unit (GPU), or both a CPU and GPU, or other processing units. Additionally, the one or more processors 638 can include a local memory that may store program modules, program data, and/or one or more operating systems.

In addition, the one or more second computing devices 636 can include one or more computer-readable storage media, such as computer-readable storage media 640. The computer-readable storage media 640 can include volatile and nonvolatile memory and/or removable and non-removable media implemented in any type of technology for storage of information, such as computer-readable instructions, data structures, program modules, or other data. Such computer-readable storage media 640 can include, but is not limited to, RAM, ROM, EEPROM, flash memory or other memory technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, removable storage media, or any other medium that can be used to store the desired information and that can be accessed by a computing device. Depending on the configuration of the one or more second computing devices 636, the computer-readable storage media 640 can be a type of tangible computer-readable storage media and can be a non-transitory storage media.

The one or more second computing devices 636 can include one or network interfaces (not shown) to communicate with other computing devices via the one or more networks 608. The one or more networks 608 can include one or more of the Internet, a cable network, a satellite network, a wide area wireless communication network, a wired local area network, a wireless local area network, or a public switched telephone network (PSTN).

The computer-readable storage media 640 can be used to store any number of functional components that are executable by the one or more processors 638. In many implementations, these functional components comprise instructions or programs that are executable by the one or more processors 638 and that, when executed, implement operational logic for performing the operations attributed to the one or more second computing devices 636. Functional components of the one or more second computing devices 636 that can be executed on the one or more processors 638 for implementing the various functions and features related to coordinating and managing the delivery of items utilizing electronic locker arrangements, as described herein, include a locker interface module 642, a locker control module 644, and a system communication module 646.

Additionally, the one or more second computing devices 636 can include one or more input/output devices (not shown). The one or more input/output devices can include a display device, keyboard, a remote controller, a mouse, a printer, audio input/output devices, a speaker, a microphone, a camera, and so forth

The one or more second computing devices 636 can also include, or be coupled to, a data store 648 that can include, but is not limited to, RAM, ROM, EEPROM, flash memory, one or more hard disks, solid state drives, optical memory (e.g. CD, DVD), or other non-transient memory technologies. The data store 648 can maintain information that is utilized by the one or more second computing devices 636 to perform operations related to coordinating and managing the pickup and drop off of items stored by the electronic locker arrangement 110. For example, the data store 648 can store sensor data 650 and locker security data 652. The sensor data 650 can include data indicating that doors of the lockers of the electronic locker arrangement 110 are opened or closed, such as data from magnetic sensors coupled to doors of the lockers of the electronic locker arrangement 110. The sensor data 650 can also include image data, video data, and/or audio data captured by input devices of the electronic locker arrangement 110. Additionally, the sensor data 650 can include data obtained by weight sensors disposed in the lockers of the electronic locker arrangement 110. The weight sensors can indicate a weight of an item placed in a locker of the electronic locker arrangement 110. The locker security data 652 can include data utilized to obtain access to the electronic locker arrangement 110. For example, the locker security data 652 can include bar codes, QR codes, identifiers of individuals, identifiers of items, or combinations thereof. In some cases, the bar codes, QR codes, and/or identifiers can be obtained from the logistics management system 108. In additional implementations, the bar codes, QR codes, and/or identifiers can be obtained via one or more input devices of the electronic locker arrangement 110.

The locker interface module 642 can include computer-readable instructions that when executed by the one or more processors 638 can provide one or more user interfaces displayed via one or more display devices of the electronic locker arrangement 110. The locker interface module 642 can generate user interfaces to capture information input by individuals utilizing the electronic locker arrangement 110. In some cases, the user interfaces generated by the locker interface module 642 can obtain information related to requests to store items in the electronic locker arrangement 110. Additionally, the user interfaces generated by the locker interface module 642 can obtain information related to requests to remove items from the electronic locker arrangement 110. The locker interface module 642 can also generate user interfaces that include information used to access items stored by the electronic locker arrangement 110, such as QR codes and/or bar codes.

The locker control module 644 can include computer-readable instructions that when executed by the one or more processors 638 can cause lockers of the electronic locker arrangement 110 to open or close. In some cases, the locker control module 644 can obtain signals from the logistics management system 108 to open or close lockers of the electronic locker arrangement 110. In other cases, the locker control module 644 can cause lockers of the electronic locker arrangement 110 to open or close based on the sensor data 650. For example, the locker control module 644 can determine that an item has been removed from a locker of the electronic locker arrangement 110 based on weight data associated with the locker and proceed to close the door of the locker. In another example, the locker control module 644 can analyze weight data associated with a locker and determine that an item has been placed in the locker.

In particular implementations, the locker interface module 642 and the locker control module 644 can work in conjunction with each other after an item has been dropped off or picked up. For example, after the locker control module 644 determines that an item has been dropped off in a locker of the electronic locker arrangement 110, the locker interface module 642 can generate one or more user interfaces to determine whether a sender or courier has additional items to drop off and to control access to the electronic locker arrangement 110 to drop off the additional items. Additionally, after the locker control module 644 determines that an item has been picked up from a locker of the electronic locker arrangement 110, the locker interface module 642 can generate one or more user interfaces to determine whether a courier or a recipient has additional items to pick up and to control access to the electronic locker arrangement 110 to pick up the additional items.

The system communication module 646 can include computer-readable instructions that when executed by the one or more processors 638 can manage communications to and from the logistics management system 108. For example, the system communications module 646 can provide information obtained via user interfaces displayed by the electronic locker arrangement 110 to the logistics management system 108. In another example, the system communications module 646 can provide sensor data 650 and/or locker security data 652 to the logistics management system 108.

The architecture 600 can also include a computing device 654 operated by a user 656. The computing device 654 can include a mobile phone, a smart phone, a tablet computing device, a laptop computing device, a portable gaming device, a desktop computing device, combinations thereof, and the like. The user 656 can include a sender of an item to be delivered via the logistics management system 108, a courier transporting items being delivered via the logistics management system 108, or a recipient that receives an item delivered via the logistics management system 108.

The computing device 654 can include one or more processors, such as processor 658 and memory 660. The one or more processors 658 can include at least one hardware processor, such as a microprocessor. In some cases, the one or more processors 658 may include a central processing unit (CPU), a graphics processing unit (GPU), or both a CPU and GPU, or other processing units. Additionally, the one or more processors 658 can include a local memory that may store program modules, program data, and/or one or more operating systems.

The memory 660 can include volatile and nonvolatile memory and/or removable and non-removable media implemented in any type of technology for storage of information, such as computer-readable instructions, data structures, program modules, or other data. The computing device 654 can also include one or network interfaces (not shown) to communicate with other computing devices via the one or more networks 608. Additionally, the computing device 654 can include one or more input/output devices (not shown).

The memory 660 can be used to store any number of functional components that are executable by the one or more processors 658. In many implementations, these functional components comprise instructions or programs that are executable by the one or more processors 658 and that, when executed, implement operational logic for performing the operations attributed to the computing device 654. Functional components of the computing device 654 that can be executed on the one or more processors 658 for implementing the various functions and features related to coordinating and managing the delivery of items utilizing electronic locker arrangements, as described herein, can include a logistics app 662.

The logistics app 662 can provide one or more user interfaces to provide information to the user 656 or to obtain information input by the user 656. The logistics app 662 can be utilized by senders to request the delivery of items to recipients. The logistics app 662 can also provide information to couriers regarding items that are available for delivery by the couriers. Couriers can also utilize the logistics app 662 to accept items for delivery. The logistics app 662 can notify recipients of items that have been sent by senders and track the progress of the delivery of items.

In some cases, the logistics app 662 can provide information to access lockers storing items being picked up or dropped off. For example, the logistics app 662 can scan QR codes that can be utilized to access items stored in lockers of electronic locker arrangements. In certain implementations, the logistics app 662 can extract information from the QR codes, such as a locker identifier, and also obtain information about the user 656, such as a user identifier, and provide this information to the logistics management system 108 to obtain access to an electronic locker arrangement. The logistics app 662 can also obtain and display bar codes to open lockers for dropping off items in lockers of electronic locker arrangements.

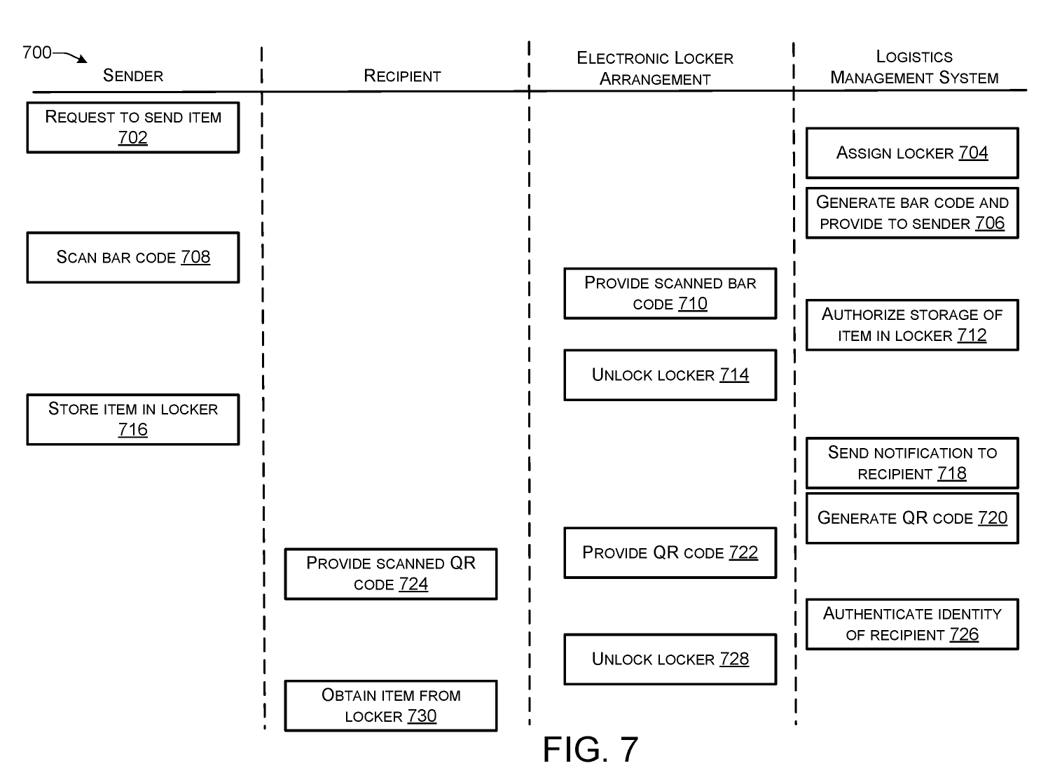

FIG. 7 is a diagram showing the timing of operations of a process 700 performed by various entities to enable an item to be delivered to a recipient from a sender via a single electronic locker arrangement according to some implementations. The entities participating in the process 700 include a sender of an item, a recipient of the item, an electronic locker arrangement that stores the item, and a logistics management system that coordinates delivery of the item from the sender to the recipient. At 702, the process 700 includes a sender providing a request to send an item. The request can be provided via a website maintained by the logistics management system or via a logistics app executed by a computing device of the sender. The logistics app can be provided by the logistics management system. At 704, the logistics management system can assign a locker of the electronic locker arrangement to store the item. The locker can be assigned, in some cases, based on dimensions of the locker with respect to dimensions of the item. At 706, the process 700 includes the logistics management system generating a bar code and providing the bar code to the sender. The logistics management system can provide the bar code to the sender via a logistics app executed by a computing device of the sender.

At 708, the sender can scan the bar code at the electronic locker arrangement. For example, the sender can display the bar code using a logistics app executed by a computing device of the sender and operate a bar code scanner of the electronic locker arrangement to scan the bar code. The electronic locker arrangement can provide one or more user interfaces for the sender to control a bar code scanner of the electronic locker arrangement. At 710, the electronic locker arrangement can provide the scanned bar code to the logistics management system and, at 712, the logistics management system can authorize storage of the item in the locker. In some situations, the logistics management system can determine that the bar code scanned at the electronic locker arrangement corresponds to the bar code provided to the sender. In particular implementations, the logistics management system can send information to the electronic locker arrangement indicating that the sender can store the item in a locker of the electronic locker arrangement. The electronic locker arrangement can then, at 714, unlock the locker, and at 716, the sender can place the item in the locker. The logistics management system can determine that the item has been placed in the locker based on information obtained from the electronic locker arrangement.

At 718, the process 700 can include sending a notification to the recipient that the item is available to be picked up at the electronic storage arrangement. At 720, the logistics management system can generate a QR code. In some situations, the logistics management system can generate the QR code in response to a request from the recipient to access the locker storing the item. In other cases, the logistics management system can generate the QR code in response to determining that the item has been stored in the locker. At 722, the electronic locker arrangement can provide the QR code to the recipient. For example, the electronic locker arrangement can display the QR code. The recipient can scan the QR code and, at 724, provide the scanned QR code to the logistics management system. The recipient can scan the QR code via a logistics app executed by a computing device of the recipient. In particular implementations the logistics app can extract information from the QR code, such as an identifier of the locker storing the item, and send the information extracted from the QR code back to the logistics management system. The logistics app can also send additional information to the logistics management system, such as an identifier of the recipient or an identifier associated with the instance of the logistics app executed by the computing device of the recipient.

At 726, the logistics management system can authenticate the identity of the recipient. For example, the logistics management system can utilize the information obtained from the logistics app, such as the locker identifier extracted from the QR code and/or the identifier of the recipient, to authenticate the identity of the recipient. After determining that the recipient is authorized to access the electronic locker arrangement, the electronic locker arrangement can unlock the locker, at 728, and, at 730, the recipient can obtain the item from the locker of the electronic locker arrangement where the item was stored. In certain implementations, the electronic locker arrangement can unlock the locker in response to information received from the logistics management system. The information indicating that the electronic locker arrangement is to unlock the locker can include a control signal to unlock the locker or information indicating that the recipient is authorized to access the locker.

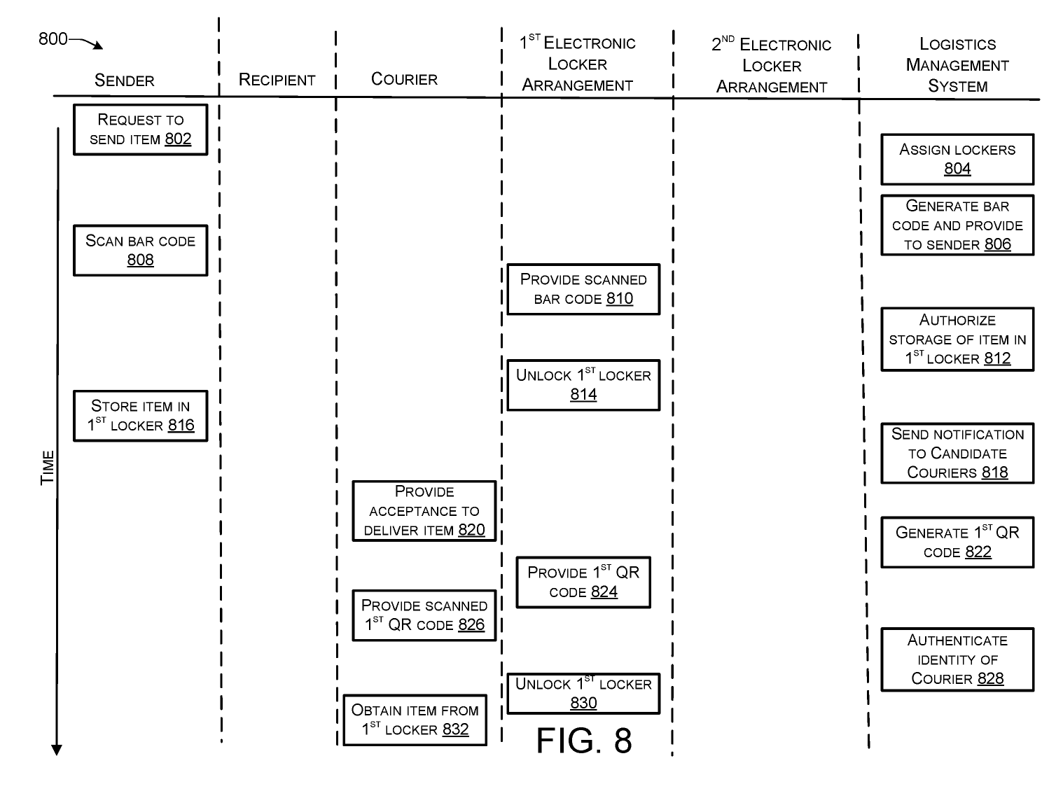

FIG. 8 is a first diagram of a process 800 showing the timing of operations performed by various entities to enable an item to be delivered to a recipient from a sender via a courier utilizing multiple electronic locker arrangements according to some implementations. The entities participating in the process 800 include a sender of an item, a recipient of the item, a first electronic locker arrangement and a second electronic storage arrangement that store the item, a courier that transports the item between the first electronic locker arrangement and the second electronic locker arrangement, and a logistics management system that coordinates delivery of the item from the sender to the recipient. At 802, the process 800 includes a sender requesting to send an item to the recipient. At 804, in response to the request to send the item, the logistics management system can assign lockers for the delivery of the item. The logistics management system can assign a first locker to store the item being dropped off by the sender and a second locker to store the item for pickup by the recipient. The first locker can be included in the first electronic locker arrangement and the second locker can be included in the second electronic locker arrangement. In some cases, the first locker and the second locker can be assigned in response to receiving the request to deliver the item and before the item is placed into the first locker or the second locker. In other situations, the second locker can be assigned after the item has been placed into the first locker or after the item has been removed from the first locker.

At 806, the logistics management system can generate a bar code associated with the item and provide the bar code to the sender. At 808, the sender can scan the bar code, such as via a bar code scanner of the first electronic locker arrangement. In particular implementations, the sender can display the bar code via a logistics app executed on a computing device of the sender and control the first electronic locker arrangement using input to one or more user interfaces to scan the displayed car code. At 810, the first electronic locker arrangement can provide the scanned bar code to the logistics management system. In response to receiving the scanned bar code, the logistics management system can, at 812, authorize storage of the item in the first locker of the first electronic storage arrangement. At 814, the first electronic storage arrangement can unlock the locker and, at 816, the sender can store the item in the locker.

At 818, the logistics management system can send notifications to candidate couriers that the item is available to be delivered. The candidate couriers can be determined by the logistics management system based on evaluating a group of couriers with respect to one or more criteria. At 820, the courier can provide an acceptance to deliver the item. At 822, the process 800 includes generating a first QR code. In some cases, the QR code can be generated in response to a request received via the electronic locker arrangement to access the locker storing the item to be delivered. At 824, the electronic locker arrangement can provide the first QR code to the sender, such as displaying the first QR code via a display device of the first electronic locker arrangement. The courier can scan the first QR code and then, at 826, provide the scanned first QR code to the logistics management system. In particular implementations, the scanned first QR code can be provided to the logistics management system via a logistics app executed by a computing device of the courier. In particular implementations the logistics app can extract information from the QR code, such as an identifier of the first locker, and send the information extracted from the first QR code back to the logistics management system. The logistics app can also send additional information to the logistics management system, such as an identifier of the courier or an identifier associated with the instance of the logistics app executed by the computing device of the courier.

At 828, the logistics management system can authenticate the identity of the courier. For example, the logistics management system can utilize the information obtained from the logistics app, such as the first locker identifier extracted from the QR code and/or the identifier of the courier, to authenticate the identity of the courier. After determining that the courier is authorized to access the electronic locker arrangement, the electronic locker arrangement can unlock the locker, at 830, and, at 832, the courier can obtain the item from the first locker of the first electronic locker arrangement where the item was stored. In certain implementations, the electronic locker arrangement can unlock the locker in response to information received from the logistics management system. The second electronic locker arrangement, at 842, unlocks the second locker, and the courier then stores the item in the second locker at 844. At 846, the logistics management system sends a notification to the recipient that the item is stored in the second locker of the second electronic locker arrangement and available to be picked up.

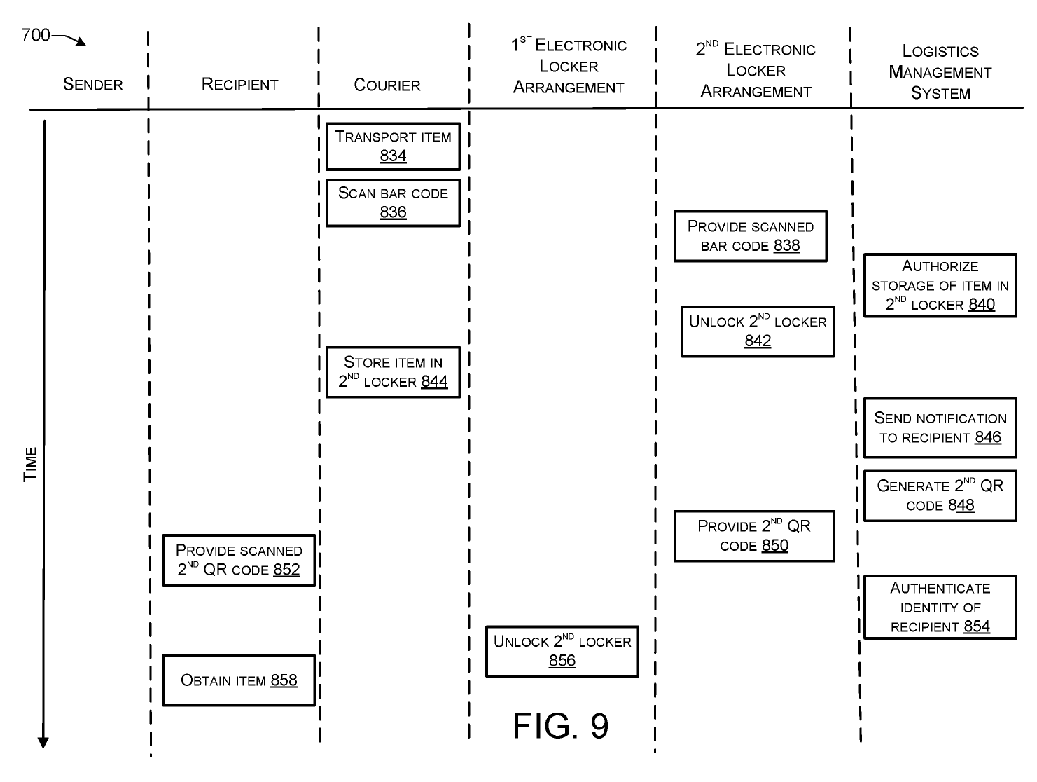

FIG. 9 is a second diagram that continues the operations of the process 800 performed in FIG. 7 showing the timing of operations performed by various entities to enable an item to be delivered to a recipient from a sender via a courier utilizing multiple electronic locker arrangements according to some implementations. At 834, the courier transports the item from the first electronic locker arrangement to the second electronic locker arrangement. At 836, the process 800 includes the courier scanning a bar code of the item at the second electronic locker arrangement. In some cases, the bar code can be the same bar code provided to the sender of the item. At 838, the second electronic locker arrangement provides the scanned bar code to the logistics management system, and after receiving the scanned bar code from the second electronic locker arrangement, the process 800 includes, at 840, authorizing storage of the item in the second locker of the second electronic storage arrangement.

At 842, the second electronic locker arrangement can unlock the second locker. In some cases, the second locker can be unlocked based at least partly on receiving information from the logistics management system. At 844, the courier can store the item in the second locker. Additionally, at 846, the logistics management system can send a notification to the recipient that the item has been stored in the second locker. In certain implementations, the logistics management system can send the notification at least partly based on receiving information from the second electronic locker arrangement that the item has been stored in the second locker. In particular implementations, the courier can receive the notification via a logistics app executed by the computing device of the courier.

At 848, the process 800 can include generating a second QR code. In some cases, the second QR code can be generated in response to a request received via the second electronic locker arrangement to access the second locker storing the item to be delivered. At 850, the electronic locker arrangement can provide the second QR code to the recipient, such as displaying the second QR code via a display device of the second electronic locker arrangement. The recipient can scan the second QR code and then, at 852, provide the scanned second QR code to the logistics management system. In particular implementations, the scanned second QR code can be provided to the logistics management system via a logistics app executed by a computing device of the recipient. In particular implementations the logistics app can extract information from the second QR code, such as an identifier of the second locker, and send the information back to the logistics management system. The logistics app can also send additional information to the logistics management system, such as an identifier of the recipient or an identifier associated with the instance of the logistics app executed by the computing device of the recipient.

At 854, the logistics management system can authenticate the identity of the recipient. For example, the logistics management system can utilize the information obtained from the logistics app, such as the second locker identifier extracted from the second QR code and/or the identifier of the recipient, to authenticate the identity of the recipient. After determining that the recipient is authorized to access the electronic locker arrangement, the electronic locker arrangement can unlock the locker, at 856, and, at 858, the recipient can obtain the item from the second locker of the second electronic locker arrangement where the item was stored. In certain implementations, the electronic locker arrangement can unlock the locker in response to information received from the logistics management system.

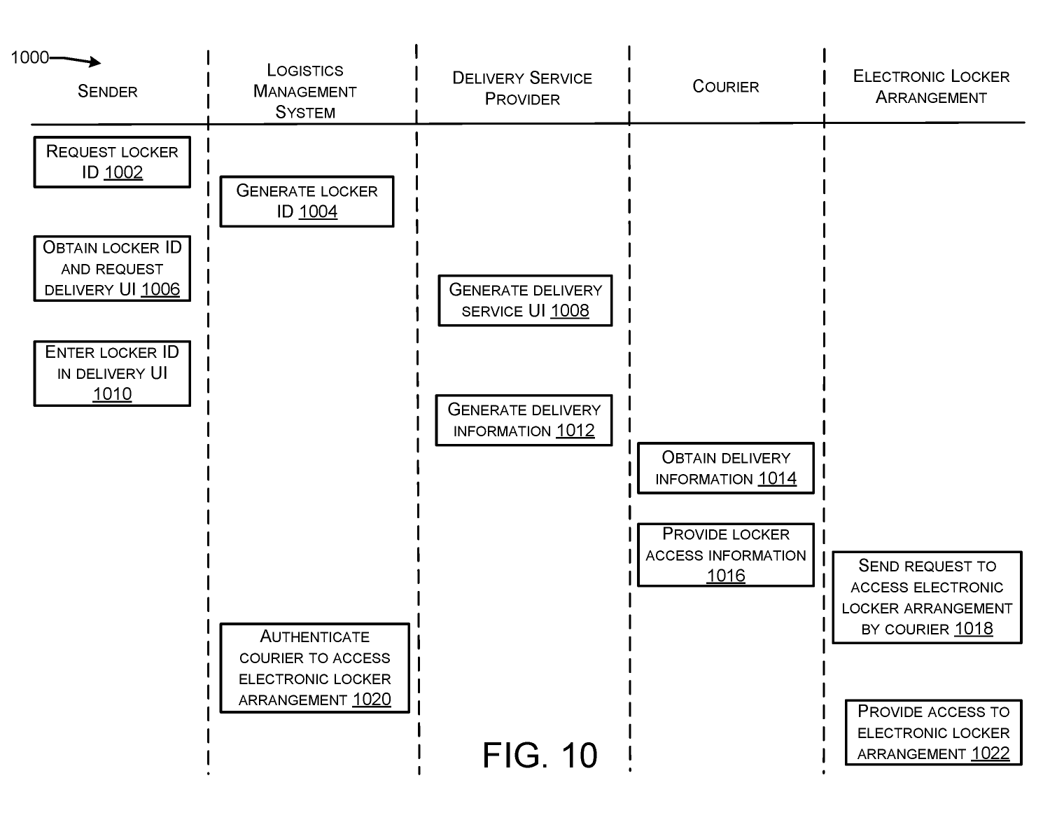

FIG. 10 is a diagram showing the timing of operations of a process 1000 performed by various entities to enable an item to be delivered to a recipient by a third-party delivery service via an electronic locker arrangement according to some implementations. The entities participating in the process 1000 include a sender of an item, an electronic locker arrangement that stores the item, a third-party delivery service provider, a courier utilized by the third-party delivery service provider to deliver the item to a recipient, and a logistics management system that controls access to the electronic locker arrangement. At 1002, the process 1000 includes the sender of the item requesting a locker identifier from the logistics management system. In various implementations, the user can operate a computing device to launch a mobile device app or a website to request a locker identifier that corresponds to a locker of an electronic locker arrangement that can hold the item until the item is picked up by the recipient. In some implementations, the sender can request the locker identifier in situations where the item is to be delivered to an electronic locker arrangement that is located at a same address as another structure, such as an office building, a residential building, an educational building, a merchant building, and so forth.

At 1004, the logistics management system can generate the locker identifier. In response to receiving the request, the logistics management system can determine an electronic locker arrangement that the item can be delivered to. The logistics management system can determine the electronic locker arrangement based on a location of the recipient of the item. In certain implementations, the logistics management system can determine distances between a location of the recipient and a number of electronic locker arrangements and identify an electronic locker arrangement that is located a minimum distance from the recipient. In situations where the location of the recipient is associated with a zip code, the logistics management system can identify an electronic locker arrangement that is located in the same zip code as the recipient. The logistics management system can also determine a locker within the electronic locker arrangement to deliver the item. For example, the logistics management system can identify a locker of the electronic locker arrangement that is empty or will be empty when the item is delivered to the electronic locker arrangement. The electronic locker arrangement can then generate a locker identifier. In some cases, the locker identifier can be previously associated with the locker or electronic locker arrangement that is determined to store the item. To illustrate, the logistics management system can assign an identifier to the locker or the electronic locker arrangement that is used throughout the processes and architectures of the logistics management system. In other situations, the logistics management system can generate the locker identifier in response to receiving the request for the locker identifier. In a particular illustrative example, the locker identifier can include the zip code of the electronic locker arrangement that is to store the item.

In various implementations, the logistics management system can be included in a code that stores information in addition to the locker identifier. For example, the logistics management system can generate a code that corresponds to the locker identifier and that corresponds to an identifier of the recipient of the item. Additionally, the logistics management system can generate a code that includes the locker identifier and that also includes authentication information. The authentication information can be used to authenticate a courier in order to provide access to the electronic locker arrangement by the courier. In some scenarios, the code can include an alphanumeric string. In other situations, the code can include a bar code. In still additional examples, the code can include a QR code.

In an illustrative example, the code can be ZPX78660aa. In this example, “ZPX” can include an identifier of the electronic locker arrangement, “78660” can include an identifier of the location of the electronic locker arrangement, such as a zip code in which the electronic locker arrangement is located, and “aa” can include an identifier of the recipient of the item being delivered. In particular examples, the identifier of the electronic locker arrangement can include an identifier of an entity managing the electronic locker arrangement. Additionally, in these situations, the code can indicate to the courier that the item can be delivered to any available lockers within the specified zip code. In another illustrative example, the code can be ZPX10007aa, where “ZPX” can include an identifier of the electronic locker arrangement, “10007” can include a number of a locker in the electronic locker arrangement to which the item is to be delivered. In these scenarios, the code indicates a specific locker to which the item is to be delivered. Further, “aa” can include an identifier of the recipient of the item. The identifier of the recipient can be used to differentiate recipients. To illustrate, two recipients with the same or similar name may be designated to have items delivered to the same electronic locker arrangement. In these cases, a courier utilizing a look-up user interface at the electronic locker arrangement may be provided with multiple results when entering the name of the recipient. The identifier of the recipient can be utilized to differentiate between recipients having the same or similar name. Thus, upon entering a name of a recipient and the identifier of the recipient from the code, the courier can accurately identify the recipient of the item and be provided access to the locker assigned to store the item being delivered for the recipient. In certain implementations, the code can include both an identifier of the location of the electronic locker arrangement, such as a zip code, and an identifier of the locker included in the electronic locker arrangement to which the item is to be delivered.

At 1006, the sender can obtain the locker identifier from the logistics management system and request a delivery user interface from the delivery service provider. The logistics management system can also provide additional information to the sender. For example, the logistics management system can provide a location of the electronic locker arrangement that is to store the item. At 1008, the delivery service provider can generate the delivery user interface and provide the delivery user interface to the sender. To illustrate, the delivery service provider can generate data that when rendered can cause a computing device to display the delivery user interface. The delivery user interface can include a number of user interface elements to capture information associated with delivery of the item. In some examples, the delivery user interface can include a user interface element to capture an identifier of the recipient of the item. In particular implementations, the recipient of the item can be the sender of the item. That is, an individual can request delivery of an item to themselves, such as via a website or mobile device app of an online retailer. Additionally, the delivery user interface can include a user interface element to capture an address of the recipient. In certain implementations, the address of the recipient can include an address of the electronic locker arrangement to which the item is to be delivered.

At 1010, the sender of the item can enter the locker identifier into a user interface element of the delivery user interface. In certain implementations, the locker identifier can be entered into a user interface element that is specifically configured to capture the locker identifier. For example, the delivery user interface can include a user interface element designated as a locker identifier user interface element. In other implementations, the locker identifier can be entered into another user interface element. To illustrate, the locker identifier can be entered into a user interface element used to capture a name of the recipient. In additional illustrative examples, the locker identifier can be entered into a user interface element used to capture a location of the recipient, such as a user interface element used to capture an address of the recipient, a user interface element used to capture a city where the recipient resided, or a user interface element used to capture a state where the recipient resides.

After receiving the locker identifier, and any other information, via the delivery user interface, the delivery service provider, at 1012 can generate delivery information and the courier can, at 1014, obtain the delivery information from the delivery service provider. The delivery information can be utilized by the courier to deliver the item to the recipient. The delivery information can be provided to the courier electronically via a computing device of the courier. In other implementations, the delivery information can be provided to the courier on a label affixed to the item or via packaging associated with the item. The delivery information can include an address of the electronic locker arrangement to which the item is to be delivered and the locker identifier. In situations where the electronic locker arrangement shares a location with another building, the locker identifier can indicate to the courier that the item is to be delivered to the electronic locker arrangement instead of to the other building that is co-located with the electronic locker arrangement.

The courier can transport the item to the electronic locker arrangement and, at 1016, the courier can provide locker access information to the electronic locker arrangement. The locker access information can include an identifier of the recipient. For example, the courier can enter an identifier of the recipient into a user interface displayed by the electronic locker arrangement. In other implementations, the courier can enter the locker identifier into a user interface displayed by the electronic locker arrangement. Additionally, the courier can enter an access code into a user interface displayed by the electronic locker arrangement. In various implementations, the courier can provide the locker access information by scanning a QR code or a bar code associated with the item using a scanner of the electronic locker arrangement.

At 1018, the electronic locker arrangement can send a request to the logistics management system to grant access to the electronic locker arrangement by the courier. The request can include the locker access information provided to the electronic locker arrangement by the courier. At 1020, the logistics management system can authenticate the courier to access the electronic locker arrangement. In some implementations, the logistics management system can authenticate the courier to access the electronic locker arrangement by verifying the status of the item and/or the location of the item with the delivery service provider. For example, the logistics management system can electronically communicate with the delivery service provider to obtain item status/location information to determine a location of the item, the location of the courier, a status of the item, or combinations thereof, and correlate the item status/location information with the location of the electronic locker arrangement. In situations where the item/status information of the item obtained from the delivery service provider corresponds to a location of the electronic locker arrangement, the logistics management system can grant access to the electronic locker arrangement by the courier. The logistics management system can also authenticate the courier to access the electronic locker arrangement based on a code provided to the electronic locker arrangement by the courier. In various implementations, a particular code can be associated with the item in a data store of the logistics management system, and the logistics management system can authenticate the courier to access the electronic locker arrangement to deliver the item based on receiving the code of the item from the courier. Although the illustrative example of FIG. 10 indicates that the logistics management system authenticates the courier to access the electronic locker arrangement, in some situations, the electronic locker arrangement can communicate with the delivery service provider to obtain the item status/location and authenticate the courier based on the item/status information of the item in relation to the location of the electronic locker arrangement. At 1022, the electronic locker arrangement can provide access to the courier. In certain implementations, after the logistics management system authenticates the courier to access the electronic locker arrangement, the logistics management system can send a signal to the electronic locker arrangement to open a locker that has been designated to store the item.

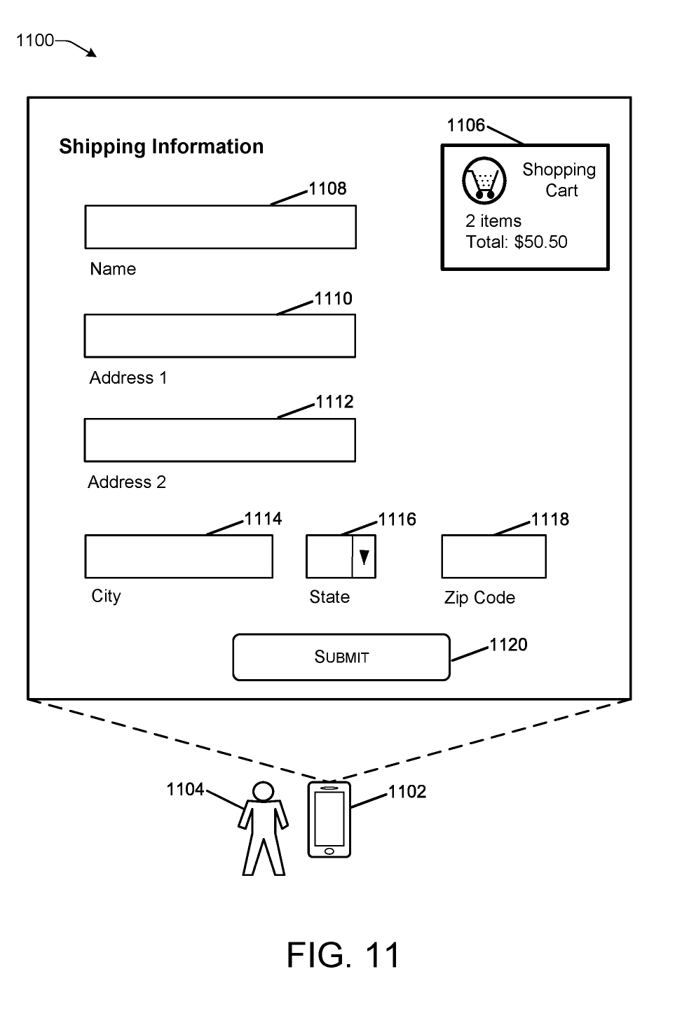

FIG. 11 shows a first user interface 1100 to capture information to deliver an item to a recipient. The user interface 1100 can be rendered and displayed on a computing device 1102. The computing device 1102 can be operated by a user 1104. The computing device 1102 can include a mobile computing device, a smart phone, a tablet computing device, a laptop computing device, a desktop computing device, a gaming console, a portable gaming device, a multimedia device, combinations thereof, and the like. The user interface 1100 can be displayed in conjunction with a mobile device app executed by the computing device 1102 or a website accessed by the computing device 1102. In the illustrative example of FIG. 11, the user interface 1100 can be provided by an online retailer and the user interface 1100 can include user interface elements directed to displaying and capturing information related to the purchase of one or more items from the online retailer.

The user interface 1100 includes a first user interface element 1106 that indicates items that have been selected for purchase and an amount of currency to be paid for the items. In some cases, the first user interface element 1106 can be selectable to show additional information about the items to be purchased. The user interface 1100 also includes a second user interface element 1108 to capture an identifier of the individual, such as a name of the individual, to receive the one or more items. In some cases, the individual that is to receive the one or more items can be the user 1104. In other cases, the user 1104 can purchase the one or more items and have them sent to an additional individual. The user interface 1110 can also include a third user interface element 1100, a fourth user interface element 1112, a fifth user interface element 1114, a sixth user interface element 1116, and a seventh user interface element 1118 that can capture information indicating a location to deliver the one or more items. In particular implementations, the location can include a location of an electronic locker arrangement to which the one or more items are to be delivered. In the illustrative example of FIG. 11, the third user interface element 1110 and the fourth user interface element 1112 can capture information that indicates an address to deliver the one or more items. Additionally, the fifth user interface element 1114 can capture information related to a city that includes the location to deliver the one or more items, the sixth user interface element 1116 can capture information related to a state that includes the location to deliver the one or more items, and the seventh user interface element 1118 can capture information related to a zip code that includes the location to deliver the one or more items. The user 1104 can utilize one or more input devices of the computing device 1102 to enter information into the user interface elements 1108, 1110, 1112, 1114, 1116, 1118. Further, the user interface 1100 includes an eighth user interface element 1120 that is selectable to submit the information entered into one or more of the user interface elements 1108, 1110, 1112, 1114, 1116, 1118 to the online retailer.

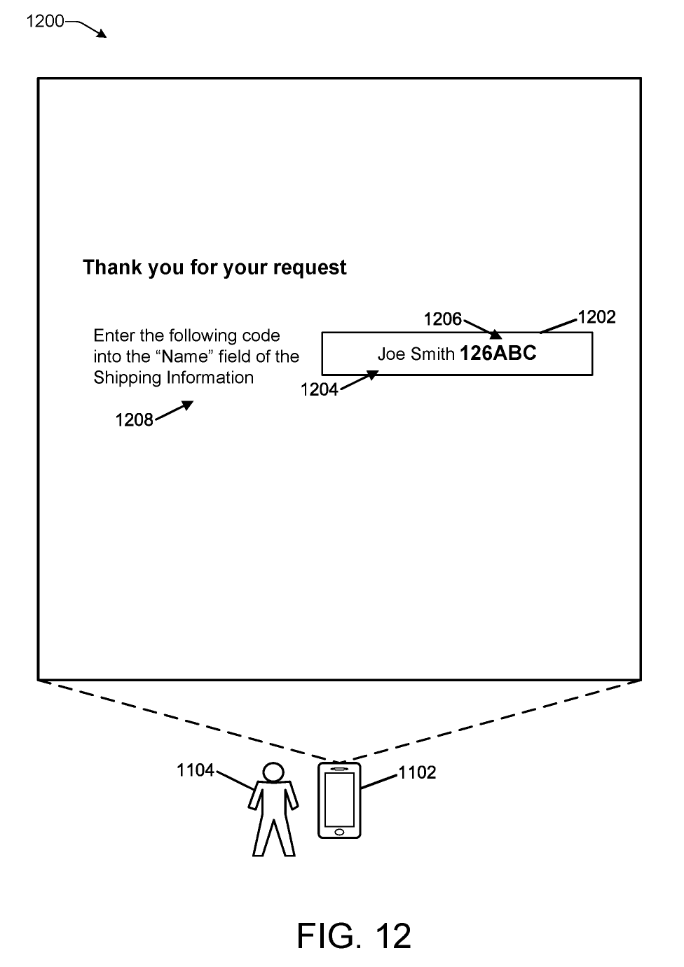

FIG. 12 shows a second user interface 1200 to obtain information indicating that an item is to be delivered to an electronic locker arrangement. The user interface 1200 can be displayed via the computing device 1102 that is operated by the user 1104. The user interface 1200 can be displayed by a mobile device app executed by the computing device 1102 or a website accessed by the computing device 1102. The user interface 1200 can be provided by a logistics management system, such as the logistics management system 108, in response to receiving a request from the computing device 1102 to obtain information indicating that an item is to be delivered to an electronic locker arrangement. The user interface 1200 can include a user interface element 1202 that includes the information that can be used to indicate that an item is to be delivered to an electronic locker arrangement. In some implementations, the computing device 1102 can execute a mobile device app or access a website of the logistics management system 108 to request a code indicating that an item is to be delivered to an electronic locker arrangement. The code can include a locker identifier that indicates an electronic locker arrangement where the item is to be delivered, a locker within the electronic locker arrangement where the item is to be delivered, or both. The code can also include an identifier corresponding to a sender of the item, an identifier corresponding to a recipient of the item, or both. The code can be entered into a user interface of an online retailer or a user interface of a delivery service provider to indicate that an item is to be delivered to an electronic locker arrangement.

In an illustrative example, the computing device 1102 can send a request to the logistics management system 108 to obtain a code indicating that an item is to be delivered to an electronic locker arrangement. The code can be generated by the logistics management system 108 and sent to the computing device 1102 and the code can be displayed in the user interface element 1202. The logistics management system 108 can determine a particular electronic locker arrangement to store the item and generate the code based at least partly on the particular electronic locker arrangement. For example, the user interface element 1202 can include an identifier 1204 of the name of an individual to which an item is to be delivered and a code 1206 indicating that the item is to be delivered to the electronic locker arrangement. The user interface 1200 can also include instructions 1208 on how to utilize the code 1206. By providing the user 1104 with the code 1206, the user 1104 can utilize conventional systems of online retailers and/or delivery service providers to have items delivered to electronic locker arrangements that can share an address with a building or structure. Thus, the code 1206 can be entered into an existing user interface provided by an online retailer and/or a delivery service provider to indicate that an item is to be delivered to an electronic locker arrangement without having to modify the systems of the online retailer and/or delivery service provider or integrate the logistics management system 108 with the systems of the online retailer and/or delivery service provider.

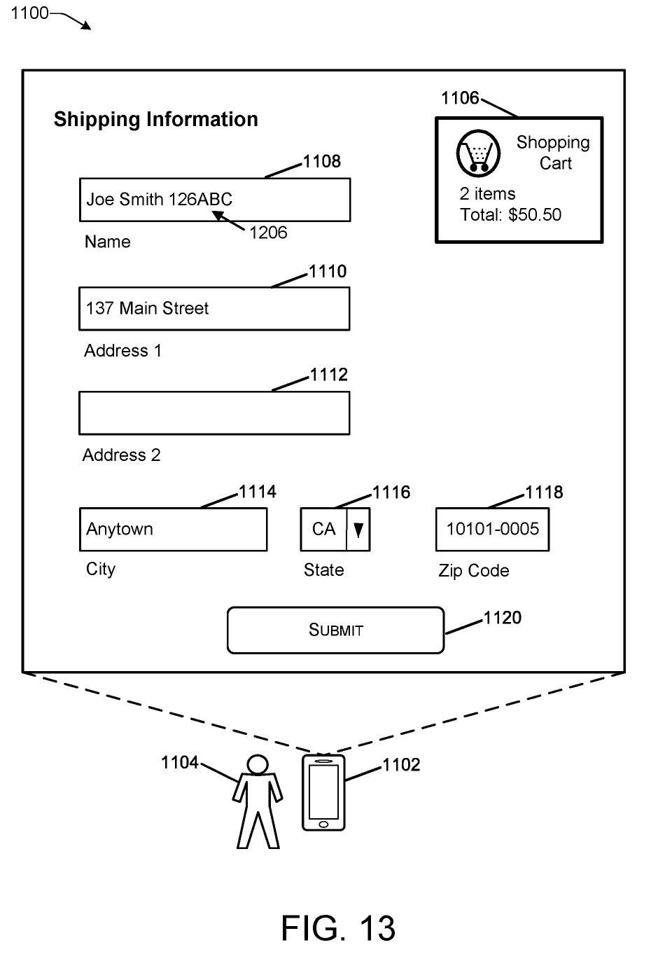

FIG. 13 shows an implementation of the first user interface 1100 with information entered into the user interface elements 1108, 1110, 1114, 1116, 1118. In particular, the second user interface element 1108 includes the code 1206 that indicates delivery of the one or more items included in the cart are to be delivered to an electronic locker arrangement. In some implementations, the code 1206 can be entered into the second user interface element 1108 by the user 1104 via one or more input devices of the computing device 1102. In other implementations, the second user interface element 1108 can be automatically populated with the code 1206. For example, a mobile device app of the logistics management system 108 can operate in conjunction with a mobile device app of the online retailer to populate the second user interface element 1108 or another user interface element of the user interface 1100 with the code 1206. In various implementations, a script provided by the logistics management system 108 can be executed with respect to a browser application, a mobile device app of the logistics management system 108, a mobile device app of the online retailer, or a combination thereof, to populate the second user interface element 1108 or another user interface element of the user interface 1100 with the code 1206.

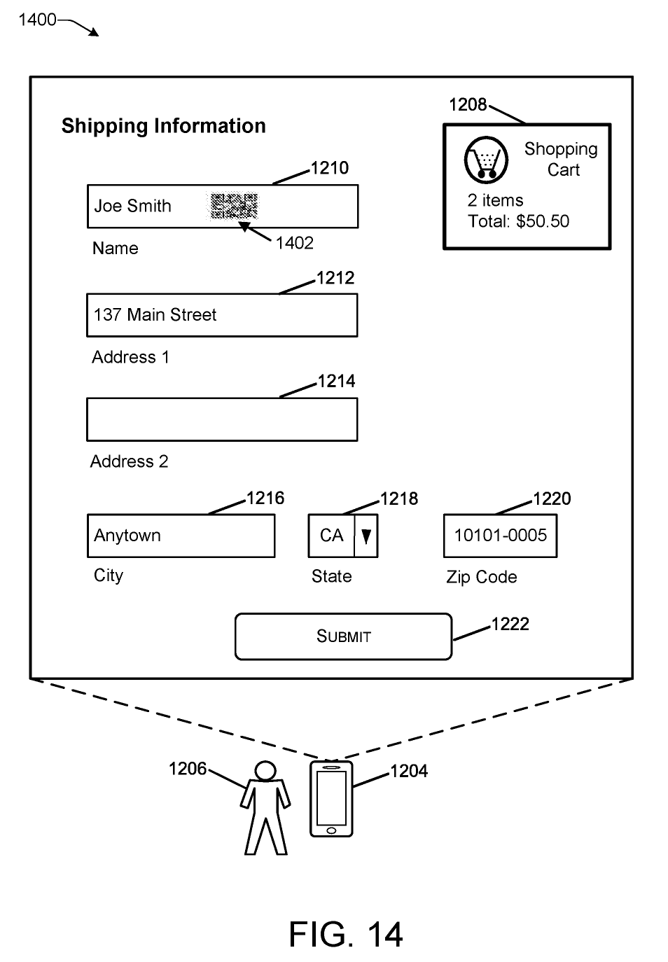

FIG. 14 shows an additional implementation of the first user interface 1100 with information entered into the user interface elements 1108, 1110, 1114, 1116, 1118. In particular, the second user interface element 1108 includes an additional code 1402 that indicates delivery of the one or more items included in the cart are to be delivered to an electronic locker arrangement. The additional code 1402 can include a QR code rather than an alphanumeric string of the code 1206 of FIG. 12 and FIG. 13. In some implementations, the additional code 1402 can be entered into the second user interface element 1108 by the user 1104 via one or more input devices of the computing device 1102. In other implementations, the second user interface element 1108 can be automatically populated with the additional code 1402. For example, a mobile device app of the logistics management system 108 can operate in conjunction with a mobile device app of the online retailer to populate the second user interface element 1108 or another user interface element of the user interface 1100 with the additional code 1402. In various implementations, a script provided by the logistics management system 108 can be executed with respect to a browser application, a mobile device app of the logistics management system 108, a mobile device app of the online retailer, or a combination thereof, to populate the second user interface element 1108 or another user interface element of the user interface 1100 with the additional code 1402.

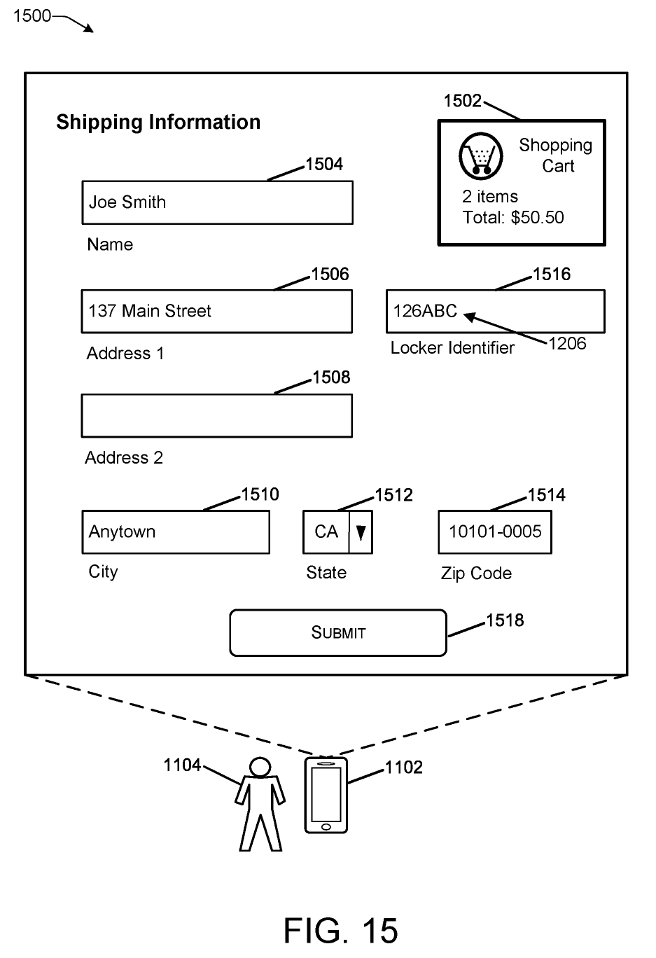

FIG. 15 shows a third user interface 1500 that includes an additional user interface element to capture a code 1206 indicating that an item is to be delivered to an electronic locker arrangement. The user interface 1500 can be similar to the user interface 1100 and include a first user interface element 1502 that indicates items that have been selected for purchase and an amount of currency to be paid for the items. In some cases, at least a portion of the first user interface element 1502 can be selectable to show additional information about the items to be purchased. The user interface 1500 also includes a second user interface element 1504 to capture an identifier of the individual, such as a name of the individual, to receive the one or more items. In some cases, the individual that is to receive the one or more items can be the user 1104. In other cases, the user 1104 can purchase the one or more items and have them sent to an additional individual. The user interface 1500 can also include a third user interface element 1506, a fourth user interface element 1508, a fifth user interface element 1510, a sixth user interface element 1512, and a seventh user interface element 1514 that can capture information indicating a location to deliver the one or more items. Additionally, the user interface 1500 can include an eighth user interface element 1516 to capture the code 1206 obtained from the logistics management system 108. In some implementations, the code 1206 can be entered into the eighth user interface element 1516 by the user 1104 via one or more input devices of the computing device 1102. In other implementations, the eighth user interface element 1516 can be automatically populated with the code 1206. The code 1206 can include an identifier of the electronic locker arrangement to which an item can be delivered, an identifier of a specific locker within an electronic locker arrangement to which an item can be delivered, or both. Further, the user interface 1500 includes a ninth user interface element 1518 that is selectable to submit the information entered into one or more of the user interface elements 1504, 1506, 1508, 1510, 1512, 1514, 1516 to the online retailer. The user interface 1500 can be displayed in conjunction with a mobile device app executed by the computing device 1102 or a website accessed by the computing device 1102. In the illustrative example of FIG. 15, the user interface 1500 can be provided by an online retailer and the user interface 1500 can include user interface elements directed to displaying and capturing information related to the purchase of one or more items from the online retailer.

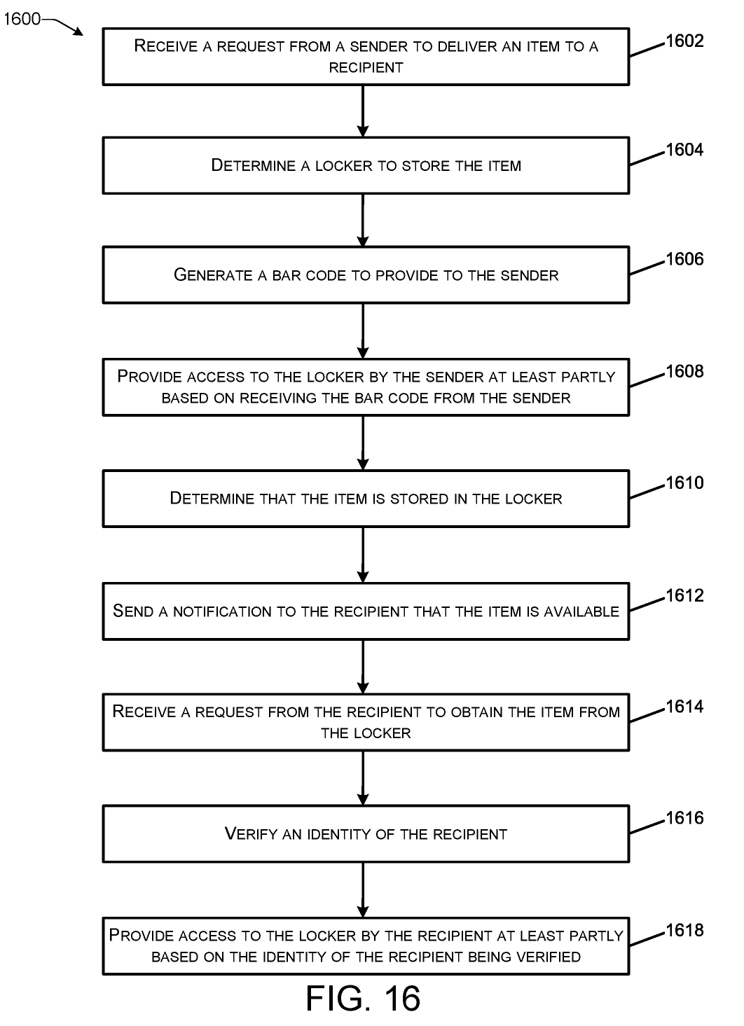

FIGS. 16-21 illustrate example processes of delivering items to recipients from senders via electronic locker arrangements. These processes (as well as each process described herein) are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

FIG. 16 is a flow diagram of a process 1600 to facilitate the delivery of an item from a sender to a recipient via a single electronic locker arrangement according to some implementations. At 1602, the process 1600 can include receiving a request from a sender to deliver an item to a recipient. The request can be received from a computing device of the sender. In some cases, the request can be received by a web site of a logistics management system, while in other cases, the request can be received by a mobile app executed on the computing device of the recipient.

At 1604, the process 1600 can include determining a locker to store the item. The locker can be included in an electronic locker arrangement. In some cases, the electronic locker arrangement can be located in a same geographic region as the sender and the recipient. In particular implementations, the electronic locker arrangement, the sender, and the recipient can each be located in a same zip code. In other implementations, the electronic locker arrangement, the sender, and the recipient can be located in a same neighborhood or district. In still additional implementations, the electronic locker arrangement, the sender, and the recipient can be located in a same city, town, village, or other municipality. Determining the locker to store the item can include analyzing dimensions and/or other characteristics of the item in relation to dimensions and/or storage capacity of lockers of the electronic locker arrangement that can have different dimensions and/or storage capacities with respect to one another.

At 1606, the process 1600 can include generating a bar code to provide to the sender. The bar code can include an identifier of the sender and/or an identifier of the item. In particular implementations, the bar code can be provided to a computing device of the sender. In other situations, the bar code can be accessible to the sender via a web site that can be accessed by a computing device of the sender. At 1608, access can be provided to the locker by the sender at least partly based on receiving the bar code or information encoded by the bar code from the sender. In some cases, the bar code or information encoded by the bar code received from the sender can be compared against the bar code initially provided to the sender. In response to determining that the bar code received from the sender corresponds to the bar code initially sent to the sender, the sender can be authorized to access the locker.

At 1610, the process 1600 can include determining that the item is stored in the locker. In particular implementations, sensor data associated with the locker can be utilized to determine that the item has been stored in the locker. At 1612, the process 1600 can include sending a notification to the recipient that the item is available for pickup at the electronic locker arrangement. In some cases, the notification can be provided to a computing device of the recipient. The notification can be provided to the recipient via an account of the recipient with a service provider implementing a logistics management system. Information associated with the account of the recipient with the service provider can be accessible to the recipient via a website of the service provider, a mobile app executed by a computing device of the recipient, or both.

At 1614, the process 1600 can include receiving a request from the recipient to obtain the item from the locker. In some cases, the request can be provided via one or more user interfaces displayed at the electronic locker arrangement, while in other cases, the request can be provided via a mobile app executed by a computing device of the recipient. Additionally, at 1616, the process 1600 can include verifying an identity of the recipient, and, at 1618, the process 1600 includes providing access to the locker by the recipient at least partly based on the identity of the recipient being verified. In particular implementations, the identity of the recipient can be verified utilizing a QR code provided to the recipient that uniquely identifies the recipient with respect to the item.

The operations of the process 1600 can be implemented by one or more computing devices. In some situations, the operations of the process 1600 can be implemented by an electronic locker arrangement. In other scenarios, the operations of the process 1600 can be implemented by a logistics management system. In still other implementations, the operations of the process 1600 can be implemented by both an electronic locker arrangement and a logistics management system.

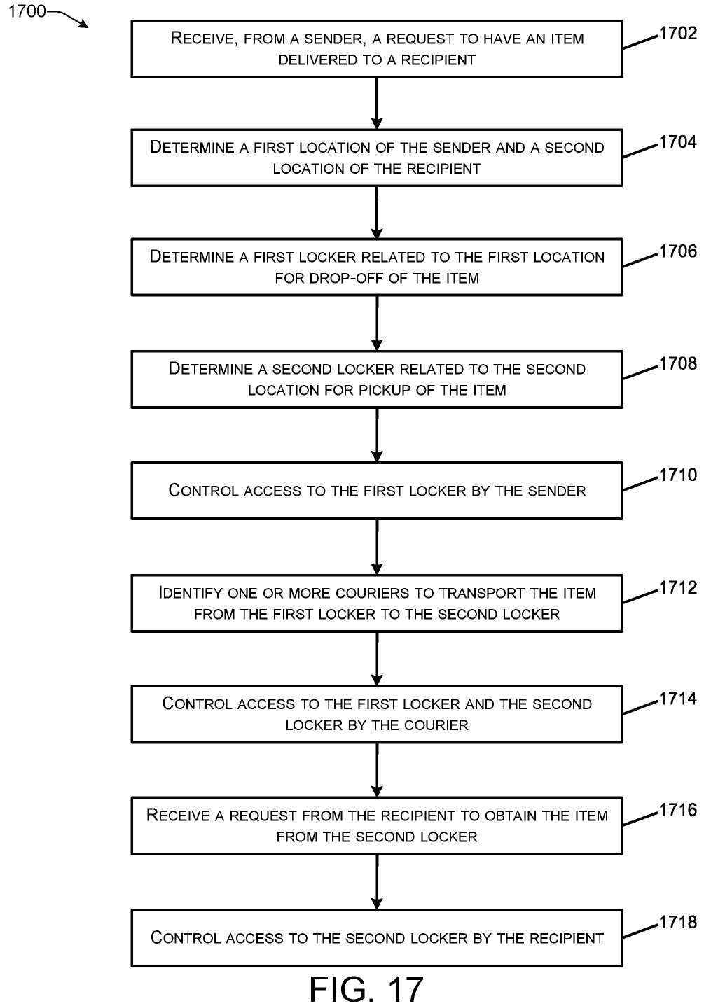

FIG. 17 is a flow diagram of a process 1700 to facilitate the delivery of an item from a sender to a recipient via multiple electronic locker arrangements according to some implementations. At 1702, the process 1700 can include receiving, from a sender, a request to have an item delivered to a recipient. The request can be received from a computing device of the sender. In some cases, the request can be received by a web site of a logistics management system, while in other cases, the request can be received by a mobile app executed on the computing device of the sender.

At 1704, the process 1700 can include determining a first location of the sender and a second location of the recipient. The first location and the second location can be determined based on information included in the request. In other situations, the first location and the second location can be determined based on GPS information received from computing devices of the sender and the recipient. In certain implementations, the first location can include a first geographic area and the second location can include a second geographic area. In particular implementations, the first location can include a first zip code and the second location can include a second zip code. In additional implementations, the first location can include a first neighborhood or first district and the second location can include a second neighborhood or second district. In further implementations, the first location can include a first municipal or political region (e.g., city, state, territory, village, town, county, etc.) and the second location can include a second municipal or political region. In other implementations, the first location can include a first geographic region specified by a logistics management system and the second location can include a second geographic region specified by the logistics management system. To illustrate, the logistics management system can divide a geographical area into a number of regions. In particular implementations, the regions can have shapes with dimensions expressed in feet, meters, kilometers, miles, or combinations thereof. The shapes of the regions can be regular shapes (e.g., square, rectangle, circle), in some scenarios, and irregular in other instances.

At 1706, the process 1700 can include determining a first locker related to the first location for drop-off of the item by the sender, and, at 1708, the process 1700 includes determining a second locker related to the second location for pickup of the item by the recipient. The first locker can be included in a first electronic locker arrangement located in the first location and the second locker can be included in a second electronic locker arrangement located in the second location. In some cases, the first electronic locker arrangement and the second electronic locker arrangement can be owned and/or operated by a service provider of the logistics management system. In other situations, at least one of the first electronic locker arrangement and the second electronic locker arrangement can be owned and/or operated by a service provider that is different from the service provider of the logistics management system. At 1710, the process 1700 can include controlling access to the first locker by the sender. In some cases, the sender can access the first locker in response to the sender providing an identifier to the logistics management system. The identifier can be provided via a logistics app executed on a computing device of the sender or via the first electronic locker arrangement. In certain implementations, the identifier can be encoded by a bar code of the item.

At 1712, the process 1700 can include identifying one or more couriers to transport the item from the first locker to the second locker. In various implementations, the one or more couriers can be identified based on one or more criteria. The one or more criteria can include location of the couriers with respect to the first location and the second location, ratings of the couriers, number of items assigned to be delivered by the couriers, and so forth. The courier can also be identified based at least partly on an availability indicated by the courier to deliver items to the first location and the second location. In certain situations, multiple couriers can be identified to deliver the item to the recipient. In particular implementations, the first location and the second location can be different cities, countries, or regions and one or more intermediate electronic locker arrangements can be determined to store the item. In these scenarios, a first courier can be identified for the first location and a second courier can be identified for the second location. Further, one or more additional couriers can be identified to transport the item between one or more intermediate electronic locker arrangements between the first location and the second location.

At 1714, the process 1700 can include controlling access to the first locker and the second locker by the courier. The access to the first locker and the second locker can be based at least partly on verifying the identity of the courier at the first location and the second location. In some cases, the identity of the courier can be determined based on identifiers provided to the courier, such as via a logistics app executed by a computing device of the courier or via an account of the courier with a logistics management system that is accessible via a website of the logistics management system. The identifiers can include or be encoded by bar codes, QR codes, alphanumeric strings, image data, biometric data, combinations thereof, and the like. The identifiers can also be unique to the courier with respect to the item.

At 1716, the process 1700 can include receiving a request from the recipient to obtain the item from the second locker. In particular implementations, the recipient can request to obtain the item from the second locker after receiving a notification that the item is available to be picked up at the second locker. At 1718, the process 1700 can include controlling access to the second locker by the recipient. The access to the second locker can be based at least partly on verifying the identity of the recipient at the second location. In some cases, the identity of the recipient can be determined based on identifiers provided to the recipient, such as via a logistics app executed by a computing device of the recipient or via an account of the recipient with a logistics management system that is accessible via a website of the logistics management system. The identifiers can include bar codes, QR codes, alphanumeric strings, image data, biometric data, combinations thereof, and the like. The identifiers can be unique to the recipient with respect to the item.

The operations of the process 1700 can be implemented by one or more computing devices. In some situations, the operations of the process 1700 can be implemented by one or more electronic locker arrangements. In other scenarios, the operations of the process 1700 can be implemented by a logistics management system. In still other implementations, the operations of the process 1700 can be implemented by one or more electronic locker arrangements and a logistics management system.

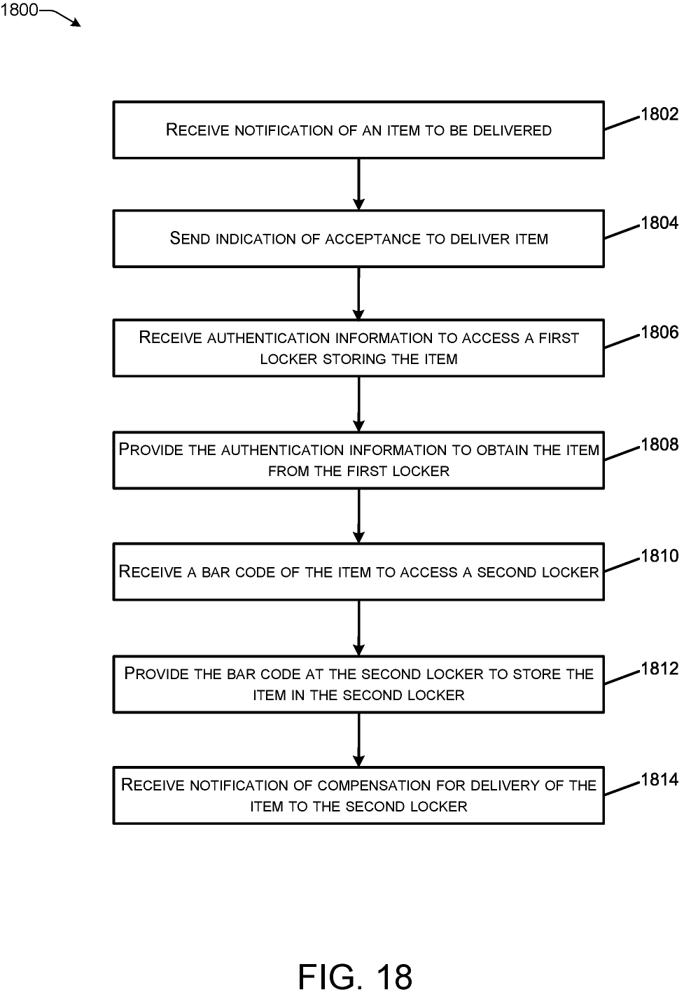

FIG. 18 is a flow diagram of a process 1800 to facilitate the delivery of an item from a recipient to a sender via a courier using an application executed by a computing device of the courier according to some implementations. At 1802, the process 1800 can include receiving notification of an item to be delivered. The notification can be provided by a logistics app executed by a computing device of the courier. In some implementations, the notification can include information about the item, such as a description of the item, dimensions of the item, a type of the item, and so forth. The notification can also include a first location for the courier to pick up the item and a second location for the courier to drop off the item. At 1804, the process 1800 can include sending an indication of acceptance to deliver the item. The acceptance to deliver the item can be sent via a logistics app executed by the computing device of the courier.

At 1806, the process 1806 can include receiving authentication information to access a first locker storing the item. In some cases, the authentication information can be encoded by a QR code. At 1808, the process 1800 can include providing the authentication information to obtain the item from the first locker. In some implementations, the authentication information can be extracted from the QR code by a logistics app executed by a computing device of the courier. In particular cases, the authentication information can include an identifier of the first locker or an identifier of the first electronic locker arrangement that includes the first locker. The logistics app can also provide additional information for the courier to obtain access to the item at the first locker, such as an identifier of the courier. The identifier of the courier can be associated with an account of the courier with a logistics management system.

At 1810, the process 1800 can include receiving a bar code to access the second locker, and, at 1812, the process 1800 can include providing the bar code at the second locker to store the item in the second locker. The bar code can encode an identifier of the item, in some situations. Additionally, the bar code can be displayed via the logistics app and scanned by an electronic locker arrangement that includes the second locker. At 1814, the process 1800 can include receiving notification of compensation for delivery of the item to the second locker. In particular implementations, the courier can receive payment for the delivery of the item and the computing device of the courier can receive the notification that an account of the courier has been credited the payment. In some cases, the payment to the courier can be based at least partly on a type of item delivered by a courier. Also, the payment to the courier can be based at least partly on a timing of the delivery of the item, such as within a specified period of time or by a specified deadline. Further, the payment to the courier can be based at least partly on a rating of the courier.

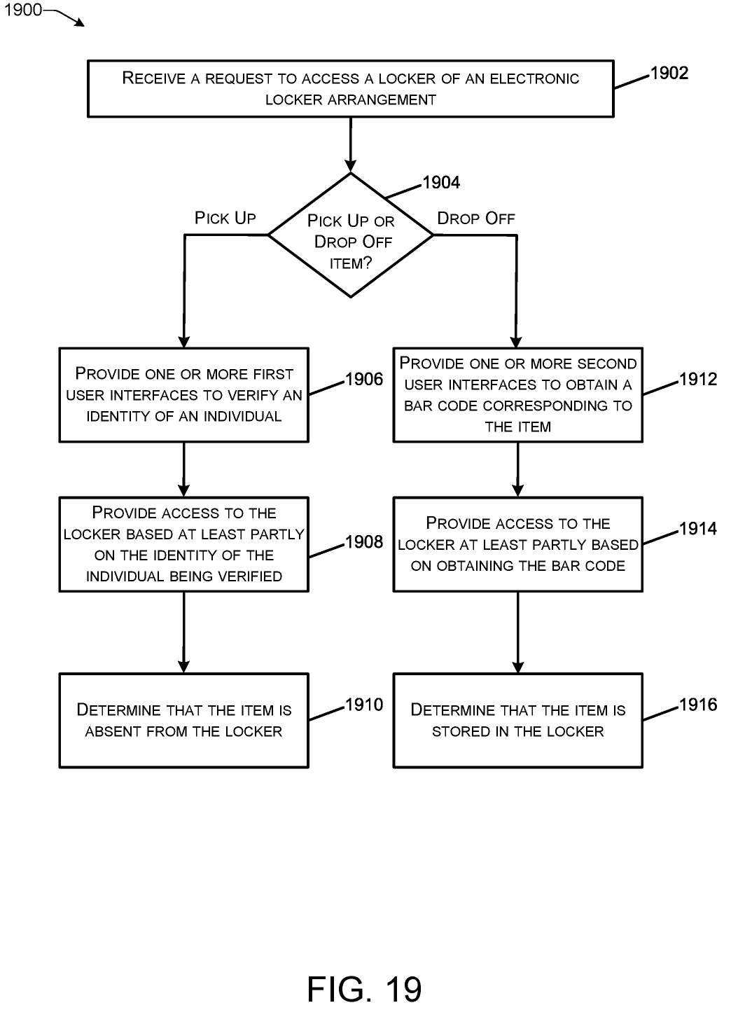

FIG. 19 is a flow diagram of a process 1900 to facilitate access to an electronic locker arrangement for the delivery of an item from a sender to a recipient. At 1902, the process 1900 can include receiving a request to access a locker of an electronic locker arrangement. In some cases, the request can be provided via one or more user interfaces displayed by the electronic locker arrangement. In other situations, the request can be received via a logistics app executed by a computing device of an individual, such as a sender of an item, a recipient of an item, or a courier. At 1904, the process 1900 can include determining whether the item is to be picked up or dropped off. When the item is to be picked up, the process 1900 can move to 1906. When the item is to be dropped off, the process 1900 can move to 1912.

At 1906, the process 1900 can include providing one or more first user interfaces to verify an identity of the individual requesting to access the electronic locker arrangement. In some cases, the one or more first user interfaces can be used to display a QR code that can be scanned by a computing device of the individual. In some cases, the QR code can be obtained by the electronic locker arrangement from a logistics management system. At 1908, the process 1900 can include providing access to the locker based at least partly on the identity of the individual being verified. For example, the electronic locker arrangement can receive information from the logistics management system indicating that the identity of the individual has been verified. The electronic locker arrangement can unlock the locker to provide access to the locker by the individual. At 1910, the process 1900 can include determining that the item is absent from the locker. In some situations, the electronic locker arrangement can determine that the item is absent from the locker based at least partly on sensor data. The sensor data can indicate that the door of the locker has been closed. The sensor data can also include weight sensor data indicating that the item has been removed from the locker based at least partly on a change in the weight detected by the weight sensors. In addition, the sensor data can include image data and/or video data indicating that the item has been removed from the locker. In particular implementations, the electronic locker arrangement can provide one or more additional user interfaces to repeat the process for an additional item to be picked up at the electronic locker arrangement. For each item picked up at the electronic locker arrangement a different QR code can be provided that uniquely identifies the individual picking up the item with respect to the item. In this way, different QR codes can be provided for the same individual picking up different items.

At 1912, the process 1900 can include providing one or more user interfaces to obtain a bar code corresponding to the item. In particular implementations, the one or more second user interfaces can be used to scan a bar code from a computing device of the individual. At 1914, the process 1900 can include providing access to the locker at least partly based on obtaining the bar code. In certain implementations, access can be provided to the locker based at least partly on receiving information from a logistics management system indicating that the bar code corresponds to the bar code assigned to the item by the logistics management system. At 1916, the process 1900 can include determining that the item is stored in the locker. In some situations, the electronic locker arrangement can determine that the item is stored in the locker based at least partly on sensor data. The sensor data can indicate that the door of the locker has been closed. The sensor data can also include weight sensor data indicating that the item has been placed into the locker based at least partly on a change in the weight detected by the weight sensors. In addition, the sensor data can include image data and/or video data indicating that the item has been placed in the locker. In particular implementations, the electronic locker arrangement can provide one or more additional user interfaces to repeat the process for an additional item to be dropped off at the electronic locker arrangement. For each item dropped off at the electronic locker arrangement a different QR code can be provided that uniquely identifies the individual dropping off the item with respect to the item. In this way, different QR codes can be provided for the same individual dropping off different items.

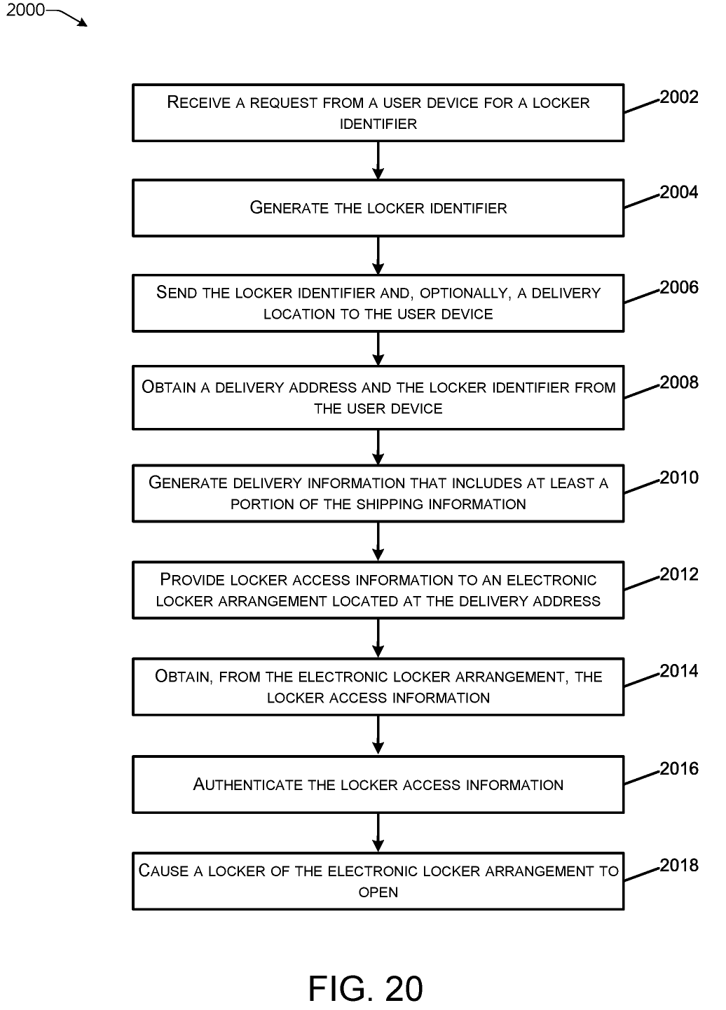

FIG. 20 is a flow diagram of a first process 2000 to deliver an item to an electronic locker arrangement via a delivery service provider. The process 2000 includes, at 2002, receiving a request from a first user device for a locker identifier. The request can be generated by a mobile device app or via a web site of a logistics management system, such as the logistics management system 108. In various implementations, the locker identifier can indicate that an item is to be delivered to an electronic locker arrangement positioned at a particular location. At 2004, the process 2000 can include generating the locker identifier. The locker identifier can be generated by the logistics management system. In some implementations, the locker identifier can include an alphanumeric string of characters. In other implementations, the locker identifier can include a bar code or a QR code. The locker identifier can be based at least partly on an electronic locker arrangement to which the item is to be delivered. In various implementations, the logistics management system can determine an electronic locker arrangement to store the item based on a proximity of the location of a recipient of the item with respect to a location of one or more electronic locker arrangements. The locker identifier can also be based at least partly on a locker within the electronic locker arrangement to store the item.

At 2006, the process 2000 can include sending the locker identifier to the first user device. In some implementations, the logistics management system can also send a delivery location to the first user device. The delivery location can indicate a location of the electronic locker arrangement to which the item is to be delivered. In certain implementations, the delivery location can include a street address, a city, a state, a zip code, or combinations thereof. At 2008, the process 2000 can include obtaining a delivery address from the user device and obtaining the locker identifier from the user device. In various implementations, the delivery address and the locker identifier can be obtained by a delivery service provider that is to deliver the item. For example, a user can access a mobile device app or a website of the delivery service provider and request that the item be delivered to a particular location. The user can enter the locker identifier and/or the delivery location into the mobile device app or the website of the delivery service provider. The item can then be provided to the delivery service provider, such as via pickup by a courier of the delivery service provider or via drop off by the user to a location of the delivery service provider. In additional implementations, the delivery address and the locker identifier can be provided to an online retailer that then sends the delivery address and the locker identifier to a delivery service provider. The delivery service provider can obtain the item from the online retailer and arrange to have the item delivered to the recipient.

At 2010, the process 2000 includes generating delivery information that includes at least the delivery address and the locker identifier. The delivery information can be generated by the delivery service provider and provided to a courier that is to deliver the item to the recipient. The delivery information can be provided to the courier via a computing device of the courier, in some cases. In additional situations, the delivery information can be provided to the courier by placing the delivery information onto the item or onto packaging associated with the item. In various implementations, the delivery information can be printed onto a label that is affixed to the item or to packaging associated with the item. In some situations, the delivery address can include a street address of a building that is co-located with the electronic locker arrangement. In these scenarios, the locker identifier can indicate that the item is to be delivered to the electronic locker arrangement instead of to the building.

At 2012, the process 2000 includes providing locker access information to an electronic locker arrangement located at the delivery address. For example, a courier can enter the locker identifier into one or more user interface elements of a user interface displayed by the electronic locker arrangement. The courier can also provide the locker identifier to the electronic locker arrangement by scanning the locker identifier using a scanning device of the electronic locker arrangement. Additionally, at 2014, the process 2000 includes obtaining from the electronic locker arrangement, the locker access information. To illustrate, the logistics management system can obtain the locker access information from the electronic locker arrangement.

At 2016, the process 2000 includes authenticating the locker access information. The logistics management system can authenticate the locker access information at least partly based on parsing a data store of the logistics management system and determining that the locker access information received from the electronic locker arrangement corresponds to a locker identifier stored by the data store that is associated with the item. In various implementations, the logistics management system can authenticate the locker access information by determining the item associated with the locker access information and accessing systems of the delivery service provider to verify a location and/or status of the item. For example, the locker access information can include an identifier of the item and/or the locker identifier. The logistics management system can utilize the identifier of the item and/or the locker identifier to query the systems of the delivery service provider for status and/or location information of the item. In some implementations, the logistics management system can generate one or more calls of an API of the delivery service provider to obtain the status and/or location information. In situations where the status of the item indicates that the item is being delivered, the logistics management system can authenticate the locker access information and determine that the courier is to be granted access to the electronic locker arrangement. Additionally, when the location of the item corresponds to a location of the electronic locker arrangement, the logistics management system can authenticate the locker access information and determine that the courier is to be granted access to the electronic locker arrangement.

At 2018, the process 2000 includes causing a locker of the electronic locker arrangement to open. In particular, after authenticating the locker access information, the logistics management system can determine a locker to which the item is to be delivered. In some cases, the item can be assigned a locker when the locker identifier is generated. In other situations, the logistics management system can assign a locker to the item when the item is in transit to the electronic locker arrangement. After identifying the locker assigned to the item, the logistics management system can send a signal to the electronic locker arrangement to open the locker. The electronic locker arrangement can send information to the logistics management system that the item has been delivered to the locker. For example, the logistics management system can obtain sensor data and/or a signal from the electronic locker arrangement indicating that the item has been placed in the locker and that the locker door has been secured. In particular implementations, the logistics management system can then send a notification to the recipient that the item has been delivered. In certain situations, the logistics management system can send a notification to the sender that the item has been delivered.

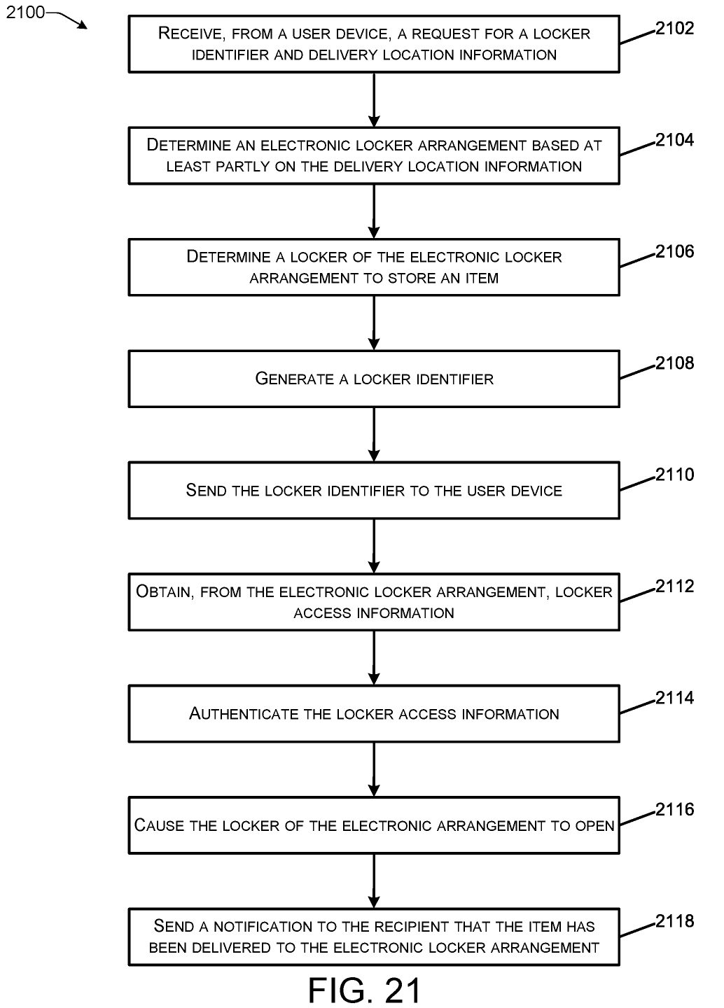

FIG. 21 is a flow diagram of a second process 2100 to deliver an item to an electronic locker arrangement via a delivery service provider. The operations of the process 2100 can be performed by a logistics management system, such as the logistics management system 108, in relation to the delivery of an item to an individual by a third-party delivery service provider that is operated by an entity that is separate from the logistics management system. At 2102, the process 2100 includes receiving, from a user device, a request for a locker identifier and also receiving delivery location information. The request can be generated by a mobile device app of the logistics management system where the mobile device app is executed by the user device. The request can also be generated via a website of the logistics management system. The delivery location information can correspond to a location of a recipient of an item. In some situations, the delivery location information can include an address of the recipient. The delivery location information can also include geographic positioning system (GPS) coordinates.

At 2104, the process 2100 can include determining an electronic locker arrangement based at least partly on the delivery location information. To illustrate, the delivery location information can be utilized by the logistics management system to determine an electronic locker arrangement that is closest in proximity with the location of the recipient of the item. In various implementations, the logistics management system can identify an electronic locker arrangement that is within a threshold distance of the location of the recipient. In certain implementations, the electronic locker arrangement designated to store the item can be based at least partly on availability of lockers that correspond to criteria associated with the item. In some cases, availability of the lockers can be based on a size of the item, a type of the item, sizes of the lockers, an estimated time of delivery of the item, estimated pickup times of items already stored or scheduled to be stored in the lockers, combinations thereof, and the like. Additionally, the logistics management system can determine the availability of lockers within one or more electronic locker arrangements and determine the particular electronic locker arrangement to deliver the item based on the availability of lockers within the one or more electronic locker arrangements. At 2106, the process 2100 includes determining a locker of the electronic locker arrangement to store the item. For example, the logistics management system can identify a particular locker within the electronic locker arrangement to which the item is to be delivered. The logistics management system can store information in a data store of the logistics management system indicating the electronic locker arrangement and the locker within the electronic locker arrangement where the item is to be delivered.

At 2108, the process 2100 includes generating a locker identifier. The logistics management system can generate the locker identifier based at least partly on an identifier of the electronic locker arrangement that is designated to store the item. The locker identifier can also be generated based at least partly on the locker within the electronic locker arrangement that is to store the item, the recipient of the item, the sender of the item, or combinations thereof. At 2110, the process 2100 includes sending the locker identifier to the user device. The locker identifier can be utilized by a user of the user device to indicate that the item is to be delivered to an electronic locker arrangement. For example, the user can provide the locker identifier to an online retailer or to a delivery service provider to indicate to the courier delivering the item that the item is to be delivered to a particular electronic locker arrangement. Thus, in situations where the electronic locker arrangement is co-located at the same address as another structure or building, the courier can determine based on the presence of the locker identifier that the item is to be delivered to the electronic locker arrangement and not to the building or other structure co-located with the electronic locker arrangement. In some cases, the logistics management system can send other information to the user device in conjunction with the locker identifier. To illustrate, the logistics management system can send a security code to be utilized by a courier to gain access to the electronic locker arrangement. In certain situations, the locker identifier can include a security code to access the electronic locker arrangement.

At 2112, the process 2100 includes obtaining, from the electronic locker arrangement, locker access information. The locker access information can include at least a portion of the locker identifier. The locker access information can include a security code to gain access to the electronic locker arrangement. At 2114, the process 2100 includes authenticating the locker access information. In some implementations, the logistics management system can authenticate the locker access information by verifying that data included in the locker access information corresponds to information stored about the item in a data store of the logistics management system. For example, the logistics management system can verify that a security code included in the locker access information corresponds to a security code of the item stored by the logistics management system. The logistics management system can also authenticate the locker access information by accessing systems of the delivery service provider to determine that the item is located at the electronic locker arrangement or that the status of the item indicates that the item is being delivered.

At 2116, the process 2100 includes causing the locker of the electronic locker arrangement to open. In various implementations, in response to authenticating the locker access information, the logistics management system can identify the locker within the electronic locker arrangement that is designated to store the item and send a signal to the electronic locker arrangement to open the locker. In some cases, the logistics management system can send a signal to the electronic locker arrangement to unlock the locker. At 2118, the process 2100 includes sending a notification to the recipient that the item has been delivered to the electronic locker arrangement. The notification can indicate a location of the electronic locker arrangement that is storing the item. The notification can also indicate a locker that is storing the item. Additionally, the notification can include a code to access the locker. In some cases, access to the locker storing the item can be granted via the process described with respect to FIG. 5, where the recipient requests access to the electronic locker arrangement at the electronic locker arrangement, the electronic locker arrangement obtains a QR code from the logistics management system and provides the QR code to the recipient, and the recipient then provides the QR code to the logistics management system via a mobile device app which, upon verification, causes the logistics management system to trigger the electronic locker arrangement to grant access to the locker storing the item by the recipient.

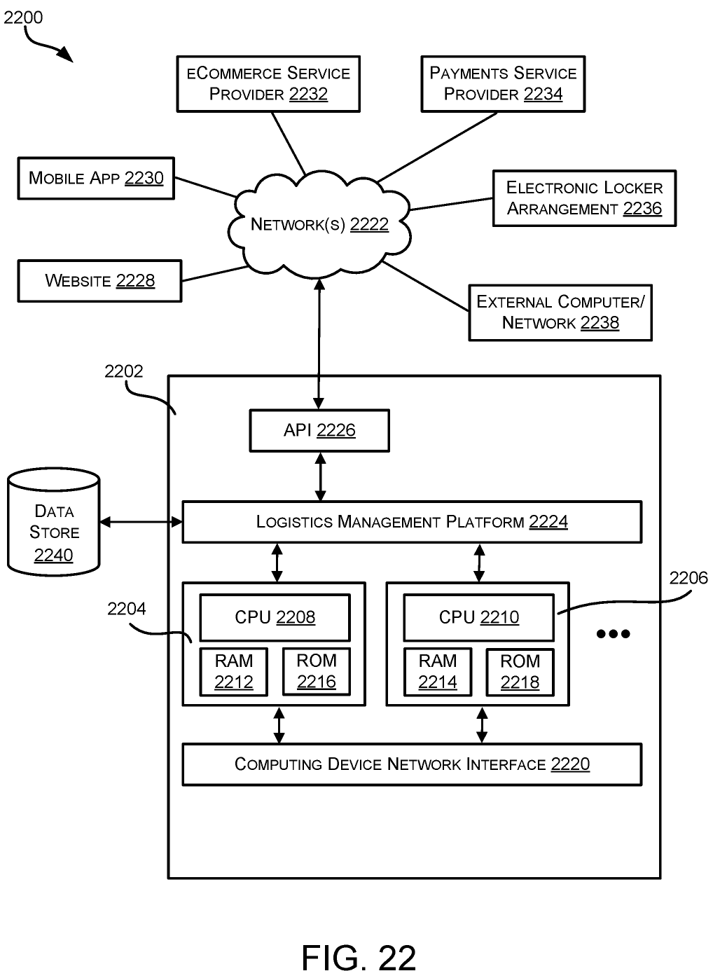

FIG. 22 is a diagram showing an illustrative computer architecture 2200 for implementing aspects of the various technologies presented herein. The architecture 2200 can include a computing system that includes hardware devices that implement software components. In the illustrative example of FIG. 22, the computing system 2202 can include a number of computing devices, such as a first computing device 2204 and a second computing device 2206.

The computing devices 2204, 2206 can include a baseboard, or “motherboard,” which is a printed circuit board to which a multitude of components or devices can be connected by way of a system bus or other electrical communication paths. In one illustrative configuration, the computing device 2204, 2206 each include one or more central processing units (“CPUs”) 2208, 2210. The CPUs 2208, 2210 can be standard programmable processors that perform arithmetic and logical operations necessary for the operation of the computing system 2200.

The CPUs 2208, 2210 perform operations by transitioning from one discrete, physical state to the next through the manipulation of switching elements that differentiate between and change these states. Switching elements can generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The computing devices 2204, 2206 also include RAM 2212, 2214, used as the main memory in the computing devices 2204, 2206. The computing devices 2204, 2206 can further include a computer-readable storage medium such as read-only memory (“ROM”) 2216, 2218 or non-volatile RAM (“NVRAM”) for storing basic routines that help to startup the computing devices 2204, 2206 and to transfer information between the various components and devices. The ROM 2216, 2218 or NVRAM can also store other software components necessary for the operation of the computing devices 2204, 2206 in accordance with the configurations described herein. The computing device network interface 2220 can provide an interface between computing devices of the computing system 2202, such as the first computing device 2204 and the second computing device 2206.

The computing system 2202 can operate in a networked environment using logical connections to remote computing devices and computer systems through one or more networks, such as the network(s) 2222. The computing system 2202 can utilize hardware components, such as one or more network interfaces, to communicate via the network(s) 2222. The computing system 2202 can also utilize software components, such as a logistics management platform 2224 and an API 2226 to communicate with, control, or otherwise interact with various computing devices via the network(s) 2222. The logistics management platform 2224 can implement the operations described herein corresponding to the logistics management system 108. In some implementations, the logistics management platform 2224 can include modules 610, 612, 614, 616, 618, 620, 622 of FIG. 6 and perform the operations described in relation to the processes 700, 800, 900, 1000, 1600, 1700, 1800, 19000, 2000, 2100 of FIGS. 7-10 and 16-21. Additionally, the logistics management platform 2224 can perform operations described with respect to at least portions of the architectures 100, 200, 300, 400, 500, 600 of FIGS. 1-6 and other implementations described herein. The API 2226 can include various calls and additional information to enable communications between the computing system 2202 and additional computing devices via the network(s) 2222. In particular implementations, the API 2226 can include a representational state transfer (RESTful) API.

The logistics management platform 2224 can exchange information with one or more websites 2228 via the API 2226 in addition to one or more mobile apps 2230. Additionally, the logistics management platform 2224 can exchange information with an ecommerce service provider 2232 as well as a payments service provider 2234 via the API 2226. Further, the logistics management platform can exchange information with electronic locker arrangements 2236 and other external computers/networks 2238 utilizing the API 2226. In some cases, the items being delivered via the logistics management platform 2224 can be obtained via the ecommerce service provider 2232 and/or websites 2228 related to merchants offering items for purchase online. Further, couriers can obtain payments for their services in delivering items via the payments service provider 2234.

The computing system 2202 can be connected to a mass storage device 2240 that provides non-volatile storage for the computing system 2202. The mass storage device 2240 can consist of one or more physical storage units. A storage controller of the computing system 2202 (not shown) can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing system 2202 can store data on the mass storage device 2240 by transforming the physical state of the physical storage units to reflect the information being stored. The specific transformation of physical state can depend on various factors, in different implementations of this description. Examples of such factors can include, but are not limited to, the technology used to implement the physical storage units, whether the mass storage device 2240 is characterized as primary or secondary storage, and the like.

For example, the computing system 2202 can store information to the mass storage device 2240 by issuing instructions through a storage controller to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing system 2202 can further read information from the mass storage device 2240 by detecting the physical states or characteristics of one or more particular locations within the physical storage units.

In addition to the mass storage device 2240 described above, the computing system 2202 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing system 2202.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

In one configuration, the mass storage device 2240 or other computer-readable storage media is encoded with computer-executable instructions which, when loaded into the computing devices 2204, 2206 of the computing system 2202, transform the computer from a general-purpose computing system into a special-purpose computer capable of implementing the configurations described herein. These computer-executable instructions transform the computing devices 2204, 2206 by specifying how the CPUs 2208, 2210 transition between states, as described above. According to one configuration, the computing system 2202 has access to computer-readable storage media storing computer-executable instructions which, when executed by the computing system 2202, perform the various processes described above with regard to FIGS. 1-21. The computing system 2202 can also include computer-readable storage media for performing any of the other computer-implemented operations described herein.

The computing devices 2204, 2206 can include one or more input/output controllers for receiving and processing input from a number of input devices, such as a keyboard, a mouse, a touchpad, a touch screen, an electronic stylus, or other type of input device. Similarly, an input/output controller can provide output to a display, such as a computer monitor, a flat-panel display, a digital projector, a printer, or other type of output device. It will be appreciated that the computing system 2202 might not include all of the components shown in FIG. 22, can include other components that are not explicitly shown in FIG. 22, or can utilize an architecture completely different than that shown in FIG. 22.

Based on the foregoing, it should be appreciated that technologies for providing a network service capable of identifying infrequently accessed data from a request stream have been disclosed herein. Moreover, although the subject matter presented herein has been described in language specific to computer structural features, methodological acts, and computer readable media, it is to be understood that the invention defined in the appended claims is not necessarily limited to the specific features, acts, or media described herein. Rather, the specific features, acts, and media are disclosed as example forms of implementing the claims.

The subject matter described above is provided by way of illustration only and should not be construed as limiting. Furthermore, the claimed subject matter is not limited to implementations that solve any or all disadvantages noted in any part of this disclosure. Various modifications and changes can be made to the subject matter described herein without following the example configurations and applications illustrated and described, and without departing from the true spirit and scope of the present invention, which is set forth in the following claims.

What is claimed is:

1. A computer-implemented method, comprising:
receiving, by a logistics management system and from a first user device, a request for information related to delivery of an item to a recipient, the request including a location of the recipient of an item;
determining, by the logistics management system, a location of an electronic locker arrangement that corresponds to the location of the recipient;
generating, by the logistics management system, a locker identifier that corresponds to the electronic locker arrangement;
sending, by the logistics management system, the locker identifier and the location of the electronic locker arrangement to the first user device;
obtaining, by a third-party service provider, shipping information from the first user device, the shipping information indicting the location of the electronic locker arrangement, the locker identifier, and an identifier of the recipient;
generating, by the third-party service provider, delivery information that includes the location of the electronic locker arrangement and the locker identifier;
obtaining, by the electronic locker arrangement, the locker identifier;
obtaining, from the electronic locker arrangement and by the logistics management system, the locker identifier;
authenticating, by the logistics management system, the locker identifier; and
causing, by the logistics management system, a locker of the electronic arrangement to open based at least partly on authentication of the locker identifier.

2. The computer-implemented method of claim 1, wherein the third-party service provider maintains at least one of a website or mobile device application to purchase the item, and the method further comprises:
sending, by the third-party service provider, the delivery information to a delivery service provider; and
providing, by the delivery service provider, the delivery information to a second user device of a courier assigned to deliver the item to the electronic locker arrangement.

3. The computer-implemented method of claim 1, further comprising:
generating label data that includes the identifier of the recipient, the locker identifier, and the location of the electronic locker arrangement; and
sending the label data to a printing device.

4. The computer-implemented method of claim 1, further comprising:
generating one or more calls of an application programming interface (API) of a delivery service provider to access at least one of a location of the item, a location of a courier assigned to deliver the item, or a status of the item;
obtaining, from the delivery service provider, verification information indicating at the least one of the location of the item, the location of the courier assigned to deliver the item, or the status of the item; and
determining, based at least partly on the location of the location of the electronic locker arrangement and the at least one of the location of the item, the location of the courier assigned to deliver the item, or the status of the item, that the locker identifier is authenticated.

5. The computer-implemented method of claim 4, wherein the locker identifier is represented by a QR code, and locker identifier is obtained by the electronic locker arrangement via a scanning device of the electronic locker arrangement.

6. The computer-implemented method of claim 1, wherein the locker identifier is generated based at least partly on an identifier of a sender of the item, the identifier of the recipient, an identifier of the electronic locker arrangement, an identifier of the locker of the electronic locker arrangement to store the item, or combinations thereof.

7. The computer-implemented method of claim 1, further comprising:
obtaining, by the electronic locker arrangement, a request to access the locker assigned to store the item;
generating, by the logistics management system, a QR code to access the locker;
sending, by the logistics management system, the QR code to the electronic locker arrangement;
scanning, by a second user device of a courier assigned to deliver the item, the QR code via a scanning device of the electronic locker arrangement;
obtaining, by the logistics management system and from the second user device, the QR code; and
sending, by the logistics management system and to the electronic locker arrangement, a command to open the locker based at least partly on obtaining the QR code from the second user device.

8. The computer-implemented method of claim 1, further comprising:
generating, by the first user device, a user interface including a plurality of user interface elements; and
obtaining, by the first user device, input indicating the locker identifier in a user interface element of the plurality of user interface elements.

9. The computer-implemented method of claim 8, wherein the input further indicates the identifier of the recipient.

10. The computer-implemented method of claim 8, wherein the user interface is provided by at least one of a website of an online retailer offering the item for purchase, a mobile device application of the online retailer, a website of a delivery service provider to deliver the item to the recipient, or an additional mobile device application of the delivery service provider.

11. The computer-implemented method of claim 8, wherein a script of a mobile device application of the logistics management system obtains the locker identifier and automatically populates the user interface element with the locker identifier.

12. A system comprising:
one or more processors; and
at least one non-transitory computer-readable storage medium having instructions stored thereupon which, when executed by the one or more processors, cause the system to perform operations comprising:
receiving, from a user device, a request for a locker identifier and delivery location information;
determining an electronic locker arrangement that corresponds to the delivery location;
determining a locker of the electronic locker arrangement to store an item associated with the request;
generating the locker identifier;
sending the locker identifier to the user device;
obtaining, from the electronic locker arrangement, locker access information;
authenticating the locker access information; and
causing the locker of the electronic locker arrangement to open.

13. The system of claim 12, wherein:
the operations further comprise sending a mobile device application to the user device; and
the request is received via the mobile device application.

14. The system of claim 12, wherein determining the electronic locker arrangement that corresponds to the delivery location includes:
determining individual locations of a plurality of electronic locker arrangements, wherein the electronic locker arrangement is one of the plurality of electronic locker arrangements;
comparing the delivery location to each of the individual locations of the plurality of electronic locker arrangements; and
determining that the individual location of the electronic locker arrangement is less than a threshold distance from the delivery location.

15. The system of claim 12, wherein determining a locker of the electronic locker arrangement to store the item includes:
obtaining sensor data from the electronic locker arrangement, the sensor data including at least one of weight data for individual lockers of the electronic locker arrangement or image data related to images of doors of lockers of the electronic locker arrangement; and
determining, based at least partly on the sensor data, that the locker is available to store the item.

16. The system of claim 12, wherein:
the locker access information includes a quick response (QR) code; and
authenticating the locker access information includes determining that the QR code corresponds to an additional QR code sent to the user device in response to receiving the request for the locker identifier.

17. A system, comprising:
one or more processors; and
at least one non-transitory computer-readable storage medium having instructions stored thereupon which, when executed by the one or more processors, cause the apparatus to perform operations comprising:
receiving, from a user device, a request for a locker identifier, the locker identifier indicating that an item is to be delivered to an electronic locker arrangement;
generating the locker identifier based at least partly on at least one of an identifier of a recipient of the item, an identifier of the electronic locker arrangement, an identifier of a sender of the item, or a location of the electronic locker arrangement;
sending the locker identifier to the user device;
receiving, from the electronic locker arrangement, at least a portion of the locker identifier; and
sending, to the electronic locker arrangement, information indicating a locker of the electronic locker arrangement to store the item based at least partly on obtaining the at least a portion of the locker identifier from the electronic locker arrangement.

18. The system of claim 17, wherein:
a location of the electronic locker arrangement is represented by a street address; and
the street address is shared by the electronic locker arrangement with a building or additional structure.

19. The system of claim 17, wherein:
the sender of the item is a same individual as the recipient of the item;
the request is obtained via an instance of a mobile device application provided by a logistics management system and executed by the user device and the request includes an identifier of the individual; and
the operations further comprising creating a database entry that stores the locker identifier in association with an account of the individual with the logistics management system.

20. The system of claim 19, wherein the operations further comprise:
comparing the at least a portion of the locker identifier with information stored in the account of the individual to authenticate the at least a portion of the locker identifier; and
based at least partly on authentication of the at least a portion of the locker identifier, sending a notification to the user device that the item is available for pickup in the locker of the electronic locker arrangement.
